SEQUENCE LISTING (10 sequences)

SEQ ID NO: 1 - DNA, 31 bp, Artificial Sequence
  Description of Artificial Sequence Synthetic primer
gcctgtcacaaagcagcacgctggaggtaca

SEQ ID NO: 2 - DNA, 29 bp, Artificial Sequence
  Description of Artificial Sequence Synthetic primer
gttctccagagccgtgggagccacactga

SEQ ID NO: 3 - DNA, 65 bp, Unknown
  Description of Unknown Target GSDMA2 gene polynucleotide
gcctgtcacaaagcagcacgctggaggtacagatgctcagtgtggctcccacggctctggagaac

SEQ ID NO: 4 - DNA, 21 bp, Artificial Sequence
  Description of Artificial Sequence Synthetic primer
tatagcacacaagtagaccct

SEQ ID NO: 5 - DNA, 20 bp, Artificial Sequence
  Description of Artificial Sequence Synthetic primer
tcctgcttgatattcacacc

SEQ ID NO: 6 - DNA, 135 bp, Human immunodeficiency virus
tatagcacacaagtagaccctgacctagcagaccaactaattcatctgtactattttgactgtttttcagactctgctataagaaaagccttattaggacatagagttagccctaggtgtgaatatcaagcagga

SEQ ID NO: 7 - DNA, 21 bp, Artificial Sequence
  Description of Artificial Sequence Synthetic primer
ccaactcgtgtgtgaaactcc

SEQ ID NO: 8 - DNA, 22 bp, Artificial Sequence
  Description of Artificial Sequence Synthetic primer
attccccattgtgattatagcc

SEQ ID NO: 9 - DNA, 451 bp, Unknown
  Description of Unknown Template polynucleotide comprising the target BCR-ABL gene sequence
ctatgagcgtgcagagtggagggagaacatccgggagcagcagaagaagtgtttcagaagcttctccctgacatccgtggagctgcagatgctgaccaactcgtgtgtgaaactccagactgtccacagcattccgctgaccatcaataaggaagatgatgagtctccggggctctatgggtttctgaatgtcatcgtccactcagccactggatttaagcagagttcaaaagcccttcagcggccagtagcatctgactttgagcctcagggtctgagtgaagccgctcgttggaactccaaggaaaaccttctcgctggacccagtgaaaatgaccccaaccttttcgttgcactgtatgattttgtggccagtggagataacactctaagcataactaaaggtgaaaagctccgggtcttaggctataatcacaatggggaatggtgt

SEQ ID NO: 10 - DNA, 351 bp, Unknown
  Description of Unknown Target BCR-ABL gene polynucleotide
ccaactcgtgtgtgaaactccagactgtccacagcattccgctgaccatcaataaggaagatgatgagtctccggggctctatgggtttctgaatgtcatcgtccactcagccactggatttaagcagagttcaaaagcccttcagcggccagtagcatctgactttgagcctcagggtctgagtgaagccgctcgttggaactccaaggaaaaccttctcgctggacccagtgaaaatgaccccaaccttttcgttgcactgtatgattttgtggccagtggagataacactctaagcataactaaaggtgaaaagctccgggtcttaggctataatcacaatggggaat

(19) United States
(12) Patent Application Publication
(10) Pub. No.: US 2014/0073013 A1
(43) Pub. Date: Mar. 13, 2014

(54) ULTRAFAST THERMAL CYCLER

(71) Applicant: California Institute of Technology, Pasadena, CA (US)

(72) Inventors: John B. GORMAN, Carlsbad, CA (US); George Maltezos, Fort Salonga, NY (US); Axel Scherer, Pasadena, CA (US)

(73) Assignee: California Institute of Technology, Pasadena, CA (US)

(21) Appl. No.: 13/961,752

(22) Filed: Aug. 7, 2013

Related U.S. Application Data
(60) Provisional application No. 61/680,654, filed on Aug. 7, 2012.

(51) Int. Cl. B01L 7/00

(52) U.S. Cl. CPC B01L 7/52
USPC 435/91.2; 435/289.1

(57) ABSTRACT

This disclosure provides thermal cyclers, systems, and methods of thermally cycling a sample.

### CROSS-REFERENCE

This application claims the benefit of U.S. Provisional Application No. 61/680,654, filed Aug. 7, 2012, which application is incorporated herein by reference in its entirety for all purposes.

### BACKGROUND

Thermal cyclers are important tools in research, clinical, diagnostic, forensic, and other environments. For example, thermal cyclers play a critical role in many methods of nucleic acid amplification. Nucleic acid amplification, both isothermal and non-isothermal, forms the basis for a number of applications, including the detection of hereditary diseases, identification of genetic fingerprints, diagnosis of infectious diseases, cloning of genes, paternity testing, criminal identification, phylogeny, and DNA computing. A number of nucleic acid amplification methods are known to those skilled in the art, with, perhaps, the most noteworthy methods being those based on the polymerase chain reaction (PCR). Invented in 1983 by Kary Mullis, PCR is recognized as one of the key scientific developments of the twentieth century. PCR has revolutionized molecular biology by vastly extending the capability to identify and reproduce genetic materials such as deoxyribonucleic acid (DNA) and ribonucleic acid (RNA). Indeed, PCR is a routine methodology practiced in many medical and biological research laboratories. Since its initial introduction, PCR methods have been further optimized and modified for use in a variety of applications and for a variety of purposes. Moreover, devices have been constructed to successfully perform PCR and provide for a degree of automation. One such device, a thermal cycler, is capable of altering the temperature of a PCR reaction mixture, a required aspect of PCR methods.

Existing thermal cyclers are typically expensive and only capable of altering the temperature of a sample relatively slowly, meaning that a relatively lengthy period of time is required to complete a single thermal cycle. This, in turn, leads to an even lengthier period of time to complete a nucleic acid amplification process, or other reaction requiring multiple thermal cycles. Therefore, there is a need for lower-cost thermal cyclers capable of rapidly changing the temperature of a sample.

### SUMMARY

This disclosure provides thermal cyclers, systems, and methods of thermally cycling a sample.

An aspect of the disclosure provides a thermal cycler comprising a sample holder; a heater in thermal contact with the sample holder, wherein the heater is configured to heat the sample holder; and a cooling gas in thermal contact with the sample holder, wherein the cooling gas is configured to cool the sample holder, wherein the thermal cycler is capable of performing a single thermal cycle in less than about three seconds. In some cases, the thermal cycler is capable of performing a single thermal cycle in less than about 1 second. In some cases, the thermal cycler is capable of performing a single thermal cycle in about 0.75 seconds.

The thermal cycler may comprise a temperature sensor in thermal contact with the sample holder. Also, the sample holder may be integrated into a cartridge. The cartridge may be made using converted-tape technology and produced from a material selected from the group consisting of polypropylene, polycarbonate, and acrylic. In some cases, the heater may be integrated into the cartridge. The thermal cycler may also include an aligner configured to align the cartridge and the heater.

The thermal cycler may also comprise a disposable support positioned underneath the heater and configured to improve contact between the heater and a cartridge. The disposable support may comprise a plurality of openings in the disposable support and the thermal cycler may comprise a plurality of fins around the perimeter of the disposable support, the openings and fins being configured to exhaust the cooling gas.

The heater may comprise a flexible circuit board. In some cases, the heater comprises a resistive heating element, which may, for example, be a thin-film heating element. The thermal cycler may also include a heat spreader in thermal contact with the heater, wherein the heat spreader is configured to promote thermal uniformity throughout the heater. The heat spreader may comprise a material with high thermal conductivity such as, for example, copper. Moreover, a temperature sensor may be in thermal contact with the heater.

In some cases, the cooling gas may be air or carbon dioxide. Also, the cooling gas may be contacted with the sample holder via a forced flow. The sample holder may be within a chip and the contact of the cooling gas with the sample holder may occur along a direction parallel to the chip. In other cases, contact of the cooling gas with the sample holder occurs along a direction normal to the sample holder. The thermal cycler may also comprise a battery.

An additional aspect of the disclosure provides a thermal cycler comprising a sample holder; a heater in thermal contact with the sample holder, wherein the heater is configured to heat the sample holder; a cooling gas in thermal contact with the sample holder, wherein the cooling gas is configured to cool the sample holder; and a heat spreader in thermal contact with the heater, wherein the heat spreader is configured to promote thermal uniformity throughout the heater. In some cases, the thermal cycler may comprise a temperature sensor in thermal contact with the sample holder and/or the heater.

The sample holder may be integrated into a cartridge. The cartridge may be made using converted-tape technology and produced from a material selected from the group consisting of polypropylene, polycarbonate, and acrylic. In some cases, the heater is integrated into the cartridge. The thermal cycler may comprise an aligner configured to align the cartridge and the heater.

The thermal cycler may comprise a disposable support positioned underneath the heater and configured to improve contact between the heater and the cartridge. The disposable support may comprise a plurality of openings and the thermal cycler may comprise a plurality of fins around the perimeter of the disposable support, the openings and fins being configured to exhaust the cooling gas.

In some cases, the heater may comprise a flexible circuit board. The heater may comprise a resistive heating element such as, for example, a thin-film heating element. The heat spreader may comprise a material with high thermal conductivity such as, for example, copper.

For example, the cooling gas may be air or carbon dioxide. The cooling gas may be contacted with the sample holder via a forced flow. In some cases, the sample holder is within a chip and the contacting of the cooling gas with the sample holder occurs along a direction parallel to the chip. In some cases, the contact of the cooling gas with the sample holder occurs along a direction normal to the sample holder. In some cases, the thermal cycler comprises a battery.

An additional aspect of the disclosure provides a method of amplifying a nucleic acid comprising providing a thermal cycler comprising a sample holder containing a sample that comprises a nucleic acid to be amplified; a heater in thermal contact with the sample holder; and a cooling gas in thermal contact with the sample holder, wherein the cooling gas is configured to cool the sample holder; and amplifying the nucleic acid in the thermal cycler, wherein at least one amplification cycle is completed in less than about 3 seconds.

In some cases, the sample may comprise reagents necessary for amplification of the nucleic acid. In some cases, the at least one nucleic acid amplification cycle is completed in less than about 1 second. In some cases, the at least one nucleic acid amplification cycle is completed in about 0.75 seconds.

The thermal cycler may comprise a temperature sensor in thermal contact with the sample holder. In some cases, the thermal cycler may comprise a temperature sensor in thermal contact with the sample holder. The sample holder may be integrated into a cartridge. The cartridge may be made using converted-tape technology and produced from a material selected from the group consisting of polypropylene, polycarbonate, and acrylic.

In some cases, the heater may be integrated into a cartridge. The thermal cycler may comprise an aligner configured to align the cartridge and the heater. Moreover, in some cases, the thermal cycler may comprise a disposable support positioned underneath the heater and configured to improve contact between the heater and a cartridge. The disposable support may comprise a plurality of openings and the thermal cycler may comprise a plurality of fins around the perimeter of the disposable support, the openings and fins being configured to exhaust the cooling gas.

In some cases, the heater comprises a flexible circuit board. Furthermore, the heater may comprise a resistive heating element such as, for example, a thin-film heating element. Also, the thermal cycler may comprise a heat spreader in thermal contact with the heater, the heat spreader being configured to promote thermal uniformity throughout the heater. In some cases, the heat spreader comprises a material with high thermal conductivity such as, for example, copper. The thermal cycler may comprise a temperature sensor in thermal contact with the heater.

In some cases, the cooling gas may be air or carbon dioxide. In some cases, the cooling gas may be contacted with the sample holder via a forced flow. In some cases, the sample holder is within a chip, and contact of the cooling gas with the sample holder occurs along a direction parallel to the chip. In other cases, contact of the cooling gas with the sample holder occurs along a direction normal to the sample holder. In some cases, the thermal cycler comprises a battery.

### INCORPORATION BY REFERENCE

All publications, patents, and patent applications mentioned in this specification are herein incorporated by reference in their entireties for all purposes and to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a layered schematic of an example cartridge comprising a sample holder and a heater.

FIG. 2 is a layered schematic of an example cartridge comprising a sample holder and its arrangement with a heater via an aligner.

FIG. 3 is a layered schematic of an example cartridge comprising a sample holder and its arrangement with a heater via an aligner. The schematic also includes an optional additional adhesive layer, protective thin layer, and thermal enhancer layer.

FIG. 4 is a multi-view schematic of an example heater.

FIG. 5 is a multi-view schematic of an example wind tunnel.

FIG. 6 is a multi-view schematic of an example thermal cycler device.

FIG. 7 is a layered schematic of an example thermal cycler device.

FIG. 8 is a layered schematic of an example thermal cycler device.

FIG. 9 is a layered schematic of an example thermal cycler device.

FIG. 10 is a layered schematic of an example thermal cycler device.

FIG. 11A is a conceptual schematic of an example computer server.

FIG. 11B is a conceptual schematic of an example control assembly.

FIG. 12 is a schematic of an example system that comprises a thermal cycler device and a sample mixing unit.

FIG. 13A is a plot of heater temperature and sample temperature versus time from an example thermal cycling experiment.

FIG. 13B is a partial, close-up view of the plot shown in FIG. 13A.

FIG. 14A is a plot of heater temperature versus time from an example PCR experiment.

FIG. 14B is a photograph of a gel electrophoresis experiment used to characterize the success of nucleic acid amplification following the conclusion of the PCR experiment in FIG. 14A.

FIG. 15A is a plot of heater temperature versus time for an example PCR experiment.

FIG. 15B is a photograph of a gel electrophoresis experiment used to characterize the success of nucleic acid amplification following the conclusion of the PCR experiment in FIG. 15A.

FIG. 16A is a plot of heater temperature versus time for an example PCR experiment.

FIG. 16B is a photograph of a gel electrophoresis experiment used to characterize the success of nucleic acid amplification following the conclusion the PCR experiment in FIG. 16A.

FIG. 17A is a plot of heater temperature versus time for an example PCR experiment.

FIG. 17B is a photograph of a gel electrophoresis experiment used to characterize the success of nucleic acid amplification following the conclusion of a PCR experiment.

FIG. 18A is a table of energy consumption values for a series of thermal cycle experiments each performed at different heater power percentages.

FIG. 18B is a graphical representation of the data shown in FIG. 18A.

FIG. 19A is a plot of heater power usage and heater temperature as a function of time during an example PCR experiment.

FIG. 19B is a plot of cumulative heater power usage as a function of time, obtained from the data in FIG. 19A.

FIG. 20 is a plot of the temperature of the sample as a function of the temperature of the heater.

FIG. 21 is a layered schematic of an example cartridge comprising a sample holder.

FIG. 22 is a plot of example temperature ramp rate and estimated temperature ramp time as a function of cooling air flow rate.

FIG. 23A and FIG. 23B are micrographs showing an example of a rough surface that may be included in a thermal spreader. FIG. 23A was obtained from http://www.emeraldinsight.com/content_images/fig/2170290304001.png and FIG. 23B was obtained from http://www.quantummicromet.co.uk/images/SEM_copper.jpg.

FIG. 24 is a summary of data obtained from operation of several different example heaters.

FIG. 25 is an example cartridge comprising material in the solid-phase.

FIG. 26 is a photograph of a gel electrophoresis experiment used to characterize the success of nucleic acid amplification following the conclusion of an example multiplex PCR experiment.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### DEFINITIONS

The terms “a” and “an”, as used herein, unless clearly indicated to the contrary, should be understood to mean “at least one”.

The term “about,” as used herein, generally refers to a range that is 15% greater than or less than a stated numerical value within the context of the particular usage. For example, “about 10” would include a range from 8.5 to 11.5.

The term “cartridge”, as used herein, generally refers to a device comprising a sample holder.

Assembly using “converted-tape technology”, as used herein, generally refers to the stacked assembly of layered materials to form a larger structure, for example, a cartridge. A cartridge assembled via converted-tape technology may be referred to as a “converted-tape cartridge”.

The term “disposable”, as used herein, generally refers to articles which are designed to be discarded after a limited use (e.g., in terms of number of reactions, thermal cycles, or time) rather than being reused indefinitely. For example, a cartridge may be disposable or may be a disposable. In some cases, a chip may be a disposable or may be disposable.

The term “nucleic acid amplification”, as used herein, generally refers to the production of one or more replicate copies of an existing nucleic acid.

The term “nucleic acid amplification cycle”, as used herein, generally refers to a complete set of steps used to perform a single round of nucleic acid amplification.

The term “template” refers to a nucleic acid that is amplified.

The term “amplification product”, as used herein, generally refers to replicate copies of an existing nucleic acid produced during nucleic acid amplification from a template.

The term “thermal cycler”, as used herein, generally refers to a device that is capable of heating and cooling a sample in cyclical fashion.

The term “thermal cycle”, as used herein, generally refers to heating a sample to increase the temperature to a maximum temperature, and then cooling the sample to decrease the temperature to a minimum temperature. The maximum and/or minimum temperatures may be selected by a user. However, heating may also occur after cooling. For example, a thermal cycle may also refer to cooling a sample to decrease the temperature to a desired minimum temperature, and then heating the sample to increase the temperature to a desired maximum temperature.

The term “heater”, as used herein, generally refers to a device that is used to provide thermal energy, for example, to a sample.

The term “cooling gas” or “cooling liquid”, as used herein, generally refers to a gas or liquid phase, respectively, which is used to remove thermal energy, for example, from a sample, from a sample holder, from a material, or from a region.

The term “mechanical contact”, as used herein, generally refers to contact made between one or more materials wherein the materials are physically touching.

The term “thermal contact”, as used herein, generally refers to contact made between one or more materials wherein energy may be exchanged between the materials. Materials in thermal contact may or may not be in direct mechanical contact.

The term “thermal path”, as used herein, generally refers to the distance through which energy transfer (e.g., a heater, a cooling gas, a cooling liquid, etc.) and a point within a sample contained within a sample holder occurs.

The term “micro-fluidic circuit”, as used herein, generally refers to fluidic circuits that are capable of processing fluids with volumes that range from the nanoliter to the milliliter scale.

### Overview

The present disclosure provides devices and methods that may be useful in performing rapid, non-isothermal nucleic acid amplification. In some cases, devices and methods may be useful in performing rapid, isothermal nucleic acid amplification. One such example of non-isothermal nucleic acid amplification is nucleic acid amplification that is performed via a polymerase chain reaction (PCR). The present disclosure provides devices and methods for the cycled heating and cooling that may be used to perform PCR. Devices and methods provided by the disclosure may be used by themselves or may be included as a part of other devices or systems. Moreover, devices and methods of the disclosure may be useful in a number of applications, including real-time diagnostics, point-of-care diagnostics, clinical, and research applications.

Non-isothermal nucleic acid amplification generally requires the cycled addition and removal of thermal energy. Many non-isothermal strategies that may be used for nucleic acid amplification involve the heating and cooling, to precise temperatures at precise times, of a reaction mixture that includes one or several nucleic acids of interest (that may or may not be chemically modified with additional agents) and reagents necessary to complete an amplification reaction. Non-limiting examples of such nucleic acid amplification reactions include PCR; variants of PCR (e.g., reverse transcriptase PCR (RT-PCR), quantitative PCR (Q-PCR), or real-time quantitative PCR (RTQ-PCR)); ligase-chain reaction (LCR); variants of LCR (e.g., reverse transcriptase LCR (RT-LCR), quantitative LCR (Q-LCR), real-time quantitative LCR (RTQ-LCR)); and digital nucleic amplification reactions (e.g., digital PCR (dPCR), digital RT-PCR (dRT-PCR), digital Q-PCR (dQ-PCR), digital RTQ-PCR (dRTQ-PCR), digital LCR (dLCR), digital RT-LCR (dRT-LCR), digital Q-LCR (dQ-LCR), digital RTQ-LCR (dRTQ-LCR). These nucleic acid amplification reactions, and others, are described in more detail below.

### Devices

The disclosure provides devices that are capable of rapid, repetitive thermal cycles of heating and cooling. Devices of the disclosure may be useful, for example, for executing non-isothermal nucleic acid amplification reactions, or any other reactions requiring thermal cycling. The devices disclosed herein generally include a) a sample holder that may hold a sample, b) a heater that heats the sample, and c) a cooling gas or liquid that flows to cool the sample. Various non-limiting examples of such devices, components that may be included as part of the devices, the arrangement of such components, operating conditions for the devices, and capabilities of the devices are provided herein.

### Sample Holders and Cartridges

Devices of the disclosure generally include a sample holder for receiving a sample to be thermally cycled. Materials used to manufacture sample holders are chosen to be capable of withstanding the maximum and minimum temperatures that are achieved by the device; to present a surface to the sample which does not inhibit or can be coated (for instance with bovine serum albumin (BSA) or gp32) not to inhibit amplification; and to be non-reactive with the sample contained within the device. Sample holders may be produced from a variety of materials, with non-limiting examples that include metals (e.g., aluminum, gold, copper), plastics, glass, silicones, or combinations thereof. Materials may be chosen so that the sample holder is disposable. In some cases, a sample holder, including a disposable sample holder, may be designed for single-use.

Sample holders may be of varied size, shape, weight, and configuration. In some examples, a sample holder may be round tubular shaped or oval tubular shaped. In other examples, a sample holder may be rectangular, square, diamond, circular, elliptical, or triangular shaped. In some cases, the shape of a sample holder may be eye-shaped. In some examples, a sample holder may have a tapered, rounded, or flat bottom. In some instances, a sample holder may be a capillary tube, such as a glass capillary tube or coated capillary tube. In other instances, the sample holders may be a slide, such as a glass slide. In still other instances, a sample holder may be a cuvette or a low-volume cuvette made, for example, from plastic or glass. Moreover, a sample holder may be a centrifuge tube made of plastic, glass, or metal, and may be capable of being used in a micro-centrifuge or larger centrifuge.

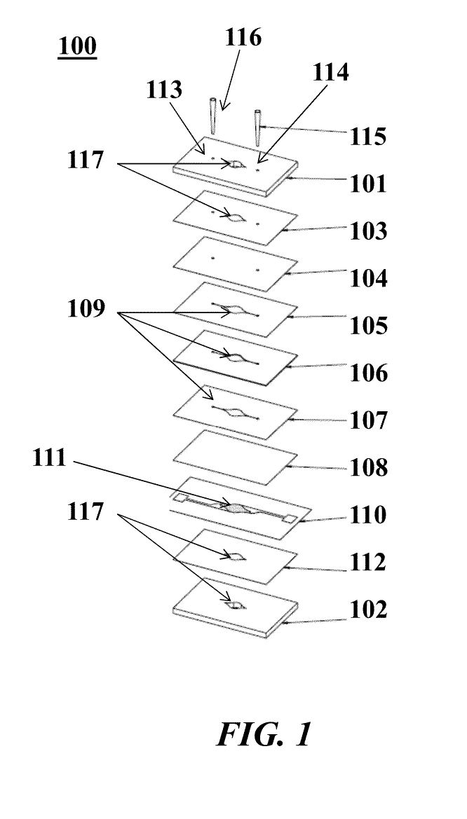

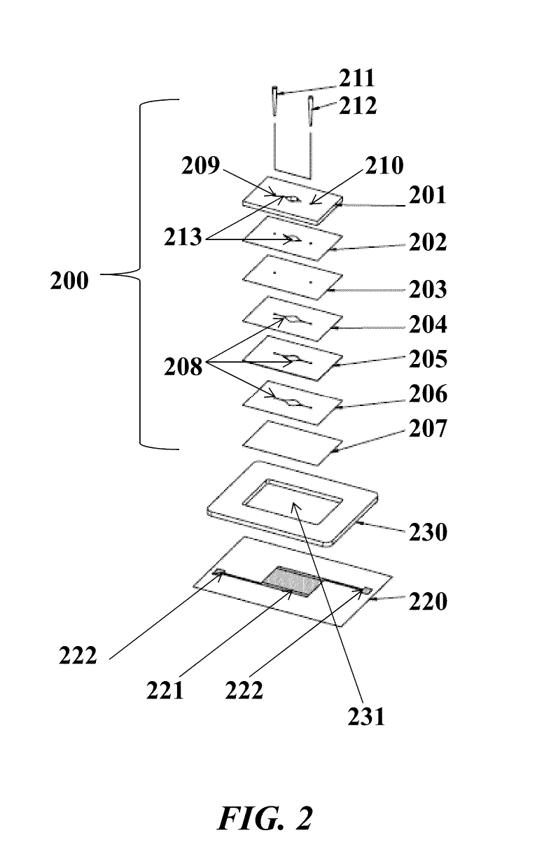

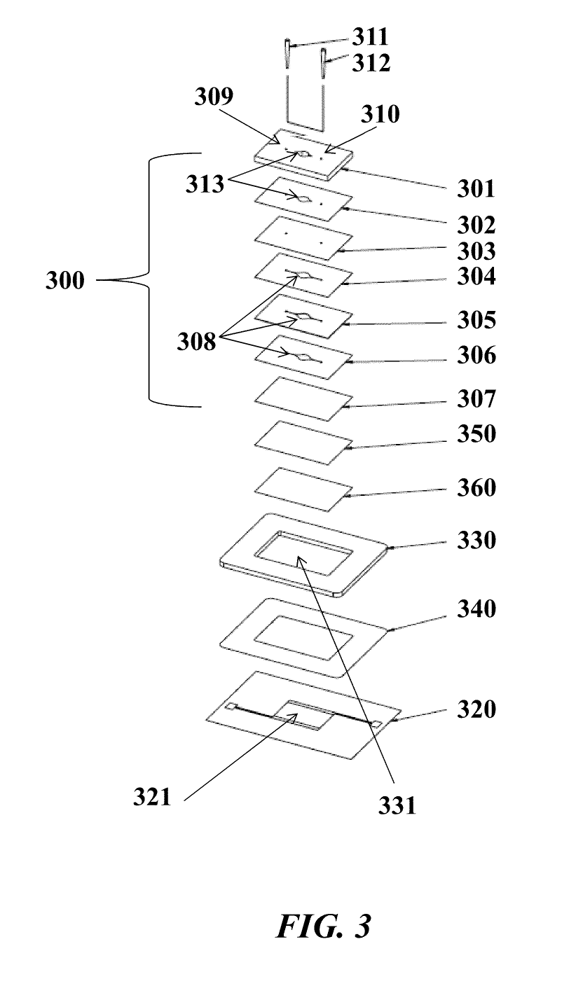

A sample holder may be coated internally and/or externally with one or more materials. Non-limiting examples of coating materials include Teflon, silane, fluorinated polymer, serum albumin (e.g., bovine serum albumin (BSA)), and gp32 protein. In some cases, a sample may not comprise a serum albumin such as, for example, BSA. A coating may be useful for anti-adhesion and may be used to reduce the adhesion of a sample component to the sample holder or to reduce the adhesion of the sample holder to another device component. Also, a sample holder may be open to the external environment and generally accessible, or generally closed to the external environment with its interior accessible via one or more fluidically-connected injection ports (e.g., FIG. 1:113, 114; FIG. 2:209, 210; and FIG. 3:309, 310), or generally closed to the external environment with its interior only accessible by disassembly of the sample holder. In cases where a sample holder includes a fluid-injection port, an injection adaptor (e.g., FIG. 1:115, 116; FIG. 2:211, 212; and FIG. 3:311, 312), that may fit into, around, or on top of, a fluid-injection port, may be used to introduce a sample into the fluid-injection port, and, thus, into the sample holder. For example, an injection adaptor may be a pipette tip.

A sample holder may be designed to contain a single sample or may be designed to contain two or more samples, with each individual sample isolated from the others. In some examples, sample holders that are designed to contain a single sample may be linked together to form one-, two-, or three-dimensional structures. When a sample holder is designed to contain two or more samples, each individual sample may be contained in an individual well of the sample holder. A microplate, for example, may be such a sample holder. Sample holders may include, for example, at least about 2 wells, 4 wells, 6, wells, 8 wells, 12 wells, 24 wells, 36 wells, 48 wells, 54 wells, 60 wells, 66 wells, 72 wells, 78 wells, 84 wells, 90 wells or 96 wells, 144 wells, 192 wells, 384 wells, 768 wells, 1536 wells, 3072 wells, 6144 wells, 12228 wells, or more.

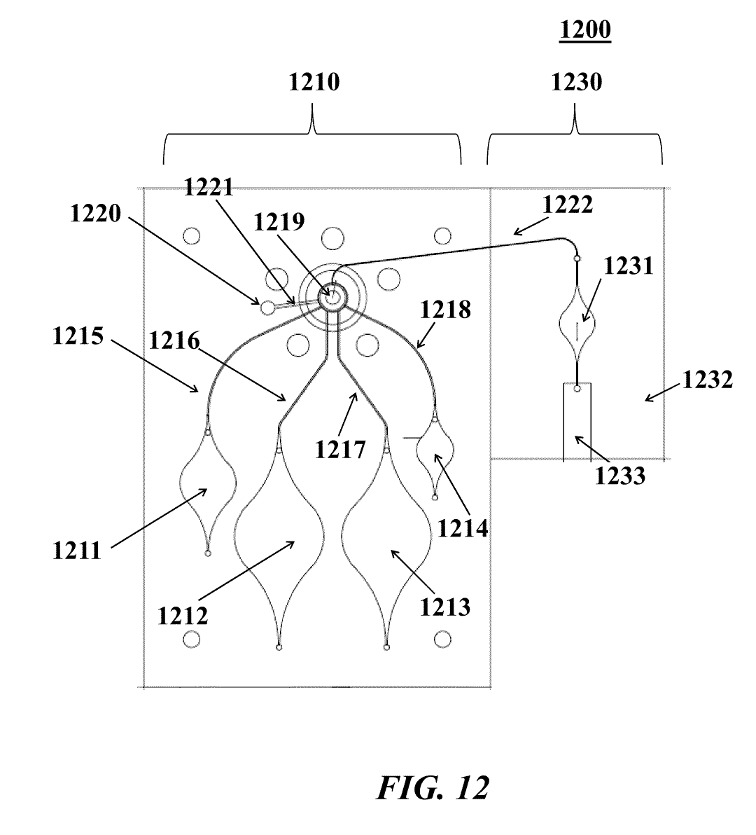

A sample holder may be constructed and arranged as a flow cell. In general, a sample may be supplied to a flow cell such that the sample flows through one or more flow channels of the flow cell. In some cases, a flow cell may be a simple channel. In other cases, a flow cell may be a larger device comprising one or more channels (e.g., see FIG. 12). Moreover, flow cells may be arranged such that flowing sample is directed to flow past one or more auxiliary unit operations in close proximity to a flow channel through which the sample is flowing. With respect to nucleic acid amplification, such auxiliary unit operations may be a heater (see below) or source of cooling gas or liquid (see below) such that regions of the flow channel represent key heating and cooling parts of a thermal cycle. As a sample flows through each region of the flow cell, it may be appropriately heated and cooled such that thermal cycling of the sample is completed with flow. In addition, an auxiliary unit operation may be a detector capable of detecting one or more chemical species in a sample that flows through the flow cell. For example, the flow cell may be constructed and arranged such that the sample flowing through the flow channel is optically accessible, which may be useful for optical detection means.

Flow channels may follow virtually any path, including a tortuous path. For example, a flow channel may be a linear flow channel such as a channel that traverses a linear path or may be a spiral channel (e.g., a channel that traverses a spiral path) such that one side of the spiral is in thermal contact with a heater and the other side of the spiral is in thermal contact with a cooling gas or liquid. Each pass through a loop of the spiral may represent a single thermal cycle.

Flow cells may be constructed to transport samples arranged in a variety of configurations. In some examples, a flow cell may be configured and arranged such that it accepts and transports a bulk fluid through its flow channels. In other examples, a flow cell may be configured and arranged such that it accepts a bulk fluid and generates one or more droplets that are then flowed through its flow channels. In still other examples, the flow cell may be capable of accepting droplets that are generated elsewhere and then flowing those droplets through its flow channels.

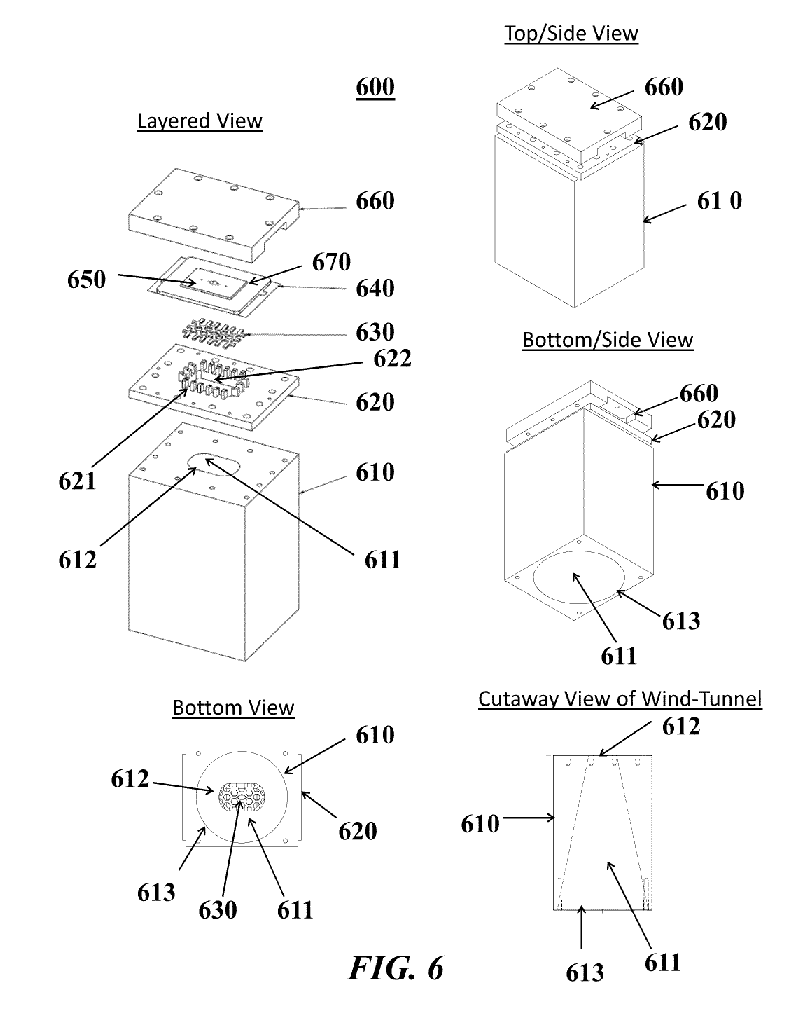

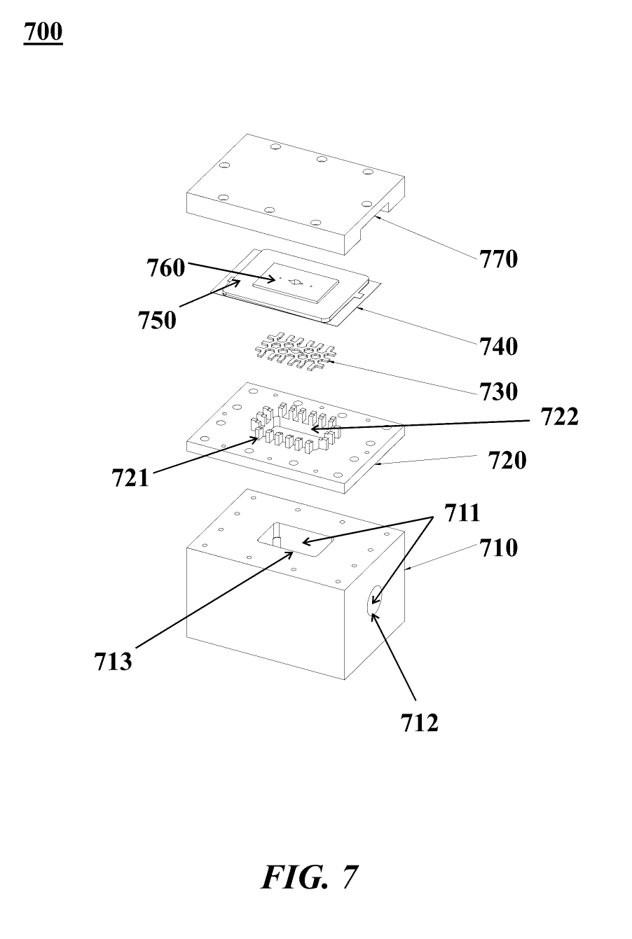

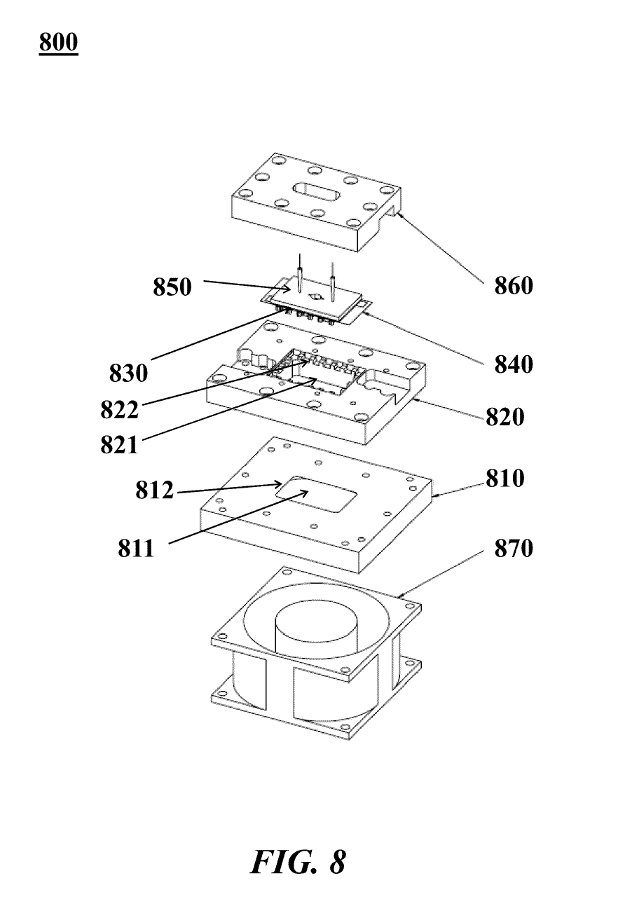

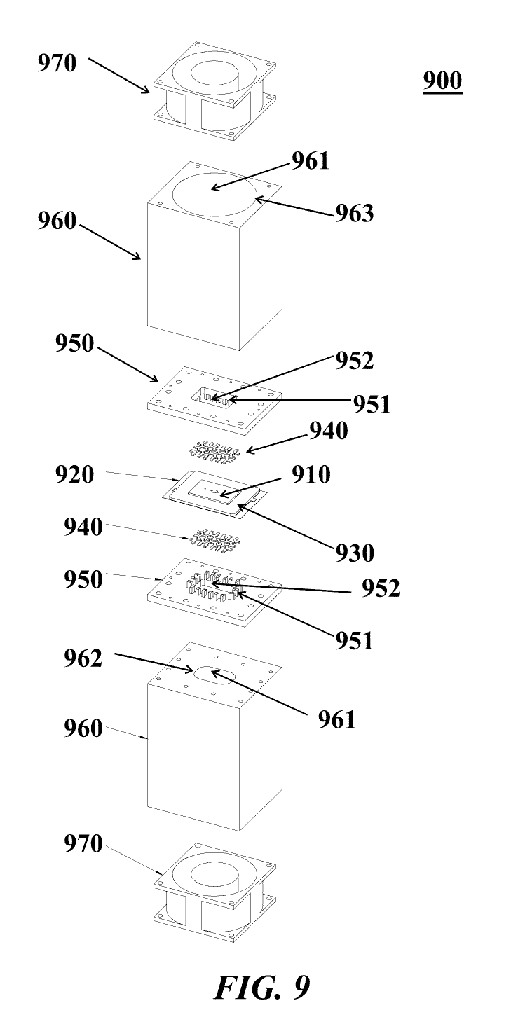

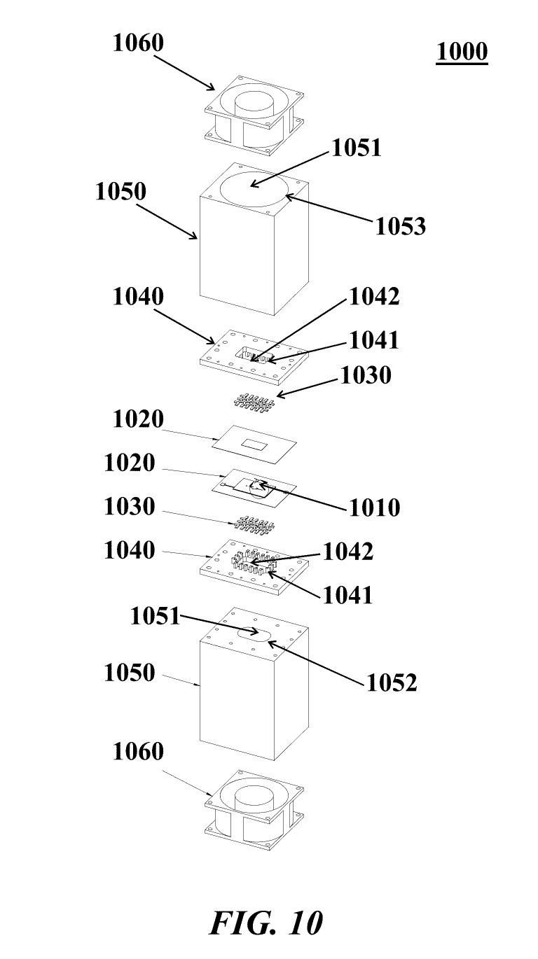

One or more sample holders may be arranged within a cartridge (e.g., chip, disposable chip, disposable cartridge, etc.) (e.g., FIG. 1:100; FIG. 2:200; FIG. 3:300; FIG. 6:650; FIG. 7:760; FIG. 8: 850; FIG. 9:910; and FIG. 10:1010). A cartridge may be assembled, for example, via converted-tape technology (e.g., FIG. 1:100; FIG. 2:200; and FIG. 3:300). Different layers of the cartridge may be constructed of different materials, depending on their intended purpose. In some instances, a layer of a converted-tape cartridge may be an adhesive layer (e.g., FIG. 1:103, 105, 107, 112; FIG. 2:202, 204, 206; and FIG. 3:302, 304, 306) that may be used to immobilize various other cartridge layers with respect to one another. In other instances, a layer of a cartridge assembled via converted-tape technology may be a stiffening layer (e.g., FIG. 1:101, 102; FIG. 2:201; and FIG. 3:301), composed of one or more stiffening materials, such as aluminum, polycarbonate, polypropylene, acrylic, polyoxymethylene (Delrin®), combinations thereof, and composites thereof. A stiffening material may be used to provide structural support and/or provide a casing for the cartridge.

A sample holder may be constructed in a cartridge made via converted-tape technology by a number of methods. For example, a sample holder may be formed in a converted-tape cartridge by cutting the sample holder into the cartridge after partial or full assembly of its individual layers. A sample holder may be cut into the cartridge such that only some of the cartridge's layers are altered. A sample holder may also be cut into the cartridge such that all of the cartridge's layers are altered.

In another example, a sample holder may be formed by cutting the cross-sectional shape of the sample holder into a single cartridge layer, or a set of consecutive cartridge layers prior to cartridge assembly (e.g., FIG. 1:100; FIG. 2:200; and FIG. 3:300). In cases where a set of consecutive layers is cut, the cross-sectional shape cut into the layers determines the length and width characteristics of the sample holder, whereas the stacking of the layers during assembly and the thickness of these layers generally give the sample holder its depth. All layers of a converted-tape cartridge may be cut with a cross-sectional shape to form a sample holder, or only one or some layers of a converted-tape cartridge may be cut. In cases where a single layer is cut, the thickness of the layer gives the sample holder its depth.

Regardless of the strategy used to produce a sample holder in a converted-tape cartridge, one or more seal layers (e.g., FIG. 1:104, 108, 112; FIG. 2:203, 207; and FIG. 3:303, 307) may be included to close an open end of the sample holder off from the external environment and/or other cartridge layers not intended to be included as part of the sample holder. Such seal layers may comprise materials that are generally transparent, capable of strong optical transmission, and/or possess low auto-fluorescence. Such characteristics may be helpful in detecting, via optical modalities (e.g., UV-vis absorbance, fluorescence), one or more species contained within a sample holder. In some cases, a seal layer is a membrane.

A cartridge may also be produced using injection molding techniques. Cartridges are produced via injection molding methods by injecting a molten stream of a material into a mold, wherein the molten material solidifies into the shape of the mold as the molten material cools. The shape of the mold is generally designed to produce the cartridge. A molten stream used to produce a cartridge may consist of a single material, or may be a mixture of materials. Moreover, one or more molten streams may also be used, depending, for example, on the structure of a cartridge. For example, layered addition of different molten streams consisting of different materials to a mold may be useful in forming a cartridge constructed of layers of differing materials. Non-limiting examples of materials that are useful for injection molding techniques and may be used to construct a cartridge include polypropylene, polycarbonate, poly(acrylic acid), acrylic, polyoxymethylene (Delrin®), combinations thereof, and composites thereof. Sample holders may be generated as part of the injection molding process (e.g., the mold may include an element used to pattern the sample holder in the cartridge) or may be cut after the cartridge is constructed.

Sample holders may vary in their volumetric capacity. In some examples, the volumetric capacity of a sample holder may be about 1 nanoliter (“nL”) to about 1 milliliter (“mL”). In some examples, the volumetric capacity of a sample holder may be about 1 nL to about 100 microliters (“μL”). In some examples, the volumetric capacity of a sample holder may be about 1 nL to about 10 μL. In some examples, the volumetric capacity of a sample holder may be from about 1.5 μL to about 4.5 μL. In some examples, the volumetric capacity of a sample holder may be from about 8 μL to about 13 μL. In some examples, the volumetric capacity of a sample holder may be about 1 nL to about 1 μL. In some examples, the volumetric capacity of a sample holder may be about 1 nL to about 100 nL. In some examples, the volumetric capacity of a sample holder may be about 1 nL to about 10 nL. In other examples, the volumetric capacity of a sample holder may be about 1 nL, 10 nL, 100 nL, 1 μL, 10 μL, 100 μL or 1 mL.

In some examples, the volumetric capacity of a sample holder may be at least about 1 nL. In some examples, the volumetric capacity of a sample holder may be at least about 10 nL. In some examples, the volumetric capacity of a sample holder may be at least about 100 nL. In some examples, the volumetric capacity of a sample holder may be at least about 1 μL. In some examples, the volumetric capacity of a sample holder may be at least about 10 μL. In other examples, the volumetric capacity of a sample holder may be at least about 100 μL.

In some examples, the volumetric capacity of a sample holder may be at most about 1 mL. In some examples, the volumetric capacity of a sample holder may be at most about 100 μL. In some examples, the volumetric capacity of a sample holder may be at most about 10 μL. In some examples, the volumetric capacity of a sample holder may be at most about 1 μL. In some examples, the volumetric capacity of a sample holder may be at most about 100 nL. In other examples, the volumetric capacity of a sample holder may be at most about 10 nL, at most about 5 nL, at most about 1.0 nL, at most about 0.5 nL, at most about 0.1 nL, at most about 0.05 nL, at most about 0.01 nL, at most about 0.005 nL, at most about 0.001 nL, at most about 0.0005 nL, at most about 0.0001 nL, at most about 0.00005 nL, or at most about 0.00001 nL.

Samples that may be used in a thermal cycler device may vary in configuration and/or volume depending on the needs of the end user. For example, a device may be capable of receiving a sample in the form of a bulk fluid and/or may be capable of receiving a sample comprising a droplet. Moreover, the amount of available sample (or reagents necessary for nucleic acid amplification) may be limited, and, thus, sample volumes may also be relatively limited. In some examples, the volume of a sample may be about 1 nL to about 1 mL. In some examples, the volume of a sample may be about 1 nL to about 100 μL. In some examples, the sample volume may be from about 1.5 μL to about 4.5 μL. In some examples, the sample volume may be from about 8 μL to about 13 μL. In some examples, the volume of a sample may be about 1 nL to about 10 μL In some examples, the volume of a sample may be about 1 nL to about 1 μL. In some examples, the volume of a sample may be about 1 nL to about 100 nL. In some examples, the volume of a sample may be about 1 nL to about 10 nL. In other examples, the volume of a sample may be about 1 nL, 10 nL, 100 nL, 1 μL, 10 μL, 100 μL, or 1 mL.

In some examples, the volume of a sample may be at least about 1 nL. In some examples, the volume of a sample may be at least about 10 nL. In some examples, the volume of a sample may be at least about 100 nL. In some examples, the volume of a sample may be at least about 1 μL. In some examples, the volume of a sample may be at least about 10 μL. In other examples, the volume of a sample may be at least about 100 μL.

In some examples, the volume of a sample may be at most about 1 mL. In some examples, the volume of a sample may be at most about 100 μL. In some examples, the volume of a sample may be at most about 10 μL. In some examples, the volume of a sample may be at most about 1 μL. In some examples, the volume of a sample may be at most about 100 nL. In other examples, the volume of a sample may be at most about 10 nL. In some examples, the volume of a sample may be at most about 1 nL. In some examples, the volume of a sample may be at most about 0.1 nL, at most about 0.05 nL, at most about 0.01 nL, at most about 0.005 nL, at most about 0.001 nL, at most about 0.0005 nL, at most about 0.0001 nL, at most about 0.00005 nL, or at most about 0.00001 nL.

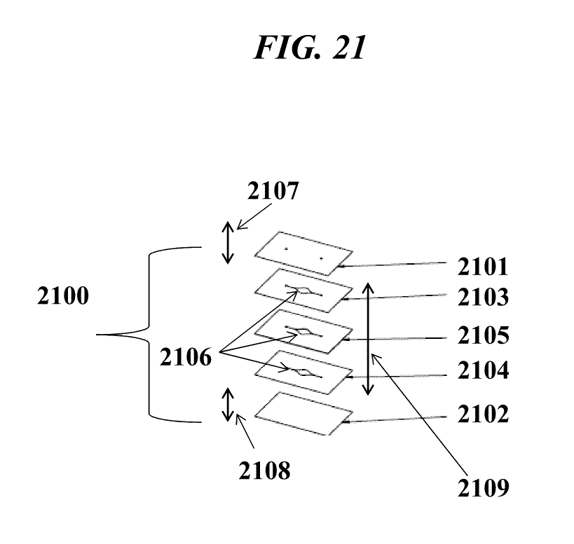

Sample holders may be constructed such that the depth of the sample holder is minimized in order to maximize thermal energy transfer to and from a sample contained in the sample holder. Depth of a sample holder, as used herein, generally refers to the distance from the top of a sample holder to the bottom of a sample holder. For example, in the instance where a sample holder is included in a converted-tape cartridge, the depth of the sample holder would be the total thickness of the layers of the cartridge comprising the sample holder, shown as distance 2109 in the example cartridge shown in FIG. 21. Minimized depth may be a strategy used to optimize the surface area-to-volume ratio of a sample holder and/or minimize the thermal path from a source of thermal energy transfer to a sample contained in a sample holder. Maximized surface areas and minimized thermal paths may generally improve heat transfer to and from a sample contained within a sample holder. In some examples, the depth of a sample holder may be from about 1 μm to about 1 mm. In some examples, the depth of a sample holder may be from about 1 μm to about 100 μm. In some examples, the depth of a sample holder may be from about 10 μm to about 100 μm. In still other examples, the depth of a sample holder may be from about 300 μm to about 500 μm.

In some examples, the depth of a sample holder may be at least about 1 μm. In some examples, the depth of a sample holder may be at least about 10 μm. In some examples, the depth of a sample holder may be about at least about 100 μm.

In some examples, the depth of a sample holder may be at most about 1 mm. In some examples, the depth of a sample holder may be at most about 100 μm. In some examples, the depth of a sample holder may be at most about 10 μm.

In some examples, the depth of a sample holder may be at least about 0.0005 inches (“in”). In some examples, the depth of a sample holder may be at least about 0.010 in. In some examples, the depth of a sample holder may be at least about 0.050 in.

In some examples, the depth of a sample holder may be at most about 0.100 in. In some examples, the depth of a sample holder may be at most about 0.015 in. In some examples, the depth of a sample holder may be at most about 0.020 in.

As sample holders may be constructed within larger components (e.g., a cartridge), the distance between a sample holder and the outer surface of a larger component comprising the sample holder may also be minimized. Minimization of this distance may be a strategy used to minimize thermal path lengths, and, thus, promote more rapid thermal energy transfer. Examples of this distance 2107 and 2108 are shown with respect to a cartridge in FIG. 21. In FIG. 21, cartridge 2100 is assembled as a multitude of layers (seal layers 2101 and 2102; adhesive layers 2103 and 2104; and sample holder layer 2105). A sample holder 2106 is formed by the assembly of the various layers, Distances 2107 (e.g., the thickness of seal layer 2101) and 2108 (e.g., the thickness of seal layer 2102) represent the distance between the sample holder 2106 and the outer surface of the cartridge (top and bottom surfaces of seal layers 2101 and 2102, respectively).

The distance between a sample holder and the outer surface of a larger component comprising the sample holder may vary. In some examples, the distance between a sample holder and the outer surface of a larger component comprising a sample holder may be about 0.0001 in. to about 0.1 in. In other examples, the distance between a sample holder and the outer surface of a larger component comprising a sample holder may be about 0.005 in. to about 0.050 in. In other examples, the distance between a sample holder and the outer surface of a larger component comprising a sample holder may be about 0.005 in. to about 0.020 in. In still other examples, the distance between a sample holder and the outer surface of a larger component comprising a sample holder may be about 0.1 in., 0.050 in., 0.040 in., 0.030 in., 0.025 in., 0.020 in., 0.018 in., 0.016 in., 0.014 in., 0.012 in., 0.010 in., 0.008 in., 0.006 in., 0.004 in., 0.002 in., 0.001 in., 0.0005 in., or 0.0001 in.

In some examples, the distance between a sample holder and the outer surface of a larger component comprising a sample holder may be at most about 0.1 in. In other examples, the distance between a sample holder and the outer surface of a larger component comprising a sample holder may be at most about 0.050 in. In other examples, the distance between a sample holder and the outer surface of a larger component comprising a sample holder may be at most about 0.020 in. In other examples, the distance between a sample holder and the outer surface of a larger component comprising a sample holder may be at most about 0.010 in. In still other examples, the distance between a sample holder and the outer surface of a larger component comprising a sample holder may be at most about 0.1 in., 0.050 in., 0.040 in., 0.030 in., 0.025 in., 0.020 in., 0.018 in., 0.016 in., 0.014 in., 0.012 in., 0.010 in., 0.008 in., 0.006 in., 0.004 in., 0.002 in., 0.001 in, 0.0005 in., or 0.0001 in.

Sample holders may be constructed, in whole or part, from materials that possess strong optical transmission, minimal auto-fluorescence, and/or are generally inert, with non-limiting examples that may include some glasses (e.g., quartz), ultra-violent transparent plastics, acrylics, polycarbonates, polystyrenes, styrene block copolymers (SBCs), styrene acrylonitrile (SAN), ABS, polysulfones, thermoplastic polyesters (such as PET), polypropylene, acrylic-styrene copolymers (SMMA), polyvinylchloride (PVC), nylon, cellulosic resins, cyclic olefin copolymers (COCs), allyl diglycol carbonate (ADC), cyclic olefins (such as TOPAS, ZEONOR and ZEONEX), Delrin, and mixtures or composites thereof. Inert materials may be desirable in order to minimize unwanted side-reactions and/or steric hindrances of a sample contained within a sample holder and the sample holder itself. Moreover, materials of strong optical transmission and/or minimal auto-fluorescence may be used in cases in which optical methods are used to detect and/or quantify species contained within a sample holder. In some examples, sample holders are designed so that light may enter the sample holder on one side and leave the sample holder through an opposite side. In other examples, sample holders are designed so that light may enter and exit the sample through the same side. In still other examples, sample holders are designed so that light may enter the sample on any surface and is directed to exit the sample holder through any surface.

Sample holders may also be constructed using metals. Non-limiting examples of metals that may be used, in whole or part, to construct a sample holder include stainless steel, chromium, other substantially non-reactive metals, or combinations thereof. Metal has a high strength and may permit thinner sample holder surfaces than those obtained by using glass or plastic. Moreover, metals are generally more thermally conductive and thus may allow heat to transfer faster than other materials. A thinner surface may minimize the thermal barrier between the sample and the heating and cooling components of a device, allowing for better thermal control, greater spatial temperature uniformity, and more rapid temperature changes, each of which may result in more efficient nucleic acid amplification reactions.

In cases where a sample holder is generally open to the environment, the sample holder may be sealed from the external environment. During nucleic acid amplification, it is generally desirable to close a sample holder off to the environment in order to prevent evaporation of a contained sample during thermal cycling and/or release of materials (e.g., sample, reagents for amplification, products of amplification). Non-limiting approaches that may be used to seal a sample holder include layering the top of the sample holder with a non-reactive liquid, such as mineral oil or silicon oil; heat sealing the sample holder (e.g., such as by heat sealing a capillary tube) such that it closes; or temporarily or permanently closing the sample holder with, for example, a cap or film.

A cap or film may include any suitable material (e.g., metal, glass, or plastic), or combination of materials, capable of forming a seal with the sample holder. In some cases, a combination of materials may include an adhesive. So long as it may form a proper seal, a cap may have any size or shape, with non-limiting examples of shapes that include a polygon, an ellipse, a circle, a square, a rectangle or a triangle, or partial shapes or combinations of shapes thereof. In some examples, a cap or film may be opaque, translucent, or substantially transparent. In some examples, a cap or film may be of the same material composition of a sample holder or may be of different composition. In some examples, a cap may be coupled its respective sample holder via a tether, which may or may not be hinged, or a cap may be included as a part of the sample holder.

In some examples, a cap or other type of covering may be adapted to readily absorb heat that may be emitted from a heater to a temperature that minimizes condensation. Significant condensation in a closed sample holder, for example from liquid contained within the sample holder, may cause the concentrations of reagents in a sample to change and, thus, alter (perhaps undesirably) the course of a given nucleic acid amplification reaction. In cases where a sample holder is sufficiently thin and/or thermal cycling occurs quickly, condensation may not form and, thus, a heated covering may not be necessary.

For the purpose of quantitative measurements, a cap or film may be constructed from one or more materials that possess strong optical transmission, minimal auto-fluorescence, and/or are generally inert. Inert materials may be desirable in order to minimize reactions of species contained within a sample holder and the cap or film itself. Moreover, materials of strong optical transmission and/or minimal auto-fluorescence may be employed in cases in which optical methods are used to detect and/or quantify species contained within a sample holder. In some examples, the refractive index of the cap or the sample holder may be the same or may be different. Non-limiting examples of materials that may be used for a cap or film used to seal a sample holder include acrylics, polycarbonates, polystyrenes, styrene block copolymers (SBCs), styrene acrylonitrile (SAN), ABS, polysulfones, thermoplastic polyesters (such as PET), polypropylene, acrylic-styrene copolymers (SMMA), polyvinyl chloride (PVC), nylon, cellulosic resins, cyclic olefin copolymers (COCs), allyl diglycol carbonate (ADC), cyclic olefins (such as TOPAS, ZEONOR and ZEONEX), and mixtures thereof.

A sample holder may be configured to receive a sample comprising a nucleic acid template and/or reagents necessary for amplification of the template, including samples and reagents described herein, just prior to nucleic acid amplification. Examples of such a scenario would include the addition of liquid sample comprising a nucleic acid template and liquid reagents necessary for template amplification to a sample holder via pipetting or by microfluidic means, followed by initiation of the desired amplification reaction.

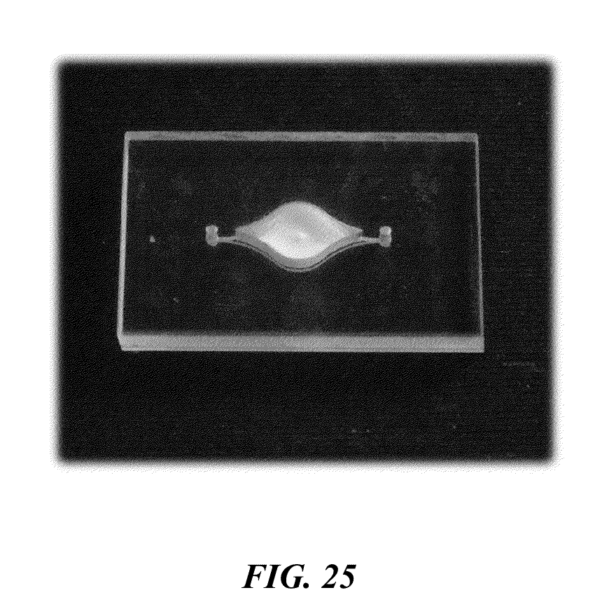

Alternatively, a sample holder may be pre-loaded with a sample comprising a nucleic acid template and/or reagents (or a subset of reagents) necessary for amplification of the template. The contents of the sample holder may then be stored for a period of time prior to amplification of the template. In such cases, materials may be stored in a liquid-phase (e.g., constituted in water or buffer) or in a solid-phase. Solid-phase storage may be advantageous, as it may render stored materials more temperature stable when compared to those constituted in a liquid-phase. An example of materials stored in the solid-phase in the sample holder of a cartridge is shown in FIG. 25.

Materials constituted in a liquid-phase may be brought into a solid-phase by a number of techniques known in the art, with non-limiting examples that include lyophilization (e.g., freeze-drying) and anhydrobiosis (e.g., lyopreservation). Both techniques may be particularly useful for solid-phase storage of biological materials, such as cells, biological fluids (including those described herein), tissues, viruses, enzymes (e.g., polymerases, reverse-transcriptases, exonucleases), dNTPs, primers, amplification cofactors, and mixtures thereof. As such, sample holders described herein may be designed to be compatible with solid-phase generation techniques, including lyophilization and anhydrobiosis.

A high surface-area-to-volume ratio of a sample holder may aid anhydrobioisis or lyophilization, as such a configuration may promote more rapid removal of fluid from a sample during processing. Moreover, the construction geometry of a cartridge may also permit an open sample holder during either anhydrobiosis or lyophilization. In some cases, sealing of the cartridge can be completed after the completion of processing.

Solid materials in a sample holder may be reconstituted into a liquid-phase by the addition of a desired liquid solvent (e.g. water or buffer) into the sample holder. In some cases, the liquid solvent used for reconstitution may comprise a sample comprising a nucleic acid template and/or reagents (or a subset of reagents) necessary for amplification of a template. For example, a sample holder may comprise one or more reagents necessary for a particular type of nucleic acid amplification reaction in the solid-phase. A buffer comprising a sample comprising a nucleic acid template and any other necessary reagents for amplification of the template may be added to the solid-phase reagents, such that the solid-phase reagents are reconstituted and the reaction mixture is readied for the desired amplification reaction.

In another example, a sample holder may comprise a sample comprising a nucleic acid template in the solid-phase and, optionally, one or more reagents necessary for amplification of the template. A buffer comprising additional reagents necessary to amplify the template may be added to the solid-phase sample, such that the solid-phase sample is reconstituted and the reaction mixture is readied for the desired amplification reaction.

In yet another example, a sample holder comprises a sample comprising a nucleic acid template and all reagents necessary for amplification of the template. A buffer is added to the solid-phase materials such that the materials are reconstituted into the liquid phase and the reaction mixture is readied for nucleic acid amplification.

Heat may be added to a sample during reconstitution. In some cases, heat promotes the solvation of a solid phase sample into the liquid phase.

One or more surfaces of a sample holder (e.g., a sample holder wall) and/or the surface of a sealing film may be physically actuated. Physical actuation of such surfaces may aid in mixing of a sample contained therein, which may aid in achieving better heat transfer and/or better diffusion of sample component. Physical actuation may also promote solvation of a solid phase sample into the liquid phase. Physical actuation may be achieved using a number of tools, with non-limiting examples that include a solenoid, magnetic beads, a sonicator, an electric motor, a vibrator, and combinations thereof.

Solid-phase storage of materials may be advantageous for generation of nucleic acid amplification reaction-specific sample holders. A sample holder may be designed to comprise particular reagents for one or more desired nucleic acid amplification reactions. Such sample holders may be particularly useful in executing a specific type of analysis of obtained nucleic acid. For example, a disposable cartridge may be manufactured such that it comprises solid-phase reagents necessary for one or more nucleic acid amplification reactions useful in a particular application, including any of those described herein. Addition of a liquid-phase sample suspected of comprising nucleic acid template(s) to the solid-phase reagents, amplification of any suspected template(s), and analysis of amplification products may be used by an end-user to reach application-specific conclusions about the original sample.

Moreover, as solid-phase materials may be more temperature stable when compared to those constituted in a liquid-phase, the shelf-life of a sample holder comprising solid-phase materials may display a relatively longer shelf-life when compared to a sample comprising liquid-phase materials. For example, the shelf-life of a sample holder comprising solid materials may display a relatively longer shelf-life at unrefrigerated temperatures between 20° C. and 50° C., when compared to a sample comprising liquid materials. Such capability may be particularly useful when materials are to be stored indefinitely (e.g., during storage, during shipment from a manufacturer, during large gaps of time between sample acquisition and analysis, etc.) and/or are to be protected from various environments (e.g., high temperature environments, high humidity environments, luminous environments, etc.). Moreover, a sample holder may also be protected from various environments in order to better protect solid-phase materials contained therein. In some examples, a sample holder is enclosed in a hermetically sealed overwrap for protection. The overwrap may comprise, for example, aluminized plastic or other similar material.

Post-amplification storage of materials, including amplification reaction mixtures (e.g., comprised of reagents necessary for nucleic acid amplification and a template nucleic acid) and amplification products, may also be useful depending on the particular application. Thus, sample holders may also be configured to permit lyophilization of contained materials following the conclusion of a nucleic acid amplification reaction.

### Heaters

A device can include a heater that is capable of heating a sample to varied temperatures at varied rates. Non-limiting examples of such heaters include resistive heater, radiative heater (e.g., infrared heater), or convective heater. Resistive heaters generally operate on the principles of Joule heating, wherein heat is generated by passing electrical current through a resistive material. Non-limiting examples of such resistive materials include resistive inks, nicrome (a composition of 80% nickel and 20% chromium), thin-film nicrome (e.g., TICER™), kanthal (a composition of iron, chromium, and aluminum), nickel-phosphorous (e.g., OhmegaPly®), cupronickel (a composition of copper and nickel), molybdenum disilicide, molybdenum discilicide doped with aluminum and/or silicon, chromium, iridium, rhodium, ruthenium, osmium, molybdenum, tungsten, copper, magnesium oxide, alumina, platinum, silicon carbide, Positive Temperature Coefficient (PTC), ceramic, barium titanate, lead titanate, bismuth telluride, antimony telluraide, bismuth chalcogenides, lead telluride inorganic clathrates, magnesium compounds, silicides, skutterudite thermoelectrics, oxide thermoelectrics, half Heusler alloys, electrically conducting organic materials, silicon-germanium, functionally graded materials, nanomaterials (e.g., quantum dots, graphene), or composites thereof, or combinations thereof. One example of a heater is a thermoelectric device, which may operate through the thermoelectric effect to establish a temperature gradient. Another example of a heater is a Peltier device, which may operate through the thermoelectric effect or Joule heating to establish a temperature gradient.

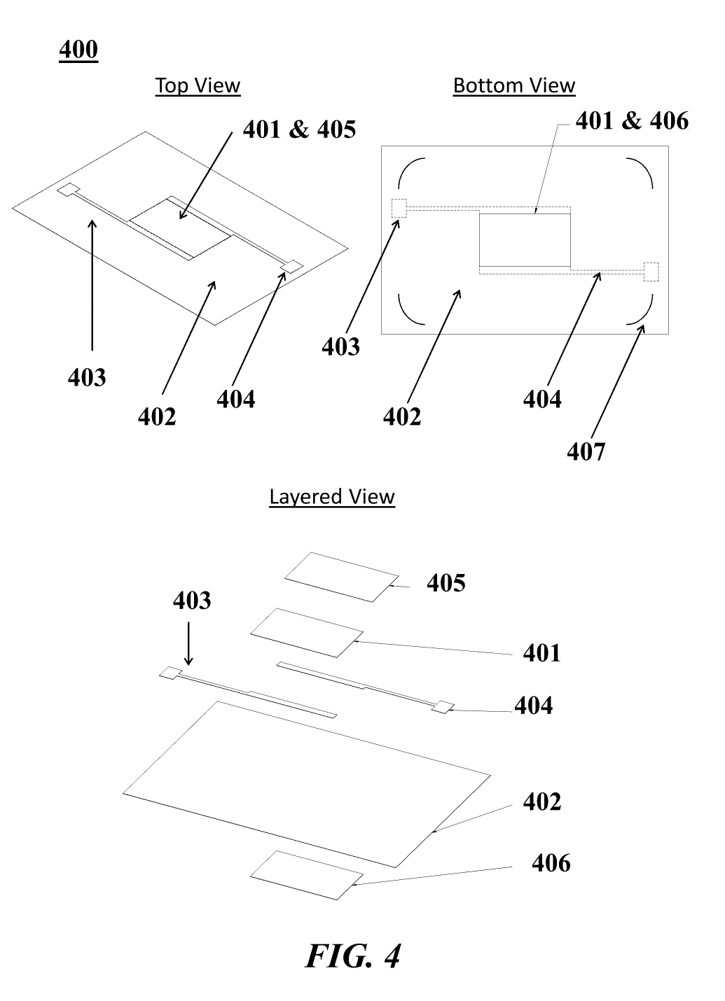

A resistive heater may be arranged as a thin-film resistive heater (e.g., FIG. 1:110+111; FIG. 2:220+221+222; FIG. 3:320+321; FIG. 4:400; FIG. 6:640; FIG. 7:740; FIG. 8:840; FIG. 9:920; and FIG. 10:1020). In general, thin-film technology involves the shaping of one or more resistive materials into a thin layer, referred to herein as a thin-film resistive heating element (e.g., FIG. 1:111; FIG. 2:221; FIG. 3:321; and FIG. 4:401), that may range from less than a nanometer to 5 mm in thickness. Advantages of thin-film technology that may be beneficial to energy transfer include higher surface area-to-volume ratios, lower thermal masses, shorter thermal paths, and more rapid thermal responses. Each of these characteristics may improve the efficiency of heat transfer from the heater to its surrounding environment and may also result in more efficient cooling of a heater and, therefore, any sample holder or sample in thermal contact with it.

Materials used for producing a resistive heater, including nickel-phosphorous and thin-film nicrome, may be particularly useful in constructing a thin-film heater. In some examples, a thin-film resistive heating element may be mounted and positioned on a carrier (e.g., FIG. 4:402). A carrier may provide a substrate for the deposition of materials to form the thin-film resistive heating element and/or provide support for the thin-film resistive heating element and any associated electronic connections. Moreover, a carrier may also provide a substrate on which to mount a thermal spreader, described elsewhere herein. Non-limiting examples of materials that may be used to construct a carrier include polyester, polyimide (e.g., Kapton), polyethylene napthalate, polyetherimide, fluoropolymers, polycarbonate, acrylic, FR-4, pre-preg (pre-impregnated) composite fibers, conformal coatings, paralyne, spin on coatings, vapor deposited coatings, coated metals, silicon-rubber, and combinations thereof. A carrier, for example, may be a flexible circuit board or a printed circuit board. Moreover, a carrier may comprise a single material or may comprise a combination of materials.

A carrier on which a thin-film heating element is mounted may also be thin in order to promote efficient heat transfer. In some examples, the thickness of a carrier is from about 0.0005 in. to about 0.2 in. In some examples, the thickness of a carrier is from about 0.0005 in. to about 0.05 in. In some examples, the thickness of a carrier is from about 0.0005 in. to about 0.03 in. In some examples, the thickness of a carrier is from about 0.0026 in. to about 0.026 in. In some examples, the thickness of a carrier is about 0.0005 in., 0.001 in., 0.002 in., 0.003 in., 0.004 in., 0.005 in., 0.006 in., 0.007 in., 0.008 in., 0.009 in., 0.01 in., 0.011 in., 0.012 in., 0.013 in., 0.014 in., 0.015 in., 0.016 in., 0.017 in., 0.018 in., 0.019 in., 0.02 in., 0.021 in., 0.022 in., 0.023 in., 0.024 in., 0.025 in., 0.026 in., 0.027 in., 0.028 in., 0.029 in., 0.030 in., 0.031 in., 0.032 in., 0.033 in., 0.034 in., 0.035 in., 0.036 in., 0.037 in., 0.038 in., 0.039 in., 0.040 in., 0.041 in., 0.042 in., 0.043 in., 0.044 in., 0.045 in., 0.046 in., 0.047 in., 0.048 in., 0.049 in., 0.050 in., 0.055 in., 0.060 in., 0.065 in., 0.070 in., 0.075 in., 0.080 in., 0.085 in., 0.090 in., 0.095 in., 0.1 in., 0.125 in., 0.15 in., 0.175 in., or 0.2 in. In some examples, the thickness of a carrier is about 0.02 in. In some examples, the thickness of a carrier is about 0.2 in.

A thin-film resistive heater may be optimized for heat transfer, such that the surface area of its heating element is larger than the surface area of a sample holder in thermal contact with the heating element (e.g., FIG. 2:221 and FIG. 3:321). This may be useful for greater heat generation and more uniform heating of the sample holder by the heating element. Alternatively, a heater may be optimized for power usage, such that the surface area of its heating element is minimized (e.g., FIG. 1:111) and, thus, possess lower resistance and lower power needs.

Additionally, a heater may be in contact, in whole or part, with a thermal spreading layer (e.g., FIG. 4:406) of highly thermally conductive material that may promote more uniform and more rapid heating and/or cooling of a sample. A thermal spreading layer, e.g., FIG. 4:406, may also be referred to as a thermal spreader or heat spreader. A highly thermally conductive thermal spreading layer may improve heat transfer between device components (e.g., a sample holder and a heater, a heater and a sample, a sample holder and a cooling gas or liquid, a heater and a cooling gas or liquid, a sample and a cooling gas or liquid, etc.). The thermal spreading layer may be placed above (e.g., FIG. 3:360) or below (e.g., FIG. 4:406) the heater and/or may be mounted on a carrier. Non-limiting examples of highly thermally conductive materials that may be used to construct a thermal spreader include metals such as copper, aluminum, gold, silver, carbon-containing materials (e.g., graphite, graphene, diamond, other allotropes of carbon), ceramics, and aluminum nitride.

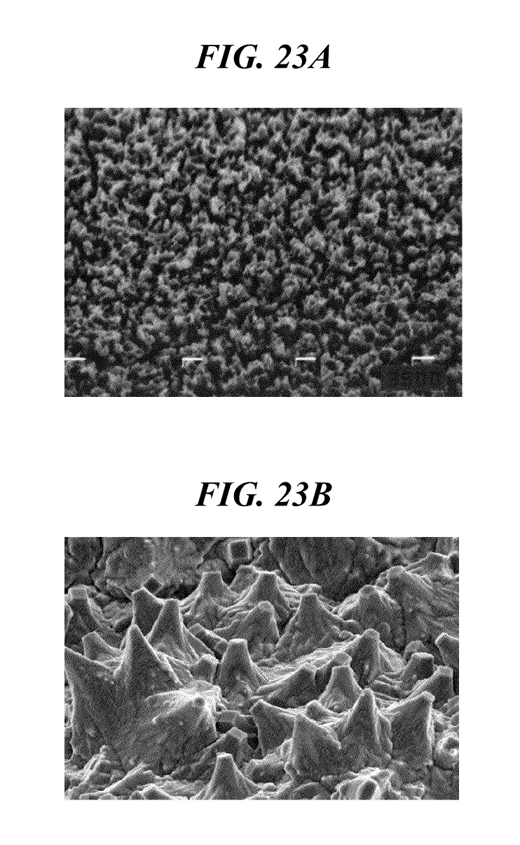

In some cases, a thermal spreading layer may comprise copper. Copper may be a particularly useful material for constructing a thermal spreading layer as it can be deposited on a substrate such that a layer of copper is formed on the substrate. Copper may be deposited via a number of techniques, with non-limiting examples that include electrodeposition techniques, electroplating, electroless copper deposition, vapor deposition, sputter deposition, evaporation, or a combination thereof. While not wishing to be bound by any particular theory, a rough surface can offer more surface area for heat transfer when compared to a smooth surface, and, thus, can improve the efficiency of thermal energy transfer. Rough surfaces may be achieved, for example, by varying the conditions of electroplating as known in the art. Example micrographs displaying a rough copper surface are shown in FIG. 23A and FIG. 23B. Roughness may be generated at any length scale, including the millimeter, the micrometer, the nanometer, and the picometer scales.

A copper thermal spreading layer may also be kept sufficiently thin. In some cases, the thickness of a copper thermal spreading layer may be about 0.1 ounces (“oz”) copper/square foot to about 10 oz. of copper/square foot. In some examples, the thickness of a copper thermal spreading layer may be about 0.25 oz. copper/square foot to about 5 oz. of copper/square foot. In some examples, the thickness of a copper thermal spreading layer may be at least about 0.1 oz. of copper/square foot. In some examples, the thickness of a copper thermal spreading layer may be at most about 10 oz. of copper/square foot. In some examples, the thickness of a copper thermal spreading layer may be at most about 0.5 oz. of copper/square foot. In some examples, the thickness of a copper thermal spreading layer may be at most about 1 oz. of copper/square foot. In some examples, the thickness of a copper thermal spreading layer may be at most about 0.1, 0.2, 0.3, 0.4, 0.5, 0.6, 0.7, 0.8, 0.9, or 1.0 oz. of copper/square foot.

Furthermore, a heater may also be coated and/or covered, in whole or part, with a protective layer (e.g., FIG. 4:405) in order to prevent damage to the heater from, for example, mechanical contacts it makes (for example, with a sample, sample holder, and/or any other materials in mechanical contact with the heater) with various components of a device. A protective layer may or may not be designed to promote heat transfer and/or heat spreading. For example, a thermal spreading layer (e.g., FIG. 3:360) may also serve as a protective and/or heat transfer promotion layer. In some examples, the protective layer and/or thermal spreading layer may be kept thin in order to minimize the layers' effects on heat transfer.

The thickness of a heater may vary depending on the particular heater used and the thickness of the heater components (e.g., thin-film resistive heating element, carrier, thermal spreader, protective layer, or any other heater component described herein). For example, the thickness of a heater may be from about 0.0001 in. to about 0.01 in. In some examples, the thickness of a heater may be from about 0.0001 in. to about 0.005 in. In some examples, the thickness of a heater may be from about 0.0001 in. to about 0.001 in. In still other examples, the thickness of a heater may be about 0.0001, 0.0005, 0.001, 0.0015, 0.0020, 0.0025, 0.0030, 0.0035, 0.0040, 0.0045, 0.0050, 0.0055, 0.0060, 0.0065, 0.0070, 0.0075, 0.0080, 0.0085, 0.0090, 0.0095, 0.01, or 0.1 in.

In some examples, the thickness of a heater may be at most about 0.1 in. In other examples, the thickness of a heater may be at most about 0.01 in. In other examples, the thickness of a heater may be at most about 0.005 in. In still other examples, the thickness of a heater may be at most about 0.0001, 0.0005, 0.001, 0.0015, 0.0020, 0.0025, 0.0030, 0.0035, 0.0040, 0.0045, 0.0050, 0.0055, 0.0060, 0.0065, 0.0070, 0.0075, 0.0080, 0.0085, 0.0090, 0.0095, 0.01, or 0.1 in.

One or more heaters used in a device of the disclosure may be arranged in variety of different configurations with respect to a sample holder(s) or cartridge comprising one or more sample holders. In some examples, a sample holder or cartridge comprising a sample holder may be in thermal contact with a heater in one direction (e.g., FIG. 1, FIG. 2, FIG. 3, FIG. 6, FIG. 7, FIG. 8, and FIG. 9) or may be in thermal contact with a heater in multiple directions (e.g., FIG. 10). In some examples, a sample holder or cartridge comprising a sample holder may be in thermal contact with a single heater (e.g., FIG. 1, FIG. 2, FIG. 3, FIG. 6, FIG. 7, FIG. 8, and FIG. 9). In some examples, a sample holder or cartridge comprising a sample holder may be in thermal contact with multiple heaters, such as, for example, situated between two heaters (e.g., FIG. 10). In some examples, a heater may be in mechanical contact (and, thus, thermal contact) with a sample contained within a sample holder or cartridge comprising a sample holder. Such an arrangement may include, for example, the case wherein a heater is immersed, in whole or part, within a sample. In other examples, a heater may be in mechanical contact with a sample holder or cartridge comprising a sample holder but not in mechanical contact with a contained sample (e.g., FIG. 1, FIG. 2, FIG. 6, FIG. 7, FIG. 8, FIG. 9, and FIG. 10).

In some examples, a sample holder may include a heater that is present in an isolated compartment from that that is used to contain a sample. In other cases, a heater may be arranged within a cartridge that also comprises a sample holder (e.g., FIG. 1). Such a configuration, for example, may include a converted-tape cartridge that includes a thin-film resistive heater layer (e.g., FIG. 1:110) that may or may not be in mechanical contact with the cartridge's sample holder. In other examples, a heater and sample holder may be separate entities that may or may not be in mechanical contact. In cases where a sample holder is separate from a heater and is not in direct mechanical contact with the heater, an appropriate thermal enhancer layer (e.g., a layer used to improve thermal energy transfer between a heater and sample and/or sample holder) (e.g., FIG. 3:350) may separate the heater and sample holder. Non-limiting examples of appropriate materials that may be used in a thermal enhancer layer include thermal grease, a thermal pad, a sheet, glue, graphite, graphene, diamond, metal, copper, aluminum, gold, silver, flexible graphite (e.g., Grafoil®)), or combinations thereof.

An aligner (e.g., FIG. 2:230; FIG. 3:330; FIG. 6:670; FIG. 7:750; and FIG. 9:930) may be utilized for positioning of a sample holder or cartridge comprising a sample holder with respect to a heater or heaters. Such positioning of a sample holder may, for example, be necessary to improve the thermal contact made between the heater and sample holder. One example of an aligner is a solid material, wherein a region, corresponding to the size and shape of one or more sample holders or cartridges, has been removed (e.g., FIG. 2:230; FIG. 3:330; FIG. 6:670; FIG. 7:750; and FIG. 9:930). Proper placement of a sample holder or cartridge in the aligner and proper coupling of the aligner to the heater may adequately position the sample holder relative to the heater. In some examples, the heater comprises an aligner. In other examples, the aligner is a separate device that may or may not be permanently associated with the heater (e.g., FIG. 3:330). Permanent association, for example, may be achieved with an adhesive (e.g., FIG. 3:340). Furthermore, the aligner may incorporate elements of poka-yoke design strategies to prevent a sample holder and heater from being misaligned. A number of such strategies may be used, with non-limiting examples that include slots, holes, bumps, raised surfaces, corners, and combinations thereof.

Whether or not an aligner is used, a heater support (e.g., FIG. 6:630; FIG. 7:730; FIG. 8:830; FIG. 9:940; and FIG. 10:1030) may also be used to improve the thermal contact made between a sample holder, or cartridge comprising a sample holder, and a heater or heaters. In general, a support may be utilized to improve the thermal contact made between a heater and sample holder, or cartridge comprising a sample holder, by forcing the two into better mechanical (and, thus, thermal) contact. Improved mechanical contact may generally minimize empty spaces (e.g., comprised of atmospheric air) between components that can present barriers to thermal energy transfer. Moreover, improved mechanical contact can also reduce thermal path lengths which can also improve thermal energy transfer. Normal forces generated by the support, in opposite reaction to gravity, the weight of other components, and/or another applied force on the heater or sample holder (or cartridge), generally provide improved mechanical contact.

A support may be arranged such that it makes contact with the surface of a heater opposite its surface in mechanical contact with, or closest to, a sample holder or cartridge comprising a sample holder (e.g., FIG. 6, FIG. 7, FIG. 8, FIG. 9, and FIG. 10). Alternatively, a support may be arranged such that it makes contact with the surface of a sample holder, or cartridge comprising a sample holder, opposite to its surface in mechanical contact with, or closest to, a heater (e.g., FIG. 10). In some examples, a support may be a properly designed grill (e.g., FIG. 6:630; FIG. 7:730; FIG. 8:830; FIG. 9:940; and FIG. 10:1030). The grill may be designed strategically, such that its holes are placed to permit ample accessibility to a cooling gas or liquid. Non-limiting examples of materials that may be used to produce a grill include metals, plastics, glass, other thermally conductive materials, or other thermal insulator materials. In some examples, the support may be a thin, stiff, and/or thermally conductive plate.

In cases where a heater or heaters are assembled together with the sample holder, mechanical and thermal contact may be assured by a number of means such as, for example, an adhesive layer between the heater and sample holder. Additionally, the force of a cooling gas or liquid impinging on a heater may be used to hold a heater or heaters and a sample holder in good mechanical and thermal contact.

A heater may be in communication with a control assembly. Such control may be necessary in order to modulate the heating and/or cooling rates of a sample during thermal cycling. A device may be configured or otherwise capable of varied methods of control. In cases where a resistive heater is used, for example, the heater may be controlled by altering the electrical current that is supplied to the heater.

A device generally includes a cooling gas or liquid that is capable of flowing to cool a sample. Flow of a cooling gas or liquid may occur passively or may be forced, by, for example, pressurizing the cooling gas or liquid and/or applying mechanical force to the cooling gas or liquid. In some instances, a gas is used. In some instances, a cooling liquid is not used. Non-limiting examples of a gas that may be used for cooling include environmental air (a composition of nitrogen and oxygen and component of the Earth's atmosphere), carbon dioxide, oxygen, nitrogen, argon, helium, or combinations thereof. In other instances, a liquid is used. A non-limiting example of a liquid that may be used for cooling includes water. A cooling gas may be used for cooling alone, with another cooling gas, or with another cooling liquid. Similarly, a cooling liquid may be used alone, with another cooling liquid, or with a least one other cooling gas.

A cooling gas or liquid may be contained in and supplied from a source, such as, for example, a cooling gas or cooling liquid source. An example of a cooling gas or cooling liquid source includes a pressurized vessel. In some examples, the pressure inside such a vessel may be greater than 1 atmosphere (“atm”), greater than 10 atm, greater than 100 atm, or greater than 1000 atm. A cooling gas or liquid may be supplied with the aid of a compressor or pump, or other mechanical or electromechanical device that is configured to effect fluid flow. An example of a source of a cooling gas includes a gas canister (e.g., compressed gas canister, a carbon dioxide (CO₂) canister). Non-limiting examples of devices that may be used to effect the flow of a cooling gas include a compressor or a fan (e.g., a direct current (DC), an alternating current (AC) fan, a squirrel cage fan) (e.g., FIG. 8:870; FIG. 9:970; and FIG. 10:1060). A cooling liquid may be supplied with the aid of a pump, fan, compressor, or combinations thereof. An example of a source of a cooling liquid includes a liquid canister (e.g., compressed liquid canister) and a gas canister (e.g., a compressed gas canister).

A source of cooling gas or liquid may be in communication with a valve and/or control assembly that is capable of altering the rate at which the source supplies its cooling gas or cooling liquid. Control of a cooling gas or liquid can modulate both heating and cooling rates. For example, a control assembly may control the rate at which electrical current is supplied to a fan arranged to supply cooling air, which, in turn, may alter the speed of the fan, and, thus, the rate at which cooling gas is supplied. In cases where multiple sources of cooling gas or liquid are used, such sources may be arranged consecutively, in parallel, or in a mixed configuration.

A source of cooling gas or liquid may be controlled by a valve. For example, during heating of a sample holder, the valve may be closed or partially closed. Halted or reduced flow of a cooling gas or liquid may decrease the cooling effect of the gas or liquid, and, thus, increase the rate of heat supplied by a heater to a sample. For cooling, the valve may be opened or further opened to increase the flow rate of a cooling gas or liquid and decrease the rate of heat of heat supplied by a heater to a sample. Moreover, a pulsed flow of a cooling gas or liquid may also be utilized to improve the cooling of a heater and/or a sample holder.

A source of cooling gas or liquid may be arranged such that a gas or liquid in the source contacts a surface of any component of a device, with non-limiting examples of such components including a sample, a sample holder, a cartridge comprising a sample holder, and a heater. In general, a source of cooling gas or liquid may be arranged such that a cooling gas or liquid in the source flows parallel to the intended surface of its target component during contact, impinges its cooling gas or liquid normal to the intended surface of its target component during contact (e.g., FIG. 6, FIG. 7, FIG. 8, FIG. 9, and FIG. 10), or a combination thereof. The cooling gas or liquid may flow along a fluid flow path (e.g., channel) in or in fluid communication with the source. In cases where at least some cooling gas or liquid is impinged on a surface of a component, a set of fins (e.g., FIG. 4:407, 6:621, 7:721, 9:951, 10:1041) may be used in order to properly exhaust and distribute the impinging cooling gas or liquid. Proper exhausting and distribution of a cooling gas or liquid may be employed, depending on the particular setup, in order to ensure that a cooling gas or liquid makes uniform contact with its intended device surface, such that all areas of the surface contact the cooling gas or liquid and uniform cooling is provided.

Additionally, impingement of a cooling gas or liquid on a heater, sample holder, cartridge comprising a sample holder, and/or an optionally used support, may provide additional force (in addition to normal forces in response to the force of gravity) to force a heater and sample holder, or cartridge comprising a sample holder, into better mechanical contact, which may also aid in improving thermal contact. Generally, higher-velocity, high pressure, high volumetric flow rates may provide for more effective cooling.

The flow rate of a cooling gas may vary. For example, the flow rate of a cooling gas may be from about 0.1 standard cubic feet per minute (SCFM) to about 50 SCFM. In some examples, the flow rate of a cooling gas may be from about 1 SCFM to about 20 SCFM. In some examples, the flow rate of a cooling gas may be from about 1 SCFM to about 10 SCFM. In still other examples, the flow rate of a cooling gas may be about 0.1, 0.5, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 25.0, 30.0, 35.0, 40.0, 45.0, or 50.0 SCFM.

In some examples, the flow rate of a cooling gas may be at least about 0.1 SCFM. In some examples, the flow rate of a cooling gas may be at least about 5 SCFM. In some examples, the flow rate of a cooling gas may be at least about 10 SCFM. In some examples, the flow rate of a cooling gas may be at least about 20 SCFM.

In some examples, the flow rate of a cooling gas may be at most about 50 SCFM. In some examples, the flow rate of a cooling gas may be at most about 20 SCFM. In some examples, the flow rate of a cooling gas may be at most about 10 SCFM. In some examples, the flow rate of a cooling gas may be at most about 5 SCFM. In some examples, a source of cooling gas or liquid may be arranged to distribute its respective gas or liquid onto the surface of a single component of a device (e.g. FIG. 6, FIG. 7, FIG. 8, and FIG. 9). In some examples, a source of cooling gas or liquid may be arranged to distribute its respective gas or liquid onto surfaces of multiple components of the device (e.g., FIG. 10). In some examples, a source of cooling gas or liquid may be arranged to contact its respective gas or liquid on a sample contained within a sample holder. In some examples, a source of cooling gas or liquid may be arranged to contact its respective gas or liquid on the surface of a sample holder or cartridge comprising a sample holder (e.g., FIG. 10). In some examples, a source of cooling gas or liquid may be arranged to contact its respective gas or liquid on the surface of a heater (e.g., FIG. 6, FIG. 7, FIG. 8, and FIG. 9).

A source of cooling gas of liquid may be arranged to contact several surfaces through a plenum or manifold. In such a configuration, a plurality of sample holders may be cooled concurrently. The thermal cycling profile of each sample holder may be controlled independent of the other sample holders by separate heaters and separate control loop. Moreover, a plurality of sample holders may also be thermal cycled under the control of a single temperature sensor (as described elsewhere herein) and or control loop.

### Thermal Path Lengths

A device may be configured such that the thermal path length between a point in a sample contained within a sample holder and a source of thermal energy transfer (e.g., a heater, a cooling gas, or a cooling liquid) is minimized. For example, the thickness of cartridge layers, heaters, etc. may be minimized for this purpose. Minimized thermal path lengths may be useful, for example, in achieving more rapid heating and/or cooling rates. For example, a thermal path length may be from about 0.0001 in. to about 0.1 in. In some examples, a thermal path length may be from about 0.0005 in. to about 0.05 in. In some examples, a thermal path length may be from about 0.0001 in. to about 0.01 in. In some examples, a thermal path length may be from about 0.0001 in. to about 0.001 in. In still other examples, a thermal path length may be about 0.0001, 0.0005, 0.001, 0.005, 0.01, 0.05, 0.1, or 0.5 in.

In some examples, a thermal path length may be at most about 0.1 in. In some examples, a thermal path length may be at most about 0.05 in. In some examples, a thermal path length may be at most about 0.03 in. In some examples, a thermal path length may be at most about 0.01 in. In some examples, a thermal path length may be at most about 0.005 in. In some examples, a thermal path length may be at most about 0.001 in.

### Guide Devices

A device of the disclosure may include one or more guide devices that are capable of properly directing a cooling gas or liquid as it flows from its source to make contact with the intended surface of its target component. Such devices may also be capable of modulating velocity, pressure, and/or volume of the cooling gas or liquid as it is supplied by a source. In general, a guide device may be configured to occupy space between a source of cooling gas or liquid and the intended target component or components of the device (e.g., FIG. 6, FIG. 7, FIG. 8, FIG. 9, and FIG. 10). Non-limiting examples of a guide device include a wind-tunnel and a nozzle.

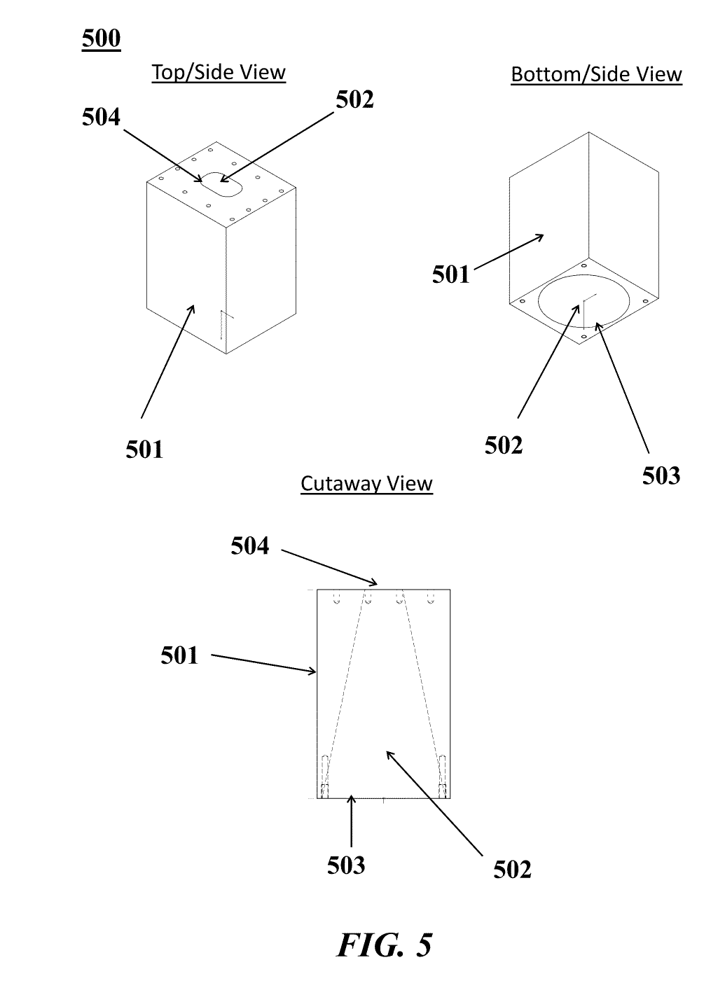

A “wind tunnel” (e.g., FIG. 5:500; FIG. 6:610; FIG. 7:710; FIG. 8:810; FIG. 9:960; and FIG. 10:1050) generally refers to a solid, hollowed-out device thorough which a gas or liquid may flow. At one end of its hollow (e.g., FIG. 5:503; FIG. 6:611; FIG. 7:712; FIG. 9:961; and FIG. 10:1051), the wind tunnel may receive a cooling gas or liquid from its source. As a cooling gas or liquid flows through the wind tunnel, its volumetric flow rate and/or pressure may be altered. The cooling gas or liquid exits the wind tunnel, though an opposite end of its hollow.

In some examples, a hollow may be designed to linearly traverse a wind tunnel, wherein the ends of the hollow are open at opposite surfaces of the wind tunnel (e.g., FIG. 5, FIG. 6, FIG. 8, FIG. 9, and FIG. 10). In other examples, a hollow may be designed to perpendicularly traverse a wind tunnel, such that the ends of the hollow are open at surfaces perpendicular to one another (e.g., FIG. 7). In still other examples, a hollow may be designed such that the ends of the hollow are open at surfaces neither opposite nor perpendicular to one another. In still other examples, a hollow may be designed such that the ends of the hollow are open at the same surface of the wind tunnel. In general, a hollow may traverse a wind tunnel in any path, including linear configurations, perpendicular configurations, or more tortuous configurations.

The cross-sectional area of a hollow may assume virtually any shape and may change throughout the length of the hollow (e.g., FIG. 5, FIG. 6, FIG. 7, FIG. 9, and FIG. 10). For example, a wind tunnel may have a circular hollow, open at opposing surfaces of the wind tunnel, and may taper (e.g., the circular cross-sectional area of the hollow is reduced) as the hollow traverses the wind tunnel (e.g., FIG. 5 and FIG. 6). Non-limiting examples of shapes that may be assumed by the cross-sectional area of a hollow include a circle, square, rectangle, oval, rhombus, parallelogram, trapezoid, ellipse, triangle, pentagon, hexagon, heptagon, octagon, or other higher-order polygons. Moreover, a wind tunnel utilized in a device of the disclosure may be arranged to direct a cooling gas or fluid parallel to the surface of a device component, normal to the surface of a device component, or a combination thereof. Wind tunnels may be constructed of varied materials, with non-limiting examples that include metals, plastics, glass, ceramics, or combinations thereof.

A device may include a single wind tunnel (e.g., FIG. 6, FIG. 7, and FIG. 8) or may include multiple wind tunnels (e.g., FIG. 9 and FIG. 10). In some examples, wherein a device includes multiple wind tunnels, the multiple wind tunnels may be arranged consecutively in series or may be arranged opposite to each other to, for example, direct a cooling gas or fluid to opposite surfaces of a target component (e.g., FIG. 9 and FIG. 10).

A guide device may be a nozzle. A “nozzle” is generally a spout that is capable of controlling the direction and flow characteristics of a gas or liquid as it exits an enclosed chamber via an orifice. A nozzle, for example, may be included as part of a source of cooling gas or liquid and may be fluidically connected to a compartment in a source that contains a cooling gas or liquid. In some examples, a nozzle is held in a fixed position such that its position may not be altered. In other examples, the positioning of a nozzle may be altered, such that the direction of flow emanating from the nozzle is also altered. In some examples, a nozzle may provide a single stream of gas or liquid, such as, for example, in cases where a nozzle comprises a single outlet. In other examples, a nozzle may provide multiple streams of gas, such as, for example, in cases where a nozzle comprises multiple outlets. In examples where a grill support is used, a nozzle may be arranged such that flow emanating from the nozzle is directed to traverse one or more holes in the grill support.

Alternatively, in examples where any type of support is used, a nozzle may be arranged such that flow emanating from the nozzle is directed to contact the support and, optionally, to bring a sample holder and heater in mechanical contact with one another. The flow emanating from the nozzle may provide improved mechanical contact between the sample holder and heater. Furthermore, a device of the disclosure may include a single nozzle or multiple nozzles. In some examples, wherein a device includes multiple nozzles, the nozzles may be arranged opposite to each other to, for example direct a cooling gas or fluid to opposite surfaces of a target component. Moreover, a nozzle may be utilized in conjunction with another type of guide devices such as, for example, one or more wind tunnels. Non-limiting examples of other materials that may compose a nozzle include metals, plastics, glass, ceramics, and combinations thereof.

Upon exiting a guide device, a cooling gas or liquid may experience adiabatic cooling, which may aid in providing additional cooling to a heater, sample holder, and/or sample.

### Clamps

A device of the disclosure may also include one or more clamps (e.g., FIG. 6:620, 660; FIG. 7:720, 770; FIG. 8:820, 860; FIG. 9:950; and FIG. 10:1040). A clamp may be used to provide structural support to a device, immobilize any component of the device (e.g., a sample holder), and/or provide proper positioning to a device component. In some examples, a clamp may be used to properly position a cartridge or sample holder and/or immobilizing the cartridge or sample holder such that it does not move during thermal cycling. Such immobilization may be especially useful in cases where flow of a cooling gas or liquid may otherwise cause unwanted movement of the cartridge or sample holder. In some examples, a device may include a single clamp. In other examples, the device may include multiple clamps (e.g., FIG. 6, FIG. 7, FIG. 8, FIG. 9, and FIG. 10). In some examples, a component of a device may be in mechanical contact with a single clamp or may be in mechanical contact with multiple clamps. In other examples, a clamp may be in mechanical contact with multiple device components or with a single device component. Moreover, one or more device components may be situated between two or more clamps (e.g., FIG. 6, FIG. 7, FIG. 8, FIG. 9, and FIG. 10).

In some examples, a device component may form fit to one or more recesses cut into a clamp and rest in the clamp by gravity or may snap-fit to a device component in order to immobilize, provide support to, and/or properly position the device component. Furthermore, a clamp may be held in tension with its respective device component or components, in order to better force a component into mechanical contact with the clamp. In examples where one or more device components are situated between two or more clamps, the clamps may be held in compression with respect to one another in order to force the situated components into better mechanical contact with one another. Compression may be achieved, for example, with one or more screws (e.g., metal screws, plastic screws, ceramic screws, wood screws, bolts, nuts, fasteners, etc.) that link a component with its respective holder, link a component with other components, or link two or more holders together. Clamps may be constructed from a variety of materials, with non-limiting examples that include metals, plastics, glass, ceramics, or combinations thereof.

### Temperature Sensors

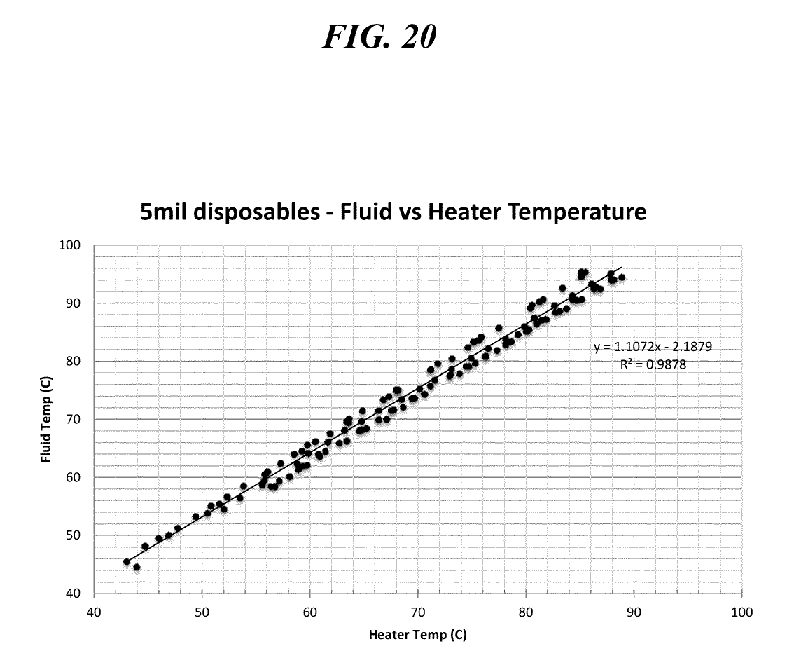

A device of the disclosure may include one or more temperature sensors. Such sensors may be useful in monitoring the temperature of a sample and/or any device component. Monitoring of sample temperature and/or the temperature of a component in thermal contact with the sample is generally critical in thermal cycle based nucleic acid amplification as different temperatures are required for different steps of a thermal cycle. In some examples, a temperature sensor may be included in a sample holder, wherein the temperature sensor is immersed, in whole part, in a contained sample. In other examples, a temperature sensor may be appended to another component (e.g., a heater) in thermal contact with the sample such that it measures the temperature of the component. The component temperature may, via calibration, be used to indirectly measure sample temperature (e.g., FIG. 20). A temperature sensor used to measure the temperature of a sample and a temperature sensor used to measure the temperature of a heater may be used in combination, or a device may include one or the other. A temperature sensor may, for example, be used to record the temperature of a component and arranged to communicate with a control device that may alter the output of a heater and/or source of cooling gas or liquid such that the desired or otherwise predetermined temperatures and/or heating/cooling profiles of thermal cycling may achieved, in some cases in the desired or otherwise predetermined order. A temperature sensor may be, for example, a thermocouple, an infrared (IR) detector, a platinum resistive temperature detector (PRTD), a resistive temperature detector (RTD). The temperature of a sample may also be measured via liquid crystals that are included in a sample holder or via infrared measurements, which do not generally require a temperature sensor in contact with the sample.

### Power Sources

A device of the disclosure is generally powered by a power supply. The device may be electrically coupled to the power supply. As an alternative, the device may include a power supply, such as an integral power supply or removable power supply. A power supply may provide a source of electrical power to a heater of the device, source of cooling gas or liquid, and/or any other component of the device. Non-limiting examples or power supplies that may be utilized in a device of the disclosure include a solid state energy storage device (e.g., ultracapacitor), electrochemical energy storage device (e.g., lithium ion battery, NiCd battery), a battery, solar panel, a plug-in power supply, or a variable voltage power-supply. A power supply may be in communication with a control assembly in order to modulate any device to which it supplies electrical current.

### Systems Comprising Devices

One or more devices of the disclosure may be included as part of a system that includes one or more other devices and/or unit operations (e.g., FIG. 12:1200). For example, one or more pre-processing unit operations (e.g., FIG. 12:1210) may be arranged upstream from and fluidically connected to a device of the disclosure. In some instances, a pre-processing unit operation may be a unit operation that is capable of lysing or otherwise disrupting biological envelopes and extracting nucleic acid to be amplified from a raw sample. Nucleic acid extraction may be completed by the unit operation, for example, by mixing cell lysis reagents with nucleic acid containing cells or viruses that are included in a raw sample. In other instances, a pre-processing unit operation may be a unit operation that is capable of mixing (e.g., FIG. 12:1210), in the appropriate ratio, a nucleic acid to be amplified with the additional reagents (e.g., primer, polymerization enzyme, reverse transcriptase, dNTPs) necessary to complete nucleic acid amplification. Each additional reagent and nucleic acid may be stored separately within the unit operation prior to mixing, some additional reagents required for nucleic acid amplification may be pre-mixed with other additional reagents required for nucleic acid amplification, and/or some of the additional reagents may be pre-mixed with nucleic acid to be amplified. In cases where the larger system is arranged to perform quantitative nucleic acid amplification (e.g., Q-PCR, Q-LCR, dQ-PCR, dQ-LCR) or real-time quantitative nucleic acid amplification (e.g., RTQ-PCR, RTQ-LCR, dRTQ-PCR, dRTQ-LCR), such pre-processing units may be capable of, for example, labeling appropriate probes with reporters prior to thermal cycling in a device of the disclosure. In cases where the larger system is arranged to perform a digital nucleic acid amplification reaction, such pre-processing units may be capable of, for example, partitioning a larger sample (e.g., a bulk fluid) into smaller entities, such as, for example, droplets.

Moreover, one or more post-processing unit operations may be arranged downstream from and fluidically connected to a device of the disclosure. In some instances, a downstream unit operation may be a separation unit designed to further purify an amplification product from other reagents originally present in a sample. A separation unit operation, for example, may be a filtration unit operation or a unit operation configured to separate nucleic acids via electrophoresis.

A downstream unit operation may be coupled to a detector that is capable of detecting and, possibly, quantifying any species of a sample, including amplification products. Non-limiting examples of such detectors include optical detectors (e.g., UV-Vis absorbance detectors, fluorescence detectors), spectroscopic detectors, nuclear magnetic resonance detectors, dynamic light scattering detectors, and luminescence detectors. A system may include a detector that is arranged to detect any component of a sample, such that detection occurs in situ as the sample is contained in its respective sample holder without sample transport downstream. Such an arrangement may be useful, for example, with real-time nucleic acid amplification methods, such as RTQ-PCR, RTQ-LCR, dRTQ-PCR, and dRTQ-LCR.

Unit operations included as part of a system that also includes one or more devices of the disclosure may be arranged such that the unit operations and one or more devices of the disclosure are components of a micro-fluidic, or other fluidic circuit, or a combination thereof. Transport of materials from one unit operation to the next occurs via active flow in micro-fluidic or other fluidic channels, respectively. Flow may be initiated using force, such as, for example, force applied via one or more pumps suitable for a given circuit.

A system may be capable of being operated in batch mode, such that each unit operation step is completed in discrete steps, perhaps at different, discontinuous time points. In other instances, a system may be capable of being operated in batch mode or continuous mode. In continuous mode, material is transported continuously throughout the system in an assembly-line fashion, wherein each unit operation step continuously processes the material as it flows through the system.

### Housings

A device of the disclosure or a system that includes the device may also be contained within a housing or casing for the purposes of transport, protection from the environment, and/or to promote a compact design. The housing can be formed of a metallic material (e.g., aluminum), polymeric material (e.g., plastic), composite material, or combinations thereof. The housing can be formed of a single piece (e.g., unitary construction) or multiple pieces. The housing can have a varied length, width, and height. In some examples, the length, width, and height of a housing are from about 1 inch (“in.”) to about 1 foot (“ft”). In some examples, the length, width, and height of a housing is at least about 1 in. In some examples, the length, width, and height of a housing is at most about 1 ft.

### Control Assembly

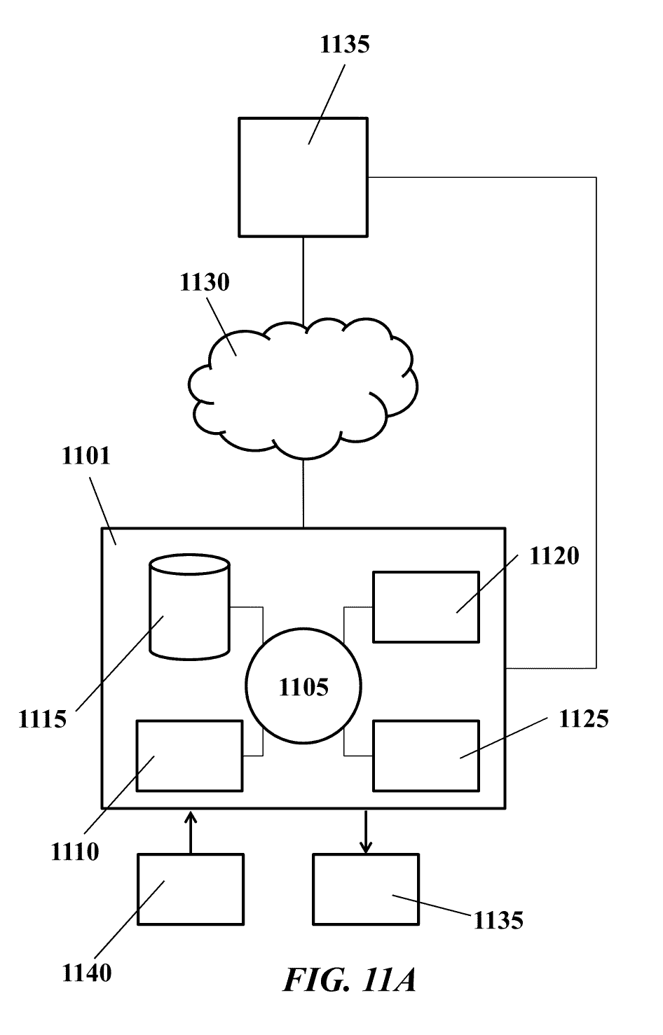

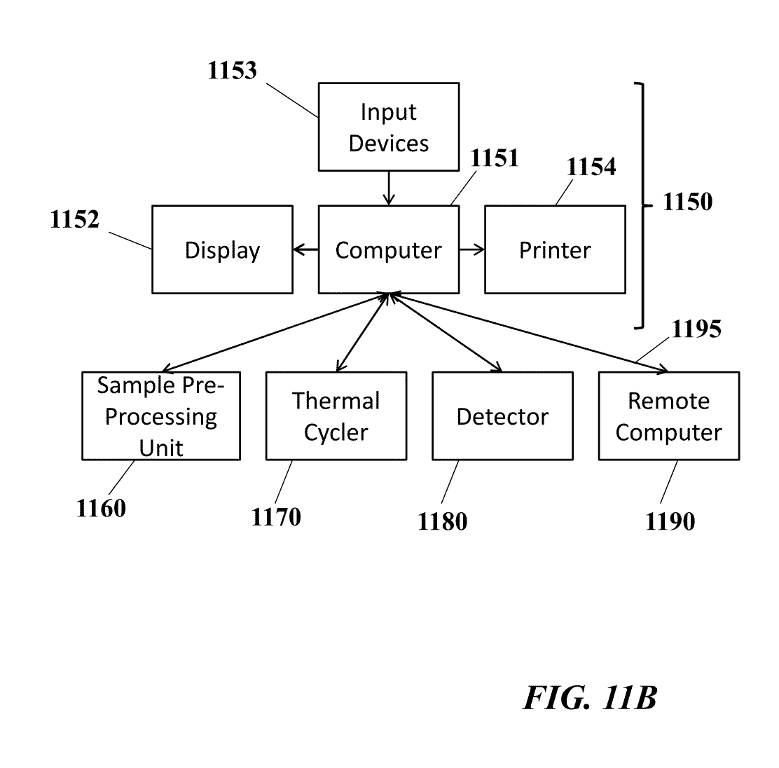

A device or system that comprises the device may be arranged such that it is in communication with a control assembly (e.g., FIG. 11B:1150). For example, the control assembly may be capable of modulating a source of cooling gas or liquid (e.g., altering, for example, the speed of a fan or controlling the flow of the gas or liquid via a controlled valve) and/or the output of a heater (e.g., via electrical input given by the controller to the heater). Moreover, the control assembly may be used for device or system automation, such that it may be programmed to, for example, automatically pre-process samples, perform a desired number of nucleic acid amplification cycles, execute a program that specifies thermal cycling parameters (e.g., temperatures, hold times, etc.), obtain measurements (if desired), digitize any measurements into data, and/or analyze data.

In some examples, a control assembly may control circuitry of a device that is capable of modulating a heater, and, thus, control the temperature of a sample during thermal cycling. In some examples, a control assembly may control circuitry of a device that is capable of modulating the flow of a cooling gas or liquid, and, thus, control the temperature of a sample during thermal cycling.

In examples where a control assembly acquires and analyzes data, the control assembly may communicate with an appropriate measurement device (e.g., a detector), digitize signals (i.e., raw data) obtained from the measurement device, and/or processes raw data into a readable form (e.g., table, chart, grid, graph or other output known in the art). Such a form may be displayed or recorded electronically or provided in a paper format.

A control assembly, for example, may include a processor which may or may not be included as part of a computer server. In cases where a computer server is absent, a control assembly may include a processor and any additional hardware (including hardware described herein) required for processor operation. An example computer server 1101 is shown in FIG. 11A. The computer server (“server”) may be programmed, for example, to operate any component of a device or system and/or execute methods described herein. The server 1101 includes a central processing unit (CPU, also “processor”) 1105 which can be a single core processor, a multi core processor, or plurality of processors for parallel processing. A processor used as part of a control assembly may be a microprocessor. The server 1101 also includes memory 1110 (e.g. random access memory, read-only memory, flash memory); electronic storage unit 1115 (e.g. hard disk); communications interface 1120 (e.g. network adaptor) for communicating with one or more other systems; and peripheral devices 1125 which may include cache, other memory, data storage, and/or electronic display adaptors. The memory 1110, storage unit 1115, interface 1120, and peripheral devices 1125 are in communication with the processor 1105 through a communications bus (solid lines), such as a motherboard. The storage unit 1115 can be a data storage unit for storing data. The server 1101 is operatively coupled to a computer network (“network”) 1130 with the aid of the communications interface 1120. A processor (including those described herein), with the aid of additional hardware described herein, may also be operatively coupled to a network. The network 1130 can be the Internet, an intranet and/or an extranet, an intranet and/or extranet that is in communication with the Internet, a telecommunication or data network. The network 1130 in some cases, with the aid of the server 1101, can implement a peer-to-peer network, which may enable devices coupled to the server 1101 to behave as a client or a server. In general, the server may be capable of transmitting and receiving computer-readable instructions (e.g., device/system operation protocols or parameters) or data (e.g., sensor measurements, raw data obtained from detecting nucleic acids, analysis of raw data obtained from detecting nucleic acids, interpretation of raw data obtained from detecting nucleic acids, etc.) via electronic signals transported through the network 1130. Moreover, a network may be used, for example, to transmit or receive data across an international border.

The server 1101 may be in communication with one or more output devices 1135 such as a display or printer, and/or with one or more input devices 1140 such as, for example, a keyboard, mouse, or joystick. The display may be a touch screen display, in which case it may function as both a display device and an input device. Different and/or additional input devices may be present such an enunciator, a speaker, or a microphone. The server may use any one of a variety of operating systems, such as for example, any one of several versions of Windows, or of MacOS, or of Unix, or of Linux.

The storage unit 1115 can store files or data associated with the operation of a device or method described herein.

The server can communicate with one or more remote computer systems through the network 1130. The one or more remote computer systems may be, for example, personal computers, laptops, tablets, telephones, Smart phones, or personal digital assistants.

In some situations a control assembly includes a single server 1101. In other situations, the system includes multiple servers in communication with one another through an intranet, extranet and/or the Internet.

The server 1101 can be adapted to store device operation parameters, protocols, methods described herein, and other information of potential relevance. Such information can be stored on the storage unit 1115 or the server 1101 and such data can be transmitted through a network.

Devices and/or systems as described herein can be operated and methods described herein executed by way of machine (or computer processor) executable code (or software) stored on an electronic storage location of the server 1101, such as, for example, on the memory 1110, or electronic storage unit 1115. During use, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110. Alternatively, the code can be executed on a second computer system 1140.

Aspects of the devices, systems, and methods provided herein, such as the server 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g. read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless likes, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, tangible storage medium, a carrier wave medium, or physical transmission medium. Non-volatile storage media can include, for example, optical or magnetic disks, such as any of the storage devices in any computer(s) or the like, such may be used to implement the system. Tangible transmission media can include: coaxial cables, copper wires, and fiber optics (including the wires that comprise a bus within a computer system). Carrier-wave transmission media may take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD, DVD-ROM, any other optical medium, punch cards, paper tame, any other physical storage medium with patterns of holes, a RAM, a ROM, a PROM and EPROM, a FLASH-EPROM, any other memory chip or cartridge, a carrier wave transporting data or instructions, cables, or links transporting such carrier wave, or any other medium from which a computer may read programming code and/or data. Many of these forms of computer readable media may be involved in carrying one or more sequences of one or more instructions to a processor for execution.

### Operating Performance of Devices

### Thermal Cycle Times

Devices of the disclosure are generally capable of completing a single thermal cycle in a short period of time, which depends on the particular device and/or conditions employed. Thermal cycling times may vary, for example, based upon a number of device operating variables, with non-limiting examples that include the polymerase, the volume of a sample, concentration of nucleic acids to be amplified, concentration of additional reagents required for nucleic acid amplification, heater performance, heater power and power density, cooling gas or liquid performance (e.g., flow rate, pressure, volume, temperature), speed of thermal cycling desired, temperature of a device component, adiabatic cooling efficiency, a heat transfer coefficient between any components, a heat transfer coefficient between any component and a cooling gas or liquid, speed of temperature sensor data acquisition, desired quality of amplification products, configuration of the components of the device, or combinations thereof.

In some examples, a device of the disclosure may be capable of completing a thermal cycle operation in about 0.01 seconds (“s”) to 60 s. In some examples, a device of the disclosure may be capable of completing a thermal cycle in about 0.01 s to 10 s. In some examples, a device of the disclosure may be capable of completing a thermal cycle in about 0.01 s to 1 s. In some examples, a device of the disclosure may be capable of completing a thermal cycle in about 0.1 s to 1 s. In some examples, a device of the disclosure may be capable of completing a thermal cycle in about 0.1 s to 0.3 s. In some examples, a device of the disclosure may be capable of completing a thermal cycle in about 0.1 s to 0.5 s. In some examples, a device of the disclosure may be capable of completing a thermal cycle in about 0.1 s to 0.8 s. In some examples, a device of the disclosure may be capable of completing a thermal cycle in about 0.01 s to 0.1 s. In some examples, a device of the disclosure may be capable of completing a thermal cycle in about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10 s, 11 s, 12 s, 13 s, 14 s, 15 s, 16 s, 17 s, 18 s, 19 s, or 20 s.

In some examples, a device of the disclosure may be capable of completing a thermal cycle in less than about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10 s, 11 s, 12 s, 13 s, 14 s, 15 s, 16 s, 17 s, 18 s, 19 s, or 20 s.

A thermal cycle operation can include one or more heating/cooling operations. A thermal cycle operation can include at least 1, 2, 3, 4, 5, 6, 7, 8, 9, 10, 20, 30, 40, 50, 60, 70, 80, 90, 100, 200, 300, 400, 500, 1000, or 10,000 heating operations, and at least 1, 2, 3, 4, 5, 6, 7, 8, 9, 10, 20, 30, 40, 50, 60, 70, 80, 90, or 100 cooling operations. A heating operation can be followed by a cooling operation, or a cooling operation can be followed by a heating operation. In some situations, a given temperature is maintained with the aid of both heating and cooling.

### Nucleic Acid Amplification Cycle Times

Devices of the disclosure generally complete a single nucleic acid amplification cycle in varied amounts of time, depending on the particular device and/or conditions employed. Nucleic acid amplification times may vary, for example, based upon a number of device operating variables, with non-limiting examples that include the volume of a sample, concentration of nucleic acids to be amplified, concentration of additional reagents required for nucleic acid amplification, heater performance, heater power and power density, cooling gas or liquid performance (e.g., flow rate, pressure, volume, temperature), speed of thermal cycling desired, adiabatic cooling efficiency, a heat transfer coefficient between any components, a heat transfer coefficient between any component and the cooling gas or liquid, controller speed, speed of temperature sensor data acquisition, desired quality of amplification products, configuration of the components of a device, or combinations thereof. Nucleic acid amplification times also vary depending on, for example, the buffer conditions, concentration of the buffer components, concentration of the template, type of polymerase used, and length of the template.

In some examples, a device of the disclosure may be capable of completing a nucleic acid amplification cycle in about 0.01 s to 60 s. In some examples, a device of the disclosure may be capable of completing a nucleic acid amplification cycle in about 0.01 s to 10 s. In some examples, a device of the disclosure may be capable of completing a nucleic acid amplification cycle in about 0.01 s to 1 s. In some examples, a device of the disclosure may be capable of completing a nucleic acid amplification cycle in about 0.1 s to 1 s. In some examples, a device of the disclosure may be capable of completing a nucleic acid amplification cycle in about 0.1 s to 0.3 s. In some examples, a device of the disclosure may be capable of completing a nucleic acid amplification cycle in about 0.1 to 0.5 s. In some examples, a device of the disclosure may be capable of completing a nucleic acid amplification cycle in about 0.1 s to 0.8 s. In some examples, a device of the disclosure may be capable of completing a nucleic acid amplification cycle in about 0.01 s to 0.1 s. In some examples, a device of the disclosure may be capable of completing a nucleic acid amplification cycle in about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10.0 s, 11 s, 12 s, 13 s, 14 s, 15 s, 16 s, 17 s, 18 s, 19 s, 20 s, 25 s, 30 s, 35 s, 40 s, 45 s, 50 s, 55 s, or 60 s.

In some examples, a device of the disclosure may be capable of completing a nucleic acid amplification cycle in less than about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10.0 s, 11 s, 12 s, 13 s, 14 s, 15 s, 16 s, 17 s, 18 s, 19 s, 20 s, 25 s, 30 s, 35 s, 40 s, 45 s, 50 s, 55 s, or 60 s.

### Hold Times

Devices of the disclosure generally complete a single thermal cycle in varied amounts of time, depending on the particular device and/or conditions employed and may be capable of holding a specified temperature for a period of time or may hold the temperature for a given period of time (also “hold time” herein). Such operation may be executed, for example, in cases where non-continuous thermal cycling (e.g., thermal cycling achieved with discrete heating and/or cooling steps) is desired. The time at which a device may be capable of holding a given temperature may vary, for example, based upon a number of variables, with non-limiting examples that include the volume of a sample, concentration of the template to be amplified, concentration of additional reagents required for template amplification, type of polymerase used, length of the template, heater performance, cooling gas or liquid performance, controller speed, desired quality of amplification products, or a combination thereof. At a given hold time, the temperature of the sample can vary by at most about 20%, 10%, 5%, 4%, 3%, 2%, 1%, 0.5%, 0.1%, 0.01%, or 0.001%. At any given hold time, the temperature of the sample may vary by at most about 5° C., 4° C., 3° C., 2° C., 1° C., 0.5° C., 0.25° C., or 0.1° C.

In some examples, a device may be capable of continuous thermal cycling with no hold time. In some examples, a device of the disclosure is capable of a hold time of about 0.01 s to 60 s. In some examples, a device of the disclosure is capable of a hold time of about 0.01 s to 10 s. In some examples, a device of the disclosure is capable of a hold time of about 0.01 s to 1 s. In some examples, a device of the disclosure is capable of a hold time of about 0.1 s to 1 s. In some examples, a device of the disclosure is capable of a hold time of about 0.01 s to 0.1 s. In some examples, a device of the disclosure is capable of a hold time of about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10.0 s, 11 s, 12 s, 13 s, 14 s, 15 s, 16 s, 17 s, 18 s, 19 s, 20 s, 25 s, 30 s, 35 s, 40 s, 45 s, 50 s, 55 s, or 60 s, or more.

In some examples, a device of the disclosure is capable of a hold time of less than about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10.0 s, 11 s, 12 s, 13 s, 14 s, 15 s, 16 s, 17 s, 18 s, 19 s, 20 s, 25 s, 30 s, 35 s, 40 s, 45 s, 50 s, 55 s, or 60 s.

As an alternative, a device of the disclosure is capable of a hold time of at least about 0.01 s, 0.02 s, 0.03 s, 0.04 s, 0.05 s, 0.06 s, 0.07 s, 0.08 s, 0.09 s, 0.10 s, 0.1, 0.15 s, 0.2 s, 0.25 s, 0.3 s, 0.35 s, 0.40 s, 0.45 s, 0.50 s, 0.55 s, 0.60 s, 0.65 s, 0.70 s, 0.75 s, 0.80 s, 0.90 s, 1 s, 1.10 s, 1.15 s, 1.20 s, 1.25 s, 1.30 s, 1.35 s, 1.40 s, 1.45 s, 1.50 s, 1.55 s, 1.60 s, 1.65 s, 1.70 s, 1.75 s, 1.80 s, 1.85 s, 1.90 s, 1.95 s, 2.00 s, 2.1 s, 2.2 s, 2.3 s, 2.4 s, 2.5 s, 2.6 s, 2.7 s, 2.8 s, 2.9 s, 3.0 s, 3.2 s, 3.4 s, 3.6 s, 3.8 s, 4.0 s, 4.5 s, 5.0 s, 5.5 s, 6.0 s, 6.5 s, 7.0 s, 7.5 s, 8.0 s, 8.5 s, 9.0 s, 9.5 s, 10.0 s, 11 s, 12 s, 13 s, 14 s, 15 s, 16 s, 17 s, 18 s, 19 s, 20 s, 25 s, 30 s, 35 s, 40 s, 45 s, 50 s, 55 s, or 60 s.

### Temperatures

Due to the nature of thermal cycling, the temperature of a sample, at any given time, may vary. A device of the disclosure is generally capable of heating and/or cooling a sample to a number of desired temperatures.

In some examples, a device of the disclosure is capable of heating and/or cooling a sample to any temperature in the range of about 0° C. to 120° C. In some examples, a device of the disclosure is capable of heating and/or cooling a sample to a temperature in the range of about 50° C. to 100° C. In some examples, a device of the disclosure is capable of heating and/or cooling a sample to a temperature in the range of about 60° C. to 95° C. In some examples, a device of the disclosure is capable of heating and/or cooling a sample to a temperature of about 0° C., 4° C., 10° C., 20° C., 25° C., 30° C., 35° C., 40° C., 45° C., 50° C., 55° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., 101° C., 102° C., 103° C., 104° C., 105° C., 110° C., 115° C., or 120° C., or more.

A control assembly may be capable of controlling the temperature of a sample at a point during a thermal cycle, such that the temperature of the sample at that point varies minimally between replicate thermal cycles. For example, the temperature of a sample at a point of a thermal cycle may vary by less than about 1.0° C. between replicate thermal cycles. In other examples, the temperature of a sample at a point of a thermal cycle may vary by less than about 0.5° C. between replicate thermal cycles. In other examples, the temperature of a sample at a point of a thermal cycle may vary by less than about 0.1° C. between replicate thermal cycles. In still other examples, the temperature of a sample at a point of a thermal cycle may vary by less than about 1.0° C., 0.95° C., 0.90° C., 0.85° C., 0.80° C., 0.75° C., 0.70° C., 0.65° C., 0.60° C., 0.55° C., 0.50° C., 0.45° C., 0.40° C., 0.35° C., 0.30° C., 0.25° C., 0.20° C., 0.15° C., or 0.10° C. between replicate thermal cycles.

In some cases, the temperature of any one sample within a thermal cycler may vary by less than about 1.0° C. when compared to the temperature of any other sample within the same thermal cycler at the same set-point temperature. In other examples, the temperature of any one sample may vary by less than about 0.5° C. when compared to any other sample within the same thermal cycler at the same set-point temperature. In other examples, the temperature of any one sample may vary by less than about 0.1° C. when compared to any other sample within the same thermal cycler at the same set-point temperature. In still other examples, the temperature of any one sample may vary by less than about 1.0° C., 0.95° C., 0.90° C., 0.85° C., 0.8° C., 0.75° C., 0.7° C., 0.65° C., 0.6° C., 0.55° C., 0.50° C., 0.45° C., 0.40° C., 0.35° C., 0.30° C., 0.25° C., 0.20° C., 0.15° C., or 0.10° C. when compared to any other sample within the same thermal cycler at the same set-point temperature.

Generally speaking, device component temperatures (e.g., of a sample holder, a sample, a heater, or the surface of any other device component described herein) may need to be monitored (e.g., by a control assembly) at regular intervals in order to achieve proper thermal cycling. The frequency at which temperature is monitored may vary, depending upon the particular device. For example, the frequency at which the temperature is monitored by a control assembly is from about 0.1 Hertz (“Hz”) to about 5000 Hz. In some examples, the frequency at which the temperature is monitored by a control assembly is from about 1 Hz to about 4000 Hz. In some examples, the frequency at which the temperature is monitored by a control assembly is from about 1 Hz to about 200 Hz. In still other examples, the frequency at which the temperature is monitored by a control assembly is about 0.1, 1, 10, 25, 50, 100, 125, 150, 175, 200, 250, 300, 350, 400, 450, 500, 550, 600, 650, 700, 800, 900, 1000, 1100, 1200, 1300, 1400, 1500, 2000, 2500, 2700, 3000, 4000, 5000, 6000, 7000, 8000, 9000, or 10000 Hz. In some examples, the frequency at which temperature is monitored may be at least about 0.1, 1, 10, 25, 50, 100, 125, 150, 175, 200, 250, 300, 350, 400, 450, 500, 550, 600, 650, 700, 800, 900, 1000, 1100, 1200, 1300, 1400, 1500, 2000, 2500, 2700, 3000, 4000, 5000, 6000, 7000, 8000, 9000, or 10000 Hz.

### Heating Rates

Devices of the disclosure may heat a sample at varied heating rates. Actual heating rates may vary, for example, depending upon the volume of a sample, concentration of nucleic acids to be amplified, concentration of additional reagents necessary for nucleic acid amplification, heater performance, heater power and power density, cooling gas or liquid performance (e.g., flow rate, pressure, volume, temperature), speed of thermal cycling desired, adiabatic cooling efficiency, a heat transfer coefficient between any components, a heat transfer coefficient between any component and a cooling gas or liquid, controller speed, speed of temperature sensor data acquisition, desired quality of amplification products, configuration of the components of a device, or combinations thereof.

In some examples, a device is capable of heating a sample at a rate of about 20° C./s to 100° C./s. In some examples, a device is capable of heating a sample at a rate of about 40° C./s to 80° C./s. In some examples, a device is capable of heating a sample at a rate of about 60° C./s to 70° C./s. In some examples, a device is capable of heating a sample at a rate of about 40° C./s, 42° C./s, 44° C./s, 46° C./s, 48° C./s, 50° C./s, 52° C./s, 54° C./s, 56° C./s, 58° C./s, 60° C./s, 61° C./s, 62° C./s, 63° C./s, 64° C./s, 65° C./s, 66° C./s, 67° C./s, 68° C./s, 69° C./s, 70° C./s, 71° C./s, 72° C./s, 73° C./s, 74° C./s, 75° C./s, 76° C./s, 77° C./s, 78° C./s, 79° C./s, 80° C./s, 81° C./s, 82° C./s, 83° C./s, 84° C./s, 85° C./s, 86° C./s, 87° C./s, 88° C./s, 89° C./s, 90° C./s, 92° C./s, 94° C./s, 96° C./s, 98° C./s, or 100° C./s.

In some examples, a device is capable of heating a sample at a rate of at least about 40° C./s, 42° C./s, 44° C./s, 46° C./s, 48° C./s, 50° C./s, 52° C./s, 54° C./s, 56° C./s, 58° C./s, 60° C./s, 61° C./s, 62° C./s, 63° C./s, 64° C./s, 65° C./s, 66° C./s, 67° C./s, 68° C./s, 69° C./s, 70° C./s, 71° C./s, 72° C./s, 73° C./s, 74° C./s, 75° C./s, 76° C./s, 77° C./s, 78° C./s, 79° C./s, 80° C./s, 81° C./s, 82° C./s, 83° C./s, 84° C./s, 85° C./s, 86° C./s, 87° C./s, 88° C./s, 89° C./s, 90° C./s, 92° C./s, 94° C./s, 96° C./s, 98° C./s, or 100° C./s, or more.

### Cooling Rates

Devices of the disclosure may cool a sample at varied cooling rates. Actual cooling rates may vary, for example, depending upon the volume of a sample, concentration of nucleic acids to be amplified, concentration of additional reagents necessary for nucleic acid amplification, heater performance, heater power and power density, cooling gas or liquid performance (e.g., flow rate, pressure, volume, temperature), speed of thermal cycling desired, adiabatic cooling efficiency, a heat transfer coefficient between any components, a heat transfer coefficient between any component and a cooling gas or liquid, controller speed, speed of temperature sensor data acquisition, desired quality of amplification products, configuration of the components of a device, or combinations thereof.

In some examples, a device is capable of cooling a sample at a rate of about 20° C./s to 100° C./s. In some examples, a device is capable of cooling a sample at a rate of about 40° C./s to 80° C./s. In some examples, a device is capable of cooling a sample at a rate of about 60° C./s to 70° C./s. In some examples, a device is capable of cooling a sample at a rate of about 40° C./s, 42° C./s, 44° C./s, 46° C./s, 48° C./s, 50° C./s, 52° C./s, 54° C./s, 56° C./s, 58° C./s, 60° C./s, 61° C./s, 62° C./s, 63° C./s, 64° C./s, 65° C./s, 66° C./s, 67° C./s, 68° C./s, 69° C./s, 70° C./s, 71° C./s, 72° C./s, 73° C./s, 74° C./s, 75° C./s, 76° C./s, 77° C./s, 78° C./s, 79° C./s, 80° C./s, 81° C./s, 82° C./s, 83° C./s, 84° C./s, 85° C./s, 86° C./s, 87° C./s, 88° C./s, 89° C./s, 90° C./s, 92° C./s, 94° C./s, 96° C./s, 98° C./s, or 100° C./s.

In some examples, a device is capable of cooling a sample at a rate of at least about 40° C./s, 42° C./s, 44° C./s, 46° C./s, 48° C./s, 50° C./s, 52° C./s, 54° C./s, 56° C./s, 58° C./s, 60° C./s, 61° C./s, 62° C./s, 63° C./s, 64° C./s, 65° C./s, 66° C./s, 67° C./s, 68° C./s, 69° C./s, 70° C./s, 71° C./s, 72° C./s, 73° C./s, 74° C./s, 75° C./s, 76° C./s, 77° C./s, 78° C./s, 79° C./s, 80° C./s, 81° C./s, 82° C./s, 83° C./s, 84° C./s, 85° C./s, 86° C./s, 87° C./s, 88° C./s, 89° C./s, 90° C./s, 92° C./s, 94° C./s, 96° C./s, 98° C./s, or 100° C./s, or more.

### Power Consumption

Devices of the disclosure consume power at varied rates. Actual power usage rates may vary depending upon the volume of a sample, the configuration of a sample with respect to a source of cooling gas or liquid, the temperature of a cooling gas or liquid, adiabatic cooling efficiency, a heat transfer coefficient between any components, a heat transfer coefficient between any component and the cooling gas or liquid, the energy required for desired operation of heaters of the device, the energy required for desired operation of a source of cooling gas or liquid, desired heating or cooling rates, desired hold times, data processing requirements, the use of a display, power requirements of other system components (e.g., unit operations) when a device is included in a larger system, a combination thereof. In order to achieve portability of the device and/or minimize the amount of energy required for operation, power consumption of a device may be optimized. For example, a device may be capable of consuming energy at a rate of at most about 1.0 watts (“W”). In some examples, a device may be capable of consuming energy at a rate of at most about 0.5 W. In some examples, a device may be capable of consuming energy at a rate of at most about 0.2 W. In some examples, a device may be capable of consuming energy at a rate of at most about 0.1 W. In still other examples, a device may be capable of consuming energy at a rate of at most about 10, 5, 1, 0.5, 0.4, 0.3, 0.2, 0.15, 0.1, 0.05, or 0.01 W.

### Methods

The disclosure also provides methods that may be utilized for rapid thermal cycling of a sample, particularly using the thermal cyclers described herein. Methods may include the execution of non-isothermal nucleic acid amplification reactions such as PCR, variants of PCR (e.g., reverse-transcription PCR, Q-PCR, or RTQ-PCR), LCR, variants of LCR (e.g., reverse-transcription LCR, Q-LCR, or RTQ-LCR), and digital nucleic amplification reactions (e.g., digital PCR (dPCR), digital RT-PCR (dRT-PCR), digital Q-PCR (dQ-PCR), digital RTQ-PCR (dRTQ-PCR), digital LCR (dLCR), digital RT-LCR (dRT-LCR), digital Q-LCR (dQ-LCR), digital RTQ-LCR (dRTQ-LCR). The methods disclosed herein broadly include the steps of a) providing a sample to a thermal cycler, wherein the sample includes a nucleic acid and reagents necessary for amplification of the nucleic acid and b) cycling the temperature of the sample to complete a nucleic amplification cycle. Various, non-limiting examples of such methods, steps that may be included as part of the methods, the sequencing of such steps, and the performance characteristics of the methods are provided herein.

### Sources of Nucleic Acids and Processing

A nucleic acid, such as deoxyribonucleic acid (DNA) or ribonucleic acid (RNA), amplified in a method of the disclosure may be obtained from a variety of sources. For example, a nucleic acid may be obtained from biological sources with non-limiting examples that include humans, animals, plants, fungi, other eukaryotes, bacteria, and viruses. Moreover, nucleic acid may be found, for example, in a number of biological fluids (e.g., blood, urine, spinal fluid, cerebrospinal fluid, synovial fluid, amniotic fluid, semen, vaginal discharge, saliva, etc.), solid tissue samples, feces, hair, tissue cultures, cells or progeny thereof, sections, smears, or combinations thereof. Other types of biological samples may include food products such as vegetables, dairy items, meat, meat by-products, and waste. Nucleic acids may also be obtained from non-living sources with non-limiting examples that include soil, water, sewage, cosmetics, agricultural specimens, industrial specimens, air filter specimens, and air conditioning specimens.

DNA may be single-stranded, double-stranded, or may comprise a higher-number of strands such as in, for example, triplex DNA. Moreover, DNA may be circular, may be linear, or may comprise another two- or three-dimensional structure. In some cases, the origin of DNA may be nuclear, mitochondrial, or extracellular. In some cases, DNA may be hybridized or otherwise linked to RNA to form a DNA-RNA hybrid.

RNA may be single-stranded, double-stranded, or may comprise a higher-number of strands. Moreover, RNA may be messenger RNA (mRNA), transfer RNA (tRNA), ribosomal RNA (rRNA), non-coding RNA (ncRNA), an RNA used for RNA interference (RNAi), or a combination thereof.

Nucleic acid amplification reactions generally require that nucleic acid desired for amplification is free in and not inaccessible to reagents required for amplification (e.g., sequestered in cells). As a result, nucleic acid subject to amplification may need to be pre-processed, such that the nucleic acid is extracted from a raw sample prior to its amplification. A variety of nucleic acid extraction methods may be used to extract nucleic acid from a raw, unprocessed sample obtained from a source. For example, where cell-lysis or viral envelope opening is desired, the use of detergents or surfactants, nucleic acid precipitation, and combinations thereof may be used to extract nucleic acid from a sample. DNA, RNA, or a mixture thereof may be obtained during an extraction. Pre-processing may also include the assembly of one or more reporters that may be used in methods that include the detection of one or more components of a sample and/or one or more amplification products. A pre-processing step may be performed, for example, by a unit operation that may be included as part of a larger system that also includes a thermal cycler. However, nucleic acids may also be amplified directly from cells (e.g., colony PCR).

### Sample Components and Volume

Methods of the disclosure can include a step of providing a sample to a thermal cycler. A sample generally comprises one or more nucleic acids to be amplified and reagents (e.g., primer, polymerase, dNTPs, reverse transcriptase, etc.) necessary for amplification. For example, a sample may include reagents necessary to complete a PCR reaction, one or more variants of a PCR reaction, or combinations thereof. In another example, a sample may include reagents necessary to complete an LCR reaction, one or more variants of an LCR reaction, or combinations thereof. In another example, a sample may include reagents necessary to complete a digital nucleic acid amplification reaction.

The volume of a sample supplied to a thermal cycler may vary depending on a variety of factors, with non-limiting examples that include the type of nucleic acid reaction desired, the amount of nucleic acid available for amplification, the concentration of nucleic acid to be amplified, the concentration or amount of additional reagents, the amount or concentration of amplification products, the heating capabilities of the thermal cycler, the cooling capabilities of the thermal cycler, and/or the volumetric capacity of a sample holder of the thermal cycler. The volume of a sample may be about, at least, or less than any of the example sample volumes provided herein.

A sample may be arranged in a variety of configurations depending on a number of factors, with non-limiting examples that include the type of available sample holder, the arrangement of necessary heaters, the arrangement of necessary sources of cooling, the desired number of thermal cycles, and the type of nucleic acid amplification reaction required. In some instances, the sample may be a bulk fluid. In other instances, a sample may comprise a droplet. In some cases, the droplet may comprise both nucleic acid and reagents necessary for nucleic acid amplification, such that nucleic acid amplification reactions may be performed in the droplet upon proper thermal cycling. In other cases, a droplet may comprise nucleic acids and may be combined with a droplet that comprises appropriate reagents for nucleic acid amplification, such that nucleic acid amplification reactions may be completed in the combined droplet upon proper thermal cycling. A droplet may be generated as a partition of a larger bulk fluid, such that nucleic acids comprised in the bulk fluid are distributed between droplets. Furthermore, in cases where a sample comprises a plurality of droplets, nucleic acid amplification reactions may be completed in all of the droplets or may be completed in one or more subsets of droplets.

### PCR Reactions

Methods of the disclosure may include the completion of a PCR amplification reaction, or any step comprising a PCR amplification (e.g., denaturation, annealing, elongation—as described elsewhere herein). A sample may comprise reagents necessary to complete a PCR reaction. Non-limiting examples of reagents for a PCR reaction include a template nucleic acid (e.g., DNA) molecule to be amplified, a set of two primers that may hybridize with a target sequence on the template nucleic acid, a polymerase (e.g., DNA polymerase), deoxynucleotide triphosphates (dNTPs), a buffer at a pH and concentration suitable for a desired PCR reaction, a monovalent cation, and a divalent cation. Generally, the ratio of each reagent in the sample may vary and depend upon, for example, the amount of nucleic acid to be amplified and/or the desired amount of amplification products. Methods to determine the ratio of each reagent necessary for a PCR amplification reaction are found in, for example, U.S. Pat. Nos. 4,683,202 and 4,683,195 which are entirely incorporated herein by reference.

### RT-PCR Reactions

Methods of the disclosure may include the completion of an RT-PCR amplification reaction, and, thus, a sample may comprise reagents necessary to complete a RT-PCR reaction. Non-limiting examples of such reagents include the reagents necessary to complete a PCR reaction, a reverse transcriptase, and a RNA template that may be used to synthesize a complementary DNA (cDNA) complement. In cases where reverse transcriptase must be removed prior to cDNA amplification, a sample supplied to a thermal cycler may not contain reagents necessary to complete a PCR reaction and may require a separate amplification reaction. Generally, the ratio of each reagent in the sample may vary and depend upon, for example, the amount of nucleic acid to be amplified and/or the desired amount of amplification products. Methods to determine the ratio of each reagent necessary for an RT-PCR amplification reaction are generally known by those skilled in the art.

### Q-PCR or RTQ-PCR Reactions

Methods of the disclosure may include the completion of a Q-PCR or RTQ-PCR amplification reaction, and, thus a sample may comprise reagents necessary to complete a Q-PCR or RTQ-PCR amplification reaction. Non-limiting examples of such reagents include the reagents necessary to complete a PCR reaction and a reporter used to detect amplification products. Generally, the ratio of each reagent in the sample may vary and depend upon, for example, the amount of nucleic acid to be amplified and/or the desired amount of amplification products. Methods to determine the ratio of each reagent necessary for a Q-PCR or RTQ-PCR amplification reaction are generally known by those skilled in the art.

### LCR Reactions

Methods of the disclosure may include the completion of a LCR amplification reaction (or any step of a LCR reaction—as described elsewhere herein), and, thus, a sample may comprise reagents necessary to complete a LCR amplification reaction. Non-limiting examples of such reagents include a template DNA molecule to be amplified, a set of oligonucleotide probes that may each hybridize with a different, but adjacent to the other, portion of a target sequence on the template DNA, a DNA ligase, a buffer at a pH and concentration suitable for a desired LCR reaction, a monovalent cation, and a divalent cation. Generally, the ratio of each reagent in the sample may vary and depend upon, for example, the amount of nucleic acid to be amplified and/or the desired amount of amplification products. Methods to determine the ratio of each reagent necessary for a LCR amplification reaction are generally known by those skilled in the art.

### Gap LCR Reactions

Methods of the disclosure may include the completion of a gap LCR amplification reaction, and, thus, a sample may comprise reagents necessary to complete a gap LCR amplification reaction. Non-limiting examples of such reagents include the reagents necessary to complete a LCR reaction, wherein the set of oligonucleotide probes may each hybridize with a different, non-adjacent portion of a target sequence on the template DNA, dNTPs, and a DNA polymerase. Generally, the ratio of each reagent in the sample may vary and depend upon, for example, the amount of nucleic acid to be amplified and/or the desired amount of amplification products. Methods to determine the ratio of each reagent necessary for a gap LCR amplification reaction are generally known by those skilled in the art.

### Q-LCR and LTQ-LCR Reactions

Methods of the disclosure may include the completion of a Q-LCR or LTQ-PCR reaction, and, thus, a sample may comprise reagents necessary to complete a Q-LCR or RTQ-LCR reaction. Non-limiting examples of such reagents include the reagents necessary to complete a LCR reaction and a reporter used to detect amplification products. Generally, the ratio of each reagent in the sample may vary and depend upon, for example, the amount of nucleic acid to be amplified and/or the desired amount of amplification products. Methods to determine the ratio of each reagent necessary for a Q-LCR and RTQ-LCR amplification reaction are generally known by those skilled in the art.

### Digital Nucleic Acid Amplification Reactions

Methods of the disclosure may include the completion of a digital nucleic acid amplification reaction, and, thus, a sample may comprise reagents necessary to complete a digital nucleic acid amplification reaction. In general, any of the example nucleic acid amplification reactions discussed herein may be conducted in digital form, upon proper separation of a sample and/or reagents necessary for nucleic acid amplification into smaller partitions. Such partitions may be droplets or may be larger aliquots of the original sample. Generally, the ratio of each reagent in partitions may vary and depend upon, for example, the amount of nucleic acid to be amplified in each droplet and/or the desired amount of amplification products. Methods to determine the ratio of each reagent necessary for a particular digital nucleic acid amplification reaction are generally known by those skilled in the art.

Digital nucleic acid amplification reactions may be droplet digital nucleic acid amplification reactions. Non-limiting examples of such nucleic acid amplification reactions include droplet digital PCR (ddPCR), droplet digital RT-PCR (ddRT-PCR), droplet digital Q-PCR (ddQ-PCR), droplet digital RTQ-PCR (ddRTQ-PCR), droplet digital LCR (ddLCR), droplet digital RT-LCR (ddRT-LCR), droplet digital Q-LCR (ddQ-LCR), or droplet digital RTQ-LCR (ddRTQ-PCR), or combinations thereof.

### Multiple Reactions and Multiplexing

Methods of the disclosure may include a single type of nucleic acid amplification reaction or may comprise multiple types of nucleic acid amplification reactions, for example one or more of the above. The methods of the disclosure may also be multiplexed. Pre-loaded sample holders may be useful in multiplexing, as reagents for various desired amplification reactions may be pre-loaded into a sample holder. For example, nucleic acid amplification reaction-specific cartridges may be constructed, such that each cartridge contains reagents for several specific nucleic acid amplification reactions in its sample holder. Thermal cycling of a sample added to the reagents and detection of amplification products for each specific amplification reaction may permit multiplexing. Such a configuration may also permit analyses with respect to different applications. For example, a subset of reagents loaded into a sample holder may be suitable for a nucleic acid amplification reaction beneficial in one application, while another subset of reagents loaded into the sample holder are suitable for a differing nucleic acid amplification reaction beneficial in another application.

### Heating and Cooling

Methods of the disclosure generally include a thermal cycling step, wherein the temperature of a sample supplied to a thermal cycler is modulated by repeated cycles of heating and cooling. Temperatures may be changed continuously with continuous heating and/or cooling of the sample or may be achieved in discrete steps with discontinuous heating and/or cooling of the sample. The temperatures achieved during thermal cycling may vary depending on a number of factors with non-limiting examples that include the type of nucleic acid amplification reaction desired, the desired speed with which thermal cycling is achieved, the desired speed with which nucleic acid amplification is achieved, the amount of nucleic acid available for amplification, the desired concentration or amount of nucleic acid to be amplified, the desired concentration or amount of additional reagents, the necessary amount or concentration of amplification products, the heating capabilities of the thermal cycler, the cooling capabilities of the thermal cycler, or combinations thereof.

The sample may be heated and/or cooled to any of the temperatures provided in this disclosure, at any of the rates provided in this disclosure. These temperatures, as well as the heating and cooling rates, may be controlled by any of the methods described in this disclosure. Any of the thermal cycle times or nucleic acid amplification times described in this disclosure may be applied to the sample. A cycle may include a hold time according to any of the hold times described in this disclosure.

The number of cycles may vary from about 1 to 5, about 5 to 10, about 10 to 20, about 20 to 30, about 30 to 40, or about 40 or more. The number of amplification cycles may depend on a number of factors that include the amount of nucleic acid to be amplified, the amount of necessary reagents to complete nucleic acid amplification, the desired amount of amplification products, the quality of nucleic acid to be amplified, the quality of necessary reagents to complete nucleic acid amplification, the quality of amplification products, the limit of detection of an amplification product (where applicable), the precision of thermal cycling, the accuracy of thermal cycling, the efficiency of method execution, or combinations thereof.

### Detection

Where desired, such as, for example, in a Q-PCR, Q-LCR, RTQ-PCR, RTQ-LCR, dQ-PCR, dQ-LCR, dRTQ-PCR, or dRTQ-LCR amplification reaction, methods of the disclosure may include a detection step. A detection step may include the detection of any species of a sample, including amplification products that are generated during thermal cycling. Detection may be qualitative, both qualitative and semi-quantitative, or both qualitative and quantitative. For example, a thermal cycler described herein may generate amplification products that are detectable using gel-electrophoresis. Detection may be completed at the completion of thermal cycling or may be completed at any point during thermal cycling, including prior to the start of a thermal cycle, during a thermal cycle, and/or at the conclusion of a thermal cycle. Any suitable method of detection may be used. In cases where multiple nucleic acid amplification reactions are completed for a single sample, detection may be completed in parallel or in-line, with each detector configured to detect a particular amplification product. In some cases, detection may be completed in a separate device. In cases where a sample has been provided to a stand-alone (e.g., no other connected unit operations or devices) thermal cycler, a sample or sample holder containing the sample may be removed from the thermal cycler and analyzed with a separate device. In cases where a sample has been provided to a thermal cycler that is included as part of a larger system, detection may be achieved in a unit operation or device upstream or downstream from and fluidically connected to the thermal cycler. Fluidic channels, linking a thermal cycler with a detection unit may be used to transport a sample from one device to the other. In other cases, detection may occur in situ, without removal of the sample from a sample holder of the thermal cycler.

### Automation

Methods of the disclosure may be executed manually or may be executed at least in part with automation. Automation may be achieved, for example, with the aid of a control assembly (or control system), including control assemblies described herein. The control assembly can include a processor that is programmed to execute machine-executable code that implements a method of the present disclosure. Methods may be performed in batch mode, wherein discrete sets of nucleic amplification are completed, or may be performed in continuous mode, wherein nucleic acid amplification occurs continuously. In cases where a method is executed by a larger system that includes a thermal cycler, the method may include all the steps necessary to obtaining one or more pieces of useful information from a raw sample provided to the device. In one example, such a method may include steps that include receiving a raw sample for its source, pre-processing the raw sample such that its nucleic acids are readied for amplification and combined with additional reagents necessary to complete an amplification reaction, amplifying the nucleic acid, detecting the amplification products, and interpreting received data from detection into output formats useful to an end-user.

Automation may also be achieved remotely. In cases where a device or system used to execute methods of the disclosure is in communication with a computer system comprised in a control assembly, the computer system may receive instructions from one or more remote computers, in the form of transmitted electronic signals through a computer network, as described elsewhere herein. Moreover, methodologies, data, data analyses, and/or interpretations of data and/or data analyses (e.g., nucleic amplification parameters, nucleic amplification protocols, data collected from detecting one or more nucleic acids, analysis of any data collected, interpretations of any data collected) that are obtained from executing methods of the disclosure may also be transmitted from a computer comprised in a control assembly to one or more remote computers, in the form of transmitted electronic signals through a computer network, including any of those example computer networks described herein.

### Applications

Devices and methods of the disclosure may be useful in a variety of applications, either separately or in combination. In some examples, devices and/or methods of the disclosure may be used in a biomedical application with non-limiting examples that include genetic testing (for example, to assess a subject's risk of presenting a genetic disease, such as, for example, cancer), tissue typing, disease diagnosis, disease staging, and/or disease detection. Devices and methods described herein may be utilized, for example, to detect a pathogen, with non-limiting examples that include bacteria (e.g., Mycobacterium, Streptococcus, Salmonella, Shigella, Staphylcococcus, Neisseria, Pseudomonads, Clostridium, or E. coli), yeast, fungi, virus, eukaryotic parasites, etc; or an infectious agent, with non-limiting examples that include influenza virus, parainfluenza virus, adenovirus, rhinovirus, coronavirus, hepatitis viruses A, B, C, D, E, human immunodeficiency virus (HIV), enterovirus, human papillomavirus (HPV), cytomegalovirus, coxsackievirus, herpes simplex virus, Epstein-Barr virus, or other viruses associated with a sexually transmitted disease. Additionally, devices and methods described herein may also be used in forensic applications such, such as, for example, genetic fingerprinting in criminal cases, parental testing, environmental surveillance, and anti-bioterrorism.

Moreover, methods and devices of the disclosure may also be useful in a number of techniques found in biomedical research environments, with non-limiting examples of such techniques that that include the rapid production of DNA, DNA or RNA sequencing, DNA cloning, sequence-tagging, studies of DNA from ancient sources, studying patterns of gene expression, and answering questions in evolutionary biology or archaeology.

A key advantage of the devices and/or methods of the disclosure is the capability to perform ultra fast nucleic acid amplification. Ultrafast nucleic acid amplification may be desired in routine practice or may be generally necessary, depending upon a given application. For example, ultra fast nucleic acid amplification may be amenable to quick disease detection in an extremely ill patient, where laboratory studies traditionally completed for disease detection may take some time and delay treatment. Moreover, fast detection may be desired for intra-operative procedures that include nucleic acid amplification based analyses. In such an application, ultrafast nucleic acid amplification may help to minimize surgical times and, thus, the risk of surgical complications. In another example, ultra fast nucleic acid amplification may be useful in the detection, diagnosis, or assessment of a disease state at the bedside. In such a sample-to-answer technique, a sample may be obtained from a patient and entered into a system that includes one or more devices described herein and that executes methods described herein, wherein the system pre-processes the sample, quickly amplifies obtained nucleic acid, detects amplification products, and generates one or more readouts that may be used to assess a patient disease state.

In another example, wherein a bio-terrorism threat is suspected, fast detection of biohazardous agents or organisms that may be employed for an attack and detectable by nucleic acid amplification methods, may be critical to averting an attack or minimizing casualties after an attack.

### Polymerase Chain Reaction (PCR)

PCR generally involves the heating and cooling of a reaction mixture that includes several key reagents and a nucleic acid (e.g., DNA) template. Non-limiting examples of reagents that, in addition to a nucleic acid template, may be used for PCR include primers, a polymerase, deoxynucleoside triphosphates (dNTPs), buffer solution, divalent cations, and monovalent cations. In general, at least two different primers per nucleic acid template may be included in the reaction mixture, wherein each primer is complementary to a portion of (e.g., the 3′ ends of) the nucleic acid template. The nucleic acid template is replicated by a polymerase.

Non-limiting examples of DNA polymerases that may be useful in PCR include Taq polymerase, Pfu polymerase, Pwo polymerase, Tfl polymerase, rTth polymerase, Tli polymerase, Tma polymerase, and VentR polymerase, Kapa2g polymerase, KOD polymerase, HaqZ05 polymerase, Haqz05 polymerase, or combinations thereof.

dNTPs are nucleotides that include triphosphate groups and are generally the building-blocks from which amplified DNA is synthesized. Non-limiting examples of dNTPs useful in PCR include deoxyadenosine triphosphate (dATP), deoxyguanosine triphosphate (dGTP), deoxycytidine triphosphate (dCTP), and deoxythymidine triphosphate (dTTP).

A buffer solution may be generally used to provide a suitable chemical environment (e.g., pH, ionic strength, etc.) for optimum activity and stability of the DNA polymerase and/or other dependent components in the reaction mixture. For example, buffers of Tris-hydrochloride may be useful in PCR methods.

Divalent cations may also be required for DNA polymerase functionality, with non-limiting examples including magnesium ions (Mg²⁺) and manganese (Mn²⁺) ions. Monovalent cations, such as, for example, potassium ions (K⁺) may be included and may be useful in minimizing the production of unwanted, non-specific amplification products.

A single cycle of PCR typically comprises a series of steps that include a denaturation step, an annealing step, and an elongation step. During denaturation, a double-stranded DNA template may be melted into its individual strands, such that the hydrogen bonds formed between bases in each base-pair of the double-stranded DNA are broken. After denaturation, an annealing step is completed, wherein the reaction mixture is incubated under conditions at which the primers hybridize with complementary sequences present on each of the original individual strands. After annealing, the elongation step commences, wherein the primers are extended by a DNA polymerase, using dNTPs present in the reaction mixture. At the conclusion of elongation, two new double-stranded DNA molecules result, each comprising one of the original individual strands of the DNA template. Each step of PCR is generally initiated by a change in the temperature of the reaction mixture that results from the heating or cooling of the reaction mixture. At the completion of a single round of amplification, the thermal cycle may be repeated for further rounds of amplification. The generation of replicate amplification products is theoretically exponential with each subsequent thermal cycle. For example, for a single DNA template, each step n, may result in a total of 2ⁿ replicates.

Successful PCR amplification requires high yield, high selectivity, and a controlled reaction rate at each step. Yield, selectivity, and reaction rate also generally depend on temperature, and optimal temperatures depend on the composition and length of the polynucleotide, enzymes, and other components in the reaction mixture. In addition, different temperatures may be optimal for different steps or different nucleic acids to be amplified. Moreover, optimal reaction conditions may vary, depending on the sequence of the template DNA, sequence of a designed primer, and composition of the reaction mixture. Thermal cyclers that may be used to perform a PCR reaction may be programmed by selecting temperatures to be maintained, time durations for each portion of a cycle, number of cycles, rate of temperature change, and the like.

Primers for PCR may be designed according to known algorithms. For example, algorithms implemented in commercially available or custom software may be used to design primers. In some examples, primers may consist of at least about 12 bases. In other examples, a primer may consist of at least about 15, 18, or 20 bases in length. In still other examples, a primer may be up to 50+ bases in length. Primers may be designed such that all of the primers participating in a particular reaction have melting temperatures that are within at least about 5° C., and more typically within about 2° C. of each other. Primers may be further designed to avoid self-hybridization or hybridization with other desired primers. Those of skill in the art will recognize that the amount or concentration of primer in a reaction mixture will vary, for example, according to the binding affinity of the primers for a given template DNA and/or the quantity of available template DNA. Typical primer concentrations, for example, may range from 0.01 μM to 0.5 μM.

In an example PCR reaction, a reaction mixture, including a double-stranded DNA template and additional reagents necessary for PCR, is heated to about 80-98° C. and held at that temperature for about 10-90 seconds, in order to denature the DNA template into its individual strands. Each individual strand, during the annealing step, is then hybridized to its respective primer included in the reaction mixture by cooling the reaction mixture to a temperature of about 30-65° C. and holding it at that temperature for about 1-2 minutes. The elongation step then commences, wherein elongation of the respective primers hybridized to each individual strand occurs by the action of a DNA polymerase adding dNTPs to the primers. Elongation is initiated by heating the reaction mixture to a temperature of about 70-75° C. and holding at that temperature for 30 seconds to 5 minutes. The reaction may be repeated for any desired number of cycles depending on, for example, the initial amount of DNA template, the length of the desired amplification product, the amount of dNTPs, the amount of primer, and/or primer stringency.

While general PCR methods may be useful for nucleic acid amplification, other more specialized forms of PCR may be even more useful for a given application. Non-limiting examples of commonly used, more-specialized forms of PCR include reverse transcription PCR (RT-PCR) (e.g., U.S. Pat. No. 7,883,871), quantitative PCR (qPCR) (e.g., U.S. Pat. No. 6,180,349), real-time quantitative PCR (RTQ-PCR) (e.g., U.S. Pat. No. 8,058,054), allele-specific PCR (e.g., U.S. Pat. No. 5,595,890), assembly PCR (e.g., U.S. Patent Publication No. 20120178129), asymmetric PCR (e.g., European Patent Publication No. EP2373807), dial-out PCR (e.g., Schwartz J, NATURE METHODS, September 2012; 9(9): 913-915), helicase-dependent PCR (e.g., Vincent M, EMBO REPORTS 5, 2004, 5(8): 795-800), hot start PCR (e.g., European Patent Publication No. EP1419275), inverse PCR (e.g., U.S. Pat. No. 6,607,899), methylation-specific PCR (e.g., European Patent Publication No. EP1690948), miniprimer PCR (U.S. Patent Publication No. 20120264132), multiplex PCR (U.S. Patent Publication No. 20120264132), nested PCR (U.S. Patent Publication No. 20120264132), overlap-extension PCR (U.S. Patent Publication No. 20120264132), thermal asymmetric interlaced PCR (U.S. Patent Publication No. 20120264132), and touchdown PCR (U.S. Patent Publication No. 20120264132).

### Reverse Transcription PCR (RT-PCR)

Reverse transcription refers to a process by which ribonucleic acid (RNA) is replicated to its single-stranded complementary DNA (cDNA) by a reverse transcriptase enzyme. Non-limiting examples of reverse transcriptase enzymes include Moloney murine leukemia virus (MMLV) transcriptase, avian myeloblastosis virus (AMV) transcriptase, variants of AMV-transcriptase, or reverse transcriptases that have endo H activity. In reverse transcription PCR(RT-PCR), a reverse transcriptase, generally with endo H activity, is added to a reaction mixture that includes an RNA template and necessary reagents for PCR. The reverse transcriptase may complete RNA template replication to cDNA, by hybridizing dNTPs to the RNA template at proper conditions. At the conclusion of replication, the reverse transcriptase may remove the single-stranded, cDNA replicated from the RNA template to permit additional replication of the cDNA with PCR methods described above. The cDNA and its amplification products that are produced from PCR may be used indirectly to garner information about the RNA, such as, for example, the sequence of the RNA. The cDNA product that is synthesized from an RNA by a reverse transcriptase may be removed from the reaction mixture to be used as a DNA template in a separate, subsequent set of PCR reactions or amplification via PCR may occur in situ where reverse transcriptase is included in the reaction mixture with reagents necessary for PCR.

### Quantitative PCR (Q-PCR) and Real Time Quantitative PCR (RTQ-PCR)

Quantitative PCR (Q-PCR) is a variation of PCR in which the amount of template DNA in a sample is quantified. Generally, amplification products produced by PCR methods are linked to a reporter, such as, for example, a fluorescent dye. At the end of a reaction, the reporter may be detected and the results back-calculated (based on the association ratio of reporter to DNA and the known number of thermal cycles) to determine the amount of original DNA template present. In some examples, the fluorescent dye may be detected in real-time as amplification progresses. Such a variation of Q-PCR may be appropriately called real-time quantitative PCR (RTQ-PCR), real-time PCR, or kinetic PCR. Both Q-PCR and RTQ-PCR may be used to determine whether or not a specific DNA template is present in a sample. In general, due to the possible changes to reaction efficiency as the number of PCR cycles increases, however, RTQ-PCR methods may be generally more sensitive, more reliable, and thus, more frequently employed by those skilled in the art as measurements are made on amplification products as they are synthesized rather than on the aggregate of amplification products obtained at the completion of the desired number of thermal cycles. Q-PCR and RTQ-PCR may also be combined with other PCR methods, such as, for example, RT-PCR. As an example utility of combining Q-PCR or RTQ-PCR with other PCR methods, reporters may be included in an RT-PCR reaction mixture to detect and/or quantify low levels of messenger RNA (mRNA) via replication of its associated cDNA, which may enable the quantification of relative gene expression in a particular cell or tissue.

One or more reporters may be used to quantify DNA amplified as part of Q-PCR and RTQ-PCR methods. Reporters may be associated with DNA both by covalent and/or non-covalent linkages (e.g., ionic interactions, Van der Waals forces, hydrophobic interactions, hydrogen bonding, etc.). For example, a fluorescent dye that non-covalently intercalates with double-stranded DNA may be used as a reporter. In another example, a DNA oligonucleotide probe that fluoresces when hybridized with a complementary DNA may be used as a reporter. In some examples, reporters may bind to initial reactants and changes in reporter levels may be used to detect amplified DNA. In other examples, reporters may only be detectable or non-detectable as DNA amplification progresses. Detection of reporters may be accomplished with one of many detection systems that are suitable in the art. Optical detectors (e.g., fluorimeters, ultra-violet/visible light absorbance spectrophotometers) or spectroscopic detectors (e.g., nuclear magnetic resonance (NMR), infrared spectroscopy) may be, for example, useful modalities of reporter detection. Gel based techniques, such as, for example, gel electrophoresis may also be used for detection.

A reporter used in a Q-PCR or RTQ-PCR reaction may be an intercalator that may be detected. An intercalator generally binds to DNA by disrupting hydrogen bonds between complementary bases, and, instead fits itself between the disrupted bases. An intercalator may form its own hydrogen bonds with one or more of the disrupted bases. Non-limiting examples of intercalators include SYBR green, SYBR blue, DAPI, propidium iodine, Hoeste, SYBR gold, ethidium bromide, acridines, proflavine, acridine orange, acriflavine, fluorcoumanin, ellipticine, daunomycin, chloroquine, distamycin D, chromomycin, homidium, mithramycin, ruthenium polypyridyls, anthramycin, phenanthridines and acridines, ethidium bromide, propidium iodide, hexidium iodide, dihydroethidium, ethidium homodimer-1 and -2, ethidium monoazide, and ACMA.

A reporter used in a Q-PCR or RTQ-PCR reaction may be a minor groove binder that may be detected. Non-limiting examples of minor grove binders include indoles and imidazoles (e.g., Hoechst 33258, Hoechst 33342, Hoechst 34580 and DAPI).

A reporter used in a Q-PCR or RTQ-PCR reaction may be a nucleic acid stain that may be detected. Non-limiting examples of nucleic acid stains include acridine orange (also capable of intercalating), 7-AAD, actinomycin D, LDS751, hydroxystilbamidine, SYTOX Blue, SYTOX Green, SYTOX Orange, POPO-1, POPO-3, YOYO-1, YOYO-3, TOTO-1, TOTO-3, JOJO-1, LOLO-1, BOBO-1, BOBO-3, PO-PRO-1, PO-PRO-3, BO-PRO-1, BO-PRO-3, TO-PRO-1, TO-PRO-3, TO-PRO-5, JO-PRO-1, LO-PRO-1, YO-PRO-1, YO-PRO-3, PicoGreen, OliGreen, RiboGreen, SYBR Gold, SYBR Green I, SYBR Green II, SYBR DX, SYTO-40, -41, -42, -43, -44, -45 (blue), SYTO-13, -16, -24, -21, -23, -12, -11, -20, -22, -15, -14, -25 (green), SYTO-81, -80, -82, -83, -84, -85 (orange), SYTO-64, -17, -59, -61, -62, -60, -63 (red).

A reporter used in a Q-PCR or RTQ-PCR reaction may be a fluorescent dye that may be detected. Non-limiting examples of fluorescent dyes include fluorescein, fluorescein isothiocyanate (FITC), tetramethyl rhodamine isothiocyanate (TRITC), rhodamine, tetramethyl rhodamine, R-phycoerythrin, Cy-2, Cy-3, Cy-3.5, Cy-5, Cy5.5, Cy-7, Texas Red, Phar-Red, allophycocyanin (APC), Sybr Green I, Sybr Green II, Sybr Gold, CellTracker Green, 7-AAD, ethidium homodimer I, ethidium homodimer II, ethidium homodimer III, ethidium bromide, umbelliferone, eosin, green fluorescent protein, erythrosin, coumarin, methyl coumarin, pyrene, malachite green, stilbene, lucifer yellow, cascade blue, dichlorotriazinylamine fluorescein, dansyl chloride, fluorescent lanthanide complexes such as those including europium and terbium, carboxy tetrachloro fluorescein, 5 and/or 6-carboxy fluorescein (FAM), 5-(or 6-) iodoacetamidofluorescein, 5-{[2(and 3)-5-(Acetylmercapto)-succinyl]amino} fluorescein (SAMSA-fluorescein), lissamine rhodamine B sulfonyl chloride, 5 and/or 6 carboxy rhodamine (ROX), 7-amino-methyl-coumarin, 7-Amino-4-methylcoumarin-3-acetic acid (AMCA), BODIPY fluorophores, 8-methoxypyrene-1,3,6-trisulfonic acid trisodium salt, 3,6-Disulfonate-4-amino-naphthalimide, phycobiliproteins, AlexaFluor 350, 405, 430, 488, 532, 546, 555, 568, 594, 610, 633, 635, 647, 660, 680, 700, 750, and 790 dyes, DyLight 350, 405, 488, 550, 594, 633, 650, 680, 755, and 800 dyes, or other fluorophores known to those of skill in the art. For detailed listing of fluorophores that may be useful in Q-PCR and RTQ-PCR methods, see also Hermanson, G. T., BIOCONJUGATE TECHNIQUES (Academic Press, San Diego, 1996) and Lakowicz, J. R., PRINCIPLES OF FLUORESCENCE SPECTROSCOPY, (Plenum Pub Corp, 2nd edition (July 1999)), which are incorporated herein by reference.

A reporter used in a Q-PCR or RTQ-PCR reaction may be a radioactive species that may be detected. Non-limiting examples of radioactive species that may be useful in Q-PCR and RTQ-PCR methods include ¹⁴C, ¹²³I, ¹²⁴I, ¹²⁵I, ¹³¹I, Tc99m, ³⁵S, or ³H.

A reporter used in a Q-PCR or RTQ-PCR reaction may be an enzyme that may produce a detectable signal. Such signal may be produced by action of the enzyme on its given substrate. Non-limiting examples of enzymes that may be useful in Q-PCR or RTQ-PCR methods include alkaline phosphatase, horseradish peroxidase, I²-galactosidase, alkaline phosphatase, β-galactosidase, acetylcholinesterase, and luciferase.

A reporter used in a Q-PCR or RTQ-PCR reaction may be an affinity ligand-label that may be detected. A particular ligand may include a label, such as for example, a fluorescent dye, and binding of the labeled ligand to its substrate may produce a useful signal. Non-limiting examples of binding pairs that may be useful in Q-PCR or RTQ-PCR methods include streptavidin/biotin, avidin/biotin or an antigen/antibody complex, such as, for example, rabbit IgG and anti-rabbit IgG;

A reporter used in a Q-PCR or RTQ-PCR reaction may be a nanoparticle that may be detected via light scattering or surface plasmon resonance (SPR). Non-limiting examples of materials useful for SPR-based detection include gold and silver materials. Other nanoparticles that may be useful in Q-PCR or RTQ-PCR reactions may be quantum dots (Qdots). Qdots are generally constructed of semiconductor nanocrystals, described, for example in U.S. Pat. No. 6,207,392. Non-limiting examples of semiconductor materials that may be used to produce a Qdot include MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, HgTe, GaAs, InGaAs, InP, InAs, or mixed compositions thereof.

A reporter used in a Q-PCR or RTQ-PCR reaction may be a labeled oligonucleotide probe. Probe based quantitative methods rely on the sequence-specific detection of amplification products of a desired DNA template, using a labeled oligonucleotide. The oligonucleotide may be a primer or a longer, different type of oligonucleotide. The oligonucleotide may be DNA or RNA. As a result, unlike non-sequence specific reporters, a labeled, sequence-specific probe hybridizes with several bases in an amplification product, and, thus, results in increased specificity and sensitivity of detection. A label linked to a probe may be any of the various reporters mentioned above and may also include a quencher (a molecule used, for example, to inhibit fluorescence). Methods for performing probe-based quantitative amplification are described in U.S. Pat. No. 5,210,015, which is entirely incorporated herein by reference. Non-limiting examples of probes that may be useful in Q-PCR or RTQ-PCR reactions include TaqMan probes, TaqMan Tamara probes, TaqMan MGB probes, or Lion probes.

A variety of arrangements of quencher and fluorescent dye may be used when both are used. In the case of a molecular beacon, for example, a quencher is linked to one end of an oligonucleotide capable of forming a hairpin structure. At the other end of the oligonucleotide is a fluorescent dye. Unbound to a complementary sequence on an amplification product, the oligonucleotide inter-hybridizes with itself and assumes a hairpin configuration. In the hairpin configuration, the fluorescent dye and quencher are brought in close proximity which effectively prevents fluorescence of the dye. Upon hybridizing with an amplification product of a desired template DNA, however, the oligonucleotide hybridizes in a linear fashion, the fluorescence and quencher separate, and fluorescence from the dye may be achieved and subsequently detected. In other example, a linear, RNA based probe that includes a fluorescent dye and a quencher held in adjacent positions may be used for detection. The close proximity of the dye to the quencher prevents its fluorescence. Upon the breakdown of the probe with the exonuclease activity of a DNA polymerase, however, the quencher and dye are separated, and the free dye may fluoresce and be detected. As different probes may be designed for different sequences, multiplexing is possible. In a multiplexed detection, assaying for several DNA templates in the same reaction mixture may be possible by using different probes, each labeled with a different reporter, for each desired DNA template.

A Q-PCR or RTQ-PCR reaction may include a single reporter or may include multiple reporters. One or more detection methodologies may be used for quantification. Moreover, as Q-PCR and RT-PCR generally adds just a quantification step, it may be generally linked to any type of PCR reaction.

### Ligase Chain Reaction (LCR)

LCR is generally a method similar to PCR, with some important key distinctions. A key distinction of general LCR over PCR, is that LCR amplifies an oligonucleotide probe using a DNA ligase enzyme to produce amplification products instead of through polymerization of nucleotides with a DNA polymerase. In LCR, two complementary oligonucleotide probe pairs that are specific to a DNA template may be used. After denaturation of a to-be-replicated template DNA into its individual strands, each probe pair may hybridize to adjacent positions on its respective individual strand of the template. Primers are generally not used in LCR. Any gap and/or nick created by the joining of two probes may be sealed by the enzyme DNA ligase, in order to produce a continuous strand of DNA complementary to the template DNA. Similar to PCR, though, LCR generally requires thermal cycling, with each part of the thermal cycle driving a particular step of the reaction. Repeated temperature changes may result in the denaturation of the DNA template, annealing of the oligonucleotide probes, ligation of the oligonucleotide probes, and separation of the ligated unit from the original DNA template. Moreover, a ligated unit synthesized in one thermal cycle may be replicated in the next thermal cycle. Each thermal cycle may result in a doubling of the DNA template, resulting in exponential amplification of the template DNA in a fashion analogous to PCR.

Gap LCR is a specialized type of LCR that utilizes modified oligonucleotide probes that may not be ligated if a specific sequence is not present on a DNA template. The probes may be designed in a way that when they hybridize to an individual strand of a DNA template, they do so discontinuously and are generally separated by a gap of one to several base pairs. The gap may be filled by with dNTPs using a DNA polymerase, which may result in adjacency of the two original probes. As in general LCR, DNA ligase may join the two resulting, adjacent probes in order to produce a continuous strand of DNA complementary to the original template. The newly synthesized strand may then be used for further thermal cycles of template amplification. Gap LCR generally has higher sensitivity than LCR as it minimizes ligation where a desired sequence is not present on a template DNA. Moreover, the combined use of both DNA ligase and DNA polymerase may also result in a more accurate identification of a sequence of interest, even in cases where low levels of DNA template are available.

Additionally, since LCR is a DNA replication method, analogous methods to RT-PCR, Q-PCR, and RTQ-PCR are possible. For example, any of the reporters specified above may be considered for use in a quantitative (Q-LCR) or real-time quantitative LCR (RTQ-LCR) reaction. Moreover, LCR methods may be combined with PCR or other nucleic amplification techniques.

### Digital Nucleic Acid Amplification

Digital nucleic acid amplification is a technique that allows amplification of a subset of nucleic acid templates fractioned into partitions obtained from a larger sample. In some cases, a partition may comprise a single nucleic acid template, such that amplification products generated from amplification of the template are exclusively derived from the template. Amplification products may be detected using a reporter, including any of those example reporters described herein. The amplification of a single nucleic acid template may be useful in discriminating genetic variations that include, for example, wild-type alleles, mutant alleles, maternal alleles, or paternal alleles of a gene. More comprehensive discussions of this technology, with respect to PCR, can be found elsewhere—see Pohl et al., Expert Rev. Mol. Diagn., 4(1):41-7 (2004), and Vogelstein and Kinzler, Proc. Natl. Acad. Sci. USA 96:9236-9241 (1999), which are both incorporated herein in entirety by reference. So long as the proper thermal cycling of a partition comprising a complete reaction mixture (e.g., a reaction mixture comprising both the nucleic acid template to be amplified and the required reagents for the desired nucleic acid amplification reaction) is achieved, any of the example nucleic acid amplification reactions discussed herein may be conducted digitally. Indeed, digital nucleic acid amplification methods still require thermal cycling and accurate temperature control, as do their non-digital analogues.

In a digital nucleic acid amplification reaction, a large sample is fractioned into a number of smaller partitions, whereby the partitions may contain on average a single copy of a nucleic acid template or multiple copies of a template. Individual nucleic acid molecules may be partitioned with the aid of a number of devices and strategies with non-limiting examples that include micro-well plates, capillaries, dispersions that comprise emulsions, arrays of miniaturized chambers, nucleic acid binding surfaces, flow cells, droplet partitioning, or combinations thereof. Each partition may be thermal cycled to generate amplification products of its component template nucleic acid, using a nucleic acid amplification reaction of choice with non-limiting examples of such reactions that include a digital PCR (dPCR) nucleic acid amplification reaction, a digital LCR (dLCR) nucleic acid amplification reaction, a digital RT-PCR (dRT-PCR) nucleic acid amplification reaction, a digital (dRT-LCR) nucleic acid amplification reaction, a digital Q-PCR (dQ-PCR) nucleic acid amplification reaction, a digital Q-LCR (dQ-LCR) nucleic acid amplification reaction, a digital RTQ-PCR (dRTQ-PCR) nucleic acid amplification reaction, a digital LTQ-LCR (dLTQ-LCR) nucleic acid amplification reaction, or combinations thereof.

In cases where reporters are used, each partition can be considered “positive” or “negative” for a particular nucleic acid template of interest. The number of positives may be counted and, thus, one may deduce the starting amount of the template in the pre-partitioned sample based upon the count. In some examples, counting may be achieved by assuming that the partitioning of the nucleic acid template population in the original sample follows a Poisson distribution. Based on such an analysis, each partition is labeled as either containing a nucleic acid template of interest (e.g., labeled “positive”) or not containing the nucleic acid template of interest (e.g., labeled “negative”). After nucleic acid amplification, templates may be quantified by counting the number of partitions that comprise “positive” reactions. Moreover, digital nucleic acid amplification is not dependent on the number of amplification cycles to determine the initial amount of nucleic acid template present in the original sample. This lack of dependency eliminates relying on assumptions with respect to uncertain exponential amplification, and, therefore, provides a method of direct, absolute quantification.

Most commonly, multiple serial dilutions of a starting sample are used to arrive at the proper concentration of nucleic acid templates in the partitions. The volume of each partition may depend on a host of factors that include, for example, the volume capacity of a thermal cycler used to generate amplification products. Furthermore, quantitative analyses conducted by digital nucleic acid amplification may generally require reliable amplification of single copies of nucleic acid template with low false positive rates. Such capability may require careful optimization in microliter-scale vessels. Moreover, the analytical precision of a nucleic acid amplification reaction may be dependent on the number of reactions.

In some cases, a digital nucleic acid amplification reaction may be a droplet digital nucleic acid amplification reaction. For example, such a nucleic acid amplification reaction may be a droplet digital PCR (ddPCR) nucleic acid amplification reaction. A ddPCR nucleic acid amplification reaction may be completed by first partitioning a larger sample comprising nucleic acids into a plurality of droplets. Each droplet comprises a random partition of nucleic acids in the original sample. The droplets may then be combined with different droplets that comprise the reagents necessary for a PCR reaction (e.g., a set of two primers that may hybridize with a target sequence on the template DNA, a DNA polymerase, deoxynucleotide triphosphates (dNTPs), a buffer at a pH and concentration suitable for a desired PCR reaction, a monovalent cation, and a divalent cation). The new combined droplet is then properly thermal cycled in a thermal cycler and PCR commences. Alternatively, a sample may already comprise reagents necessary for PCR prior to partitioning into droplets—droplet combination with other droplets would, thus, not be required.

Analogous procedures may be followed to complete a droplet digital RT-PCR (ddRT-PCR) nucleic acid amplification reaction, a droplet digital LCR (ddLCR) nucleic acid amplification reaction, a droplet digital RT-PCR (ddRT-LCR) nucleic acid amplification reaction, a droplet digital Q-PCR (ddQ-PCR) nucleic acid amplification reaction, a droplet digital RTQ-PCR (ddRTQ-PCR) nucleic acid amplification reaction, a droplet digital Q-LCR (ddQ-LCR) nucleic acid amplification reaction, or a droplet digital RTQ-LCR (ddRTQ-LCR) reaction.

In the case of a quantitative droplet digital nucleic acid amplification reaction (e.g., ddQ-PCR, ddRTQ-PCR, ddQ-LCR, or ddRTQ-LCR), droplets may also comprise a reporter used to detect amplification products. Such reporters may be contacted with nucleic acids by combining droplets or may already be included in a partition comprising nucleic acid templates to be amplified.

Droplet nucleic acid amplification may be completed using a variety of sample holders. In some examples, droplets may be applied to one or more wells of a sample holder and then thermal cycled. In other examples, a device comprising fluidic channels, such as, for example, a flow cell or microfluidic device may be used. Fluidic channels may be used to transport droplets through a sample holder (or other component of a thermal cycler) such that droplet thermal contact with different temperature regions of the sample holder (or other component of a thermal cycler) results in proper thermal cycling of the droplets.

### EXAMPLES

### Example 1

### Cartridge Comprising Sample Holder and Integrated Heating Element

FIG. 1 shows an example layered schematic of a cartridge for use with the invention 100. Cartridge 100 is assembled via converted-tape technology and thus comprises a series of layers that that are situated between top stiffening layer 101 and bottom stiffening layer 102. The bottom surface of top stiffening layer 101 is adhered to the top surface of adhesive layer 103 whose bottom surface is adhered to top seal layer 104. Top seal layer 104 is adhered on its bottom surface to the top surface of adhesive layer 105 whose bottom surface is adhered to the top surface of chamber volume layer 106. Chamber volume layer 106 is adhered on its bottom surface to the top surface of adhesive layer 107 whose bottom surface is adhered to the top surface of bottom seal layer 108. Chamber volume layer 106, adhesive layer 105, and adhesive layer 107 each comprise a cut hollow 109 such that, when they are situated between top seal layer 104 and bottom seal layer 108, a sample holder is formed. Adhesive layers 105 and 107 may be cut with hollow 109 in order to avoid, as much as possible, adhesive from contacting a sample contained in the formed sample holder. Thus, a sample holder substantially free of adhesive material can be formed. The sample holder has a volume determined by the cross-sectional area of the hollows 109 and the thickness of adhesive layer 105, chamber volume layer 106, and adhesive layer 107.

The cartridge may be constructed of materials that do not interfere with optical detection methods. Injection ports 113 and 114 traverse top stiffening layer 101, adhesive layer 103, top seal layer 104, and adhesive layer 105, to enable introduction of a sample into the sample holder. One injection port may serve as an inlet and the other injection port may serve as an outlet. In some cases, the injection ports may be connected to opposite or orthogonal sides of the sample holder. Injection adaptors 115 and 116 that fit into injection ports 113 and 114 may be used to supply a sample to the sample holder and may also be used as a vent to minimize pressure build-up in the sample holder.

Bottom seal layer 108 is adhered on its bottom surface to heater layer 110. In this example, heater layer 110 comprises thin-film resistive heating element 111, which may be used to heat a sample contained in the sample holder. The cross-sectional area of thin-film resistive heating element 111 may be minimized to possess low electrical resistance and, thus, minimize power requirements. Heater layer 110 is adhered on its bottom surface to the top surface of adhesive layer 112 whose bottom surface is adhered to the top surface of bottom stiffening layer 102. Moreover, hollows 117, which may be similar to the sample holder in cross-sectional area, may be precision-cut through adhesive layers 103 and 112, top stiffening layer 101, and bottom stiffening layer 102, such that the outer surfaces of top seal layer 104 and bottom seal layer 108 are exposed upon cartridge assembly. Such a design may be useful in optical detection of any species contained with the sample holder. Moreover, such a design may also permit a cooling gas or liquid to directly contact the outer surface of top seal layer 104 and/or bottom seal layer 108, which may improve thermal contact of the cooling gas or liquid with the sample holder (and, thus, a sample contained within the sample holder).

While this example cartridge is made by layered assembly, as an alternative, the cartridge may be fabricated by injection molding and integrated with other fluidic components. Moreover, while the example cartridge is depicted with certain geometries, any geometries compatible with the invention may be used. Additionally, the cartridge may be designed so that only certain materials contact the sample. For example, if an adhesive is used to assemble the cartridge, the glue layers may be cut or otherwise processed in a way (e.g., covered) such that the adhesive does not contact the sample.

### Example 2

### Cartridge with Aligner

FIG. 2 shows a layered schematic of a cartridge 200 similar to that shown in FIG. 1, along with an aligner and a larger (relative to that in FIG. 1) heating element 221. Example cartridge 200 is assembled via converted-tape technology, and thus, comprises a series of layers. Stiffening layer 201 is adhered on its bottom surface to the top surface of adhesive layer 202 whose bottom surface is adhered to the top surface of top seal layer 203. Top seal layer 203 is adhered on its bottom surface to the top surface of adhesive layer 204 whose bottom surface is adhered to the top surface of chamber volume layer 205. The bottom surface of chamber volume layer 205 is adhered to the top surface of adhesive layer 206 whose bottom surface is adhered to the top surface of bottom seal layer 207. Bottom seal layer 207 may be a membrane. Chamber volume layer 205, adhesive layer 204, and adhesive layer 206 each comprise a cut hollow 208 such that, when they are situated between top seal layer 203 and bottom seal layer 207, a sample holder is formed. The sample holder has a volume determined by the cross-sectional area of hollows 208 and the thickness of adhesive layer 204, chamber volume layer 205, and adhesive layer 207.

The cartridge may be constructed of materials that do not interfere with optical detection methods. Injection ports 209 and 210 traverse top stiffening layer 201, adhesive layer 202, top seal layer 203, and adhesive layer 204, to enable introduction of a sample into the sample holder. One injection port may serve as an inlet and the other injection port may serve as an outlet. In some cases, the injection ports may be connected to opposite or orthogonal sides of the sample holder. Injection adaptors 211 and 212 that fit into injection ports 209 and 210 may be used to supply a sample to the sample holder and may also be used as vents to minimize pressure build-up in the sample holder.

Hollows 213, which may be similar to the sample holder in cross-sectional area, may be precision-cut completely through adhesive layer 202 and stiffening layer 201, such that the outer surface of top seal layer 203 is exposed upon cartridge assembly. Such a design may be useful in optical detection of any species contained within the sample holder. Moreover, such a design may also permit a cooling gas or liquid to directly contact the outer surface of top seal layer 203, which may improve thermal contact of the cooling gas or liquid with the sample holder (and, thus, a sample contained within the sample holder).

Cartridge 200 rests on heater 220 and may be positioned using aligner 230. Aligner 230 is designed to rest on heater 220 and comprises hollow 231, in which cartridge 200 may fit. Via the aligner, the sample holder of cartridge 200 may be aligned with the thin-film resistive heating element 221 of heater 220. Electrical leads 222 of heater 220 may be used to supply electrical energy to thin-film resistive heating element 221. In this example, the cross-sectional area of thin-film resistive heating element 221 is oversized with respect to the cross-sectional area of the sample holder of cartridge 200. This is intended to maximize the heating output of heater 220 and the uniformity with which a sample contained within the sample holder of cartridge 200 is heated. In contrast, thin-film resistive heating element 111 provided in FIG. 1. is smaller, has lower overall electrical resistance, and is optimized for low power.

While this example cartridge is made by layered assembly, as an alternative, the cartridge may be fabricated by injection molding and integrated with other fluidic components. Moreover, while the example cartridge is depicted with certain geometries, any geometry compatible with the present disclosure may be used. Additionally, the cartridge may be designed so that only certain materials contact the sample. For example, if an adhesive (e.g., glue) is used to assemble the cartridge, the adhesive layers may be cut or otherwise processed in a way (e.g., covered) such that the adhesive does not contact the sample.

### Example 3

### Cartridge Comprising Additional Adhesive Layer, Protective Thin Layer, and Thermal Enhancer Layer

FIG. 3 shows an example layered schematic of a cartridge for use with the invention 300 and its arrangement with heater 320. Cartridge 300 is assembled via converted-tape technology and thus comprises a series of layers. A stiffening layer 301 is adhered on its bottom surface to the top surface of adhesive layer 302 whose bottom surface is adhered to the top surface top seal layer 303. Top seal layer 303 is adhered on its bottom surface to the top surface of adhesive layer 304 whose bottom surface is adhered to the top surface of chamber volume layer 305. The bottom surface of chamber volume layer 305 is adhered to the top surface of adhesive layer 306 whose bottom surface is adhered to the top surface of bottom seal layer 307. Chamber volume layer 305, adhesive layer 304, and adhesive layer 306 each comprise a cut hollow 308 such that, when situated between top seal layer 303 and bottom seal layer 307, a sample holder is formed. The sample holder has a volume determined by the cross-sectional area of hollows 308 and the thickness of adhesive layer 304, chamber volume layer 305, and adhesive layer 306.

The cartridge may be constructed of materials that do not interfere with optical detection methods. Injection ports 309 and 310 traverse stiffening layer 301, adhesive layer 302, top seal layer 303, and adhesive layer 304, to enable introduction of a sample into the sample holder. Injection adaptors 311 and 312 that fit into injection ports 309 and 310 may be used to supply a sample to the sample holder and may also be used as vents to minimize pressure build-up in the sample holder.

Hollows 313, which may be similar to the sample holder in cross-sectional area, are cut completely through adhesive layer 302 and stiffening layer 301, such that the outer surface of top seal layer 303 is exposed upon cartridge assembly. Such a design may be useful in optical detection of any species contained within the sample holder. Moreover, such a design may also permit a cooling gas or liquid to directly contact the outer surface of top seal layer 303, which may improve thermal contact of the cooling gas or liquid with the sample holder (and, thus, a sample contained within the sample holder).

Cartridge 300 rests on heater 320 and may be positioned using aligner 330. In this example, aligner 330 is may be adhered to heater 330, via adhesive layer 340 that may be of the same cross-sectional shape as aligner 330 and comprises a space 331, in which cartridge 300 may fit and align with thin-film resistive heating element 321 of heater 320. The space 331 may be defined by one or more walls of the aligner 330. In the illustrated example, the space 331 is defined by an inner wall of the aligner 330.

Optionally situated between heater 320 and cartridge 300 is either or both of a thermal enhancer layer 350 (which improves the thermal contact between heater 320 and sample holder 300) and a heater protective layer 360 (designed to protect thin-film resistive heating element 321). Alternatively, layer 360 may be a thermal spreader. The cross-sectional area of thin-film resistive heating element 321 is oversized with respect to that of the sample holder of cartridge 300, to maximize the heating output of heater 320 and the uniformity with which a sample contained within the sample holder of cartridge 300 is heated.

### Example 4

### Heater

FIG. 4 shows a multiple view schematic of an example heater 400 for use with the invention. Heater 400 comprises a thin-film resistive heating element 401 mounted on a carrier 402. Electrical leads 403 and 404 are used to connect the heater 400 to an electrical circuit that supplies electrical current to the thin-film resistive heating element 401. An optional protective layer 405 may be associated with thin-film resistive heating element 401, designed to provide protection to the thin-film resistive heating element 401. Moreover, an optional thermal spreader 406 may also be appended directly beneath the bottom surface of thin-film resistive heating element 401 on the opposite side of carrier 402. Thermal spreader 406 is designed to improve thermal uniformity of heat from the thin-film resistive heating element 401. Thermal spreader 406 may also provide increased heat transfer to a cooling gas or liquid. In addition, heater 400 may optionally comprise a series of fins 407 located at various points on its surfaces in order to aid in proper lateral venting of cooling gas or liquid that is arranged to impinge on that surface.

The heater may be made by printed circuit board or flexible circuit board fabrication methods. The thermal spreader may be a layer of a high thermal conductivity material, such as copper.

### Example 5

### Wind Tunnel

FIG. 5 shows a multiple view schematic of an example wind tunnel 500. Wind tunnel 500 is a solid block 501, wherein material has been removed to form hollow 502. Hollow 502 extends the height of the device, and creates openings at orifices 503 and 504 of solid block 501. Orifice 503, at the bottom surface of solid block 501 is circular and generally larger in area than orifice 504 which is an elliptical shape and opens at the top surface of the solid block. The cross-sectional area of hollow 502 generally decreases with increasing height away from orifice 503, in the direction of orifice 504. When utilized in a device of the disclosure, a source of cooling gas or liquid (not shown) may be positioned to feed into wind tunnel 500 at orifice 503. The progressively reduced cross-sectional area of hollow 502 and/or the narrow opening at orifice 504 may aid in increasing the flow rate of and/or channeling the supplied cooling gas or liquid as it exits the wind tunnel at orifice 504.

### Example 6

### Example Thermal Cycler Device

A multiple view schematic of an example thermal cycler device 600 is shown in FIG. 6. Thermal cycler 600 comprises a wind tunnel 610, a bottom clamp (comprising a set of vents 621) 620, a heater support 630, a heater 640, a cartridge 650 comprising a sample holder, a top clamp 660, and an aligner 670. Cartridge 650 is in thermal contact with heater 640, and may be positioned with heater 640, via aligner 670. Heater 640 rests on heater support 630, designed as a grill for purposes of this example. Heater support 630 fits into a patterned platform formed by vents 621 on the top surface of bottom clamp 620. Bottom clamp 620 is mated to wind tunnel 610 via a set of screws. Cartridge 650 may be integrated into the thermal cycler via a set of screws that link top clamp 660 to bottom clamp 620.

Wind tunnel 610 is a solid block, wherein material has been removed to form hollow 611. Hollow 611 extends the height of wind tunnel 610, between orifices 612 and 613. Orifice 613, at the bottom surface of wind tunnel 610, is circular and generally larger in area than orifice 612 which is an elliptical shape and opens at the top surface of wind tunnel 610. The cross-sectional area of hollow 611 generally decreases with increasing height away from orifice 613, in the direction of orifice 612. A source of cooling gas or liquid (not shown) may be positioned to feed cooling gas or liquid into wind tunnel 610 at orifice 613. The progressively reduced cross-sectional area of hollow 611 and/or the narrow opening at orifice 612 may aid in increasing the flow rate of and directing the supplied cooling gas or liquid as it exits the wind tunnel at orifice 612. After exiting wind tunnel 610 at orifice 612, a cooling gas or liquid that is supplied through wind tunnel 610 flows through hollow 622 in bottom clamp 620 and impinges on heater support 630 and, also, heater 640 via the grill holes of heater support 630. After the cooling gas or liquid cools heater 640, the cooling gas or liquid may escape the device through vents 621.

### Example 7

### Example Thermal Cycler Device

A layered schematic of an example thermal cycler device 700 is shown in FIG. 7. Thermal cycler 700 comprises a wind tunnel 710, a bottom clamp (comprising a set of vents 721) 720, a heater support 730, a heater 740, an aligner 750, a cartridge 760 comprising a sample holder, and a top clamp 770. Cartridge 760 is in thermal contact with heater 740, and may be positioned over heater 740 via aligner 750. Heater 740 rests on heater support 730, designed as a grill, in this example. The heater support 730 fits into a patterned platform formed by vents 721 on the top surface of bottom clamp 720. Bottom clamp 720 is mated to wind tunnel 710 via a set of screws. Cartridge 760 may be integrated into the thermal cycler via a set of screws that link top clamp 770 to bottom clamp 720.

Wind tunnel 710 is a solid block in which wherein material has been removed to form hollow 711. Hollow 711 is positioned between orifices 712 and 713. Orifice 712, open at a side surface of wind tunnel 710, is circular whereas orifice 713 is a rounded rectangle shape and opens at the top surface of wind tunnel 710. A source of cooling gas or liquid (not shown) may be positioned to feed cooling gas or liquid into wind tunnel 710 at orifice 712 and exit at orifice 713. After exiting wind tunnel 710 at orifice 713, a cooling gas or liquid that is supplied through wind tunnel 710 flows through the hollow 722 in bottom clamp 720 and impinges on heater support 730 and, also, heater 740 via the grill holes of heater support 730. After the cooling gas or liquid cools heater 740, the cooling gas or liquid may escape the device through vents 721.

### Example 8

### Example Thermal Cycler Device

A layered schematic of an example thermal cycler device 800 is shown in FIG. 8. Thermal cycler 800 comprises a wind tunnel 810, a bottom clamp (comprising a set of vents 822) 820, a heater support 830, a heater 840, a cartridge 850 comprising a sample holder, and a top clamp 860. Cartridge 850 is in thermal contact with heater 840. Heater 840 rests on heater support 830, designed as a grill, for this example. Heater support 830 fits into a patterned recess formed by vents 822 that line an opening 821 in bottom clamp 820. Bottom clamp 820 is mated to wind tunnel 810 via a set of screws. Cartridge 850 may be integrated into the thermal cycler via a set of screws that link top clamp 860 to bottom clamp 820.

Wind tunnel 810 is a solid block in which material has been removed to form hollow 811. Hollow 811 ends at orifice 812 which is of a rounded rectangle shape and opens at the top surface of wind tunnel 810. A fan 870 provides cooling air and is positioned to feed cooling air into wind tunnel 810 via a second orifice (not shown) on the bottom surface of wind tunnel 810. This orifice may be larger in cross-sectional area than orifice 812. The supplied cooling air exits at orifice 812. After exiting wind tunnel 810 at orifice 812, the cooling gas that is supplied through wind tunnel 810 flows through the opening 821 in bottom clamp 820 and impinges on heater support 830 and, also, heater 840 via the grill holes of heater support 830. After the cooling air cools heater 840, the cooling air may escape the device through vents 822.

### Example 9

### Example Thermal Cycler Device

A layered schematic of an example thermal cycler device 900 is shown in FIG. 9. Thermal cycler 900 is a double-sided design in which a sample contained within cartridge 910 is cooled with cooling air provided from two opposing directions. Cartridge 910, comprising a sample holder, rests on heater 920 and may be positioned via aligner 930. In addition to cartridge 910, heater 920, and aligner 930, thermal cycler 900 comprises two grill supports 940, two clamps 950, two wind tunnels 960, and two fans 970.

Grill supports 940 are placed on the top side of cartridge 910 and on the bottom side of heater 920, so as to force heater 920 and cartridge 910 into thermal contact. Each grill support 940 may fit into a patterned complement formed by a set of vents 951 that is constructed around the perimeter of hollow 952 cut into each clamp 950. Each clamp 950 is mated to a respective wind tunnel 960 via a set of screws.

Each of wind tunnels 960 is a solid block in which material has been removed to form hollows 961. Hollows 961 open at orifices 962 which are of a rounded rectangle shape and located at the surface of wind tunnels 960 that are in mechanical contact with clamps 950. Hollows 961 are also open at orifices 963, which are of a circular shaper, larger in cross sectional area that orifices 962 and at the surface of wind tunnels 960 that accept air from fans 970.

Fans 970 may be mated to wind tunnels 960 via a set of screws. The cross-sectional area of hollows 961 generally decreases with increasing distance away from orifices 963, in the direction of orifices 962. The progressively reduced cross-sectional area of hollows 961 and/or the narrower opening at orifices 962 may aid in increasing the flow rate of and directing the cooling air supplied by fans 970 as it exits the wind tunnel at orifices 962. After exiting wind tunnels 960 at orifices 962, cooling air that is supplied by fans 970 and through a wind tunnels 960 flows through hollows 952 cut into a clamps 950 and impinges on its intended target component.

The fan 970/wind tunnel 960 combination arranged below heater 920 impinges cooling air on heater 920 and its respective grill support 940. The fan 970/wind tunnel 960 combination arranged above cartridge 910 impinges cooling air on cartridge 910 and its respective grill support 940. After the cooling air cools heater 920 or cartridge 910, the cooling air may escape the device through respective vents 951. In some cases, thermal cycler 900 may be oriented in a 90-degree rotation from the orientation shown in FIG. 9, such that cartridge 910 is held vertically and a sample that is contained within the sample holder of cartridge 910 is in mechanical contact with both of its thermal transfer surfaces (e.g., those in the direction of heating and/or cooling) that close off the sample holder to the external environment.

### Example 10

### Example Thermal Cycler Device

A layered schematic of an example thermal cycler device 1000 is shown in FIG. 10. Thermal cycler 1000 is a double-sided design in which a sample contained within cartridge 1010 is both heated and cooled in two opposing directions. Cartridge 1010, comprising a sample holder, is situated between two heaters 1020. In addition to cartridge 1010 and heaters 1020, thermal cycler 1000 comprises two grill supports 1030, two clamps 1040, two wind tunnels 1050, and two fans 1060.

A grill support 1030 is placed at the surface of each heater 1020. Each grill support 1030 may fit into a patterned complement formed by a set of vents 1041 that are constructed around the perimeter of hollow 1042 cut into each clamp 1040. Each clamp 1040 is mated to a respective wind tunnel 1050 via a set of screws.

Each of wind tunnels 1050 is a solid block in which material has been removed to form hollows 1051. Hollows 1051 create orifices 1052 which are of a rounded rectangle shape and located at the surfaces of wind tunnels 1050 that are in mechanical contact with clamps 1040. Hollows 1051 also create orifices 1053, which are of a circular shaper, larger in cross sectional area than orifices 1051 and located at the surfaces of a wind tunnels 1050 that accept air from fans 1060. Fans 1060 may be mated to wind tunnels 1050 via a set of screws. The cross-sectional areas of hollows 1051 generally decreases with increasing distance away from orifices 1053, in the direction of orifice 1052. The progressively reduced cross-sectional areas of hollows 1051 and/or the narrower openings at orifices 1052 may aid in increasing the flow rate of and directing the cooling air supplied by fans 1060 as it exits the wind tunnels at orifices 1052. After exiting a wind tunnel 1050 at orifice 1052, cooling air that is supplied by a fan 1060 and through a wind tunnel 1050 flows through the hollow 1042 cut into a clamp 1040 and impinges on its intended target component. Each fan 1060/wind tunnel 1050 combination impinges cooling air on its respective heater 1020 and its respective grill support 1030. After the cooling air cools heater 1040, the cooling air may escape the device through vents 1041. Thermal cycler 1000 may be oriented in a 90-degree rotation from the orientation shown in FIG. 10, such that the cartridge 1010 is held vertically and any sample that is contained within the sample holder of cartridge 1010 is in mechanical contact with both the its thermal transfer surfaces (e.g., those in the direction of heating and/or cooling) that close off the sample holder to the external environment.

### Example 11

### Control Assembly

A conceptual schematic for an example control assembly 1150 is shown in FIG. 11B. A computer 1151 serves as the central hub for control assembly 1150. Computer 1151 is in communication with a display 1152, one or more input devices (e.g., a mouse, keyboard, camera, etc.) 1153, and a printer 1154. Control assembly 1150, via its computer 1151, is in communication with three devices: a sample pre-processing unit 1160, a thermal cycler 1170, and a detector 1180. The sample pre-processing unit 1160, thermal cycler 1170, and detector 1180 may be arranged in a micro-fluidic circuit, or other fluidic circuit. The control assembly may be networked, for example, via an Ethernet connection.

A user may provide inputs (e.g., the parameters necessary for a desired set of nucleic acid amplification reactions) into computer 1151 using an input device 1153. The inputs are interpreted by computer 1151 to generate instructions. The computer 1151 communicates such instructions to sample pre-processing unit 1160, thermal cycler 1170, and/or detector 1180 for execution.

For example, via on-board circuitry of thermal cycler 1170, such instructions might include the level of electrical current supplied to a heater of thermal cycler 1170 or device component that modulates the flow of cooling gas or liquid from its source. Moreover, during operation of sample pre-processing unit 1160, thermal cycler 1170, and/or detector 1180, each device may communicate signals back to computer 1151. Such signals may be interpreted and used by computer 1151 to determine if any of the devices require further instruction. For example, during operation of thermal cycler 1170, signals (e.g., temperature measurements recorded by one of more temperature sensors that are included as part of thermal cycler 1170) from thermal cycler 1170 may be communicated back to computer 1151 which may interpret such signals and modulate thermal cycler 1170, pre-processing unit 1160, and/or detector 1180. Computer 1151 may also modulate sample pre-processing unit 1160, such that the components of a sample are mixed appropriately and fed, at a desired or otherwise predetermined rate, into a sample holder of thermal cycler 1170. Computer 1151 may also communicate with detector 1180 such that the detector performs measurements at desired or otherwise predetermined time points or at time points determined from feedback received from pre-processing unit 1160 or thermal cycler 1170. Detector 1180 may also communicate raw data obtained during measurements back to computer 1151 for further analysis and interpretation. Analysis may be summarized in formats useful to an end user via display 1153 and/or printouts generated by printer 1154. Instructions or programs used to control the sample pre-processing unit 1160, thermal cycler 1170, and/or detector 1180; data acquired by executing any of the methods described herein; or data analyzed and/or interpreted may be transmitted to or received from one or more remote computers 1190, via a network 1195, which, for example, could be the Internet.

### Example 12

### Integration of a Thermal Cycler with a Sample Pre-Processing Unit

A schematic of example system 1200 is shown in FIG. 12. System 1200 comprises sample mixing unit 1210 and thermal cycler device 1230. Sample mixing unit 1210 is a sample pre-processing unit that functions to properly mix the various reagents necessary for a nucleic acid amplification reaction with sample containing a nucleic acid to be amplified. Sample mixing unit 1210 comprises a number of vessels 1211, 1212, 1213, and 1214 that each may contain one or more reagents necessary for a nucleic amplification reaction. The vessels are fluidically connected via micro-fluidic channels 1215, 1216, 1217, and 1218, respectively to mixing vessel 1219. Mixing vessel 1219 comprises a pump and a number of valves that aid in controlling the flow rates and directions of flow of the species that are both contained within vessels 1211, 1212, 1213, 1214 and the mixing vessel 1219. A sample comprising a nucleic acid may be introduced into the system via port 1220. The sample comprising the nucleic acid is transported, via micro-fluidic channel 1221 and through the action of the pump connected to mixing vessel 1219, into mixing vessel 1219 where it is combined with reagents from vessels 1211, 1212, 1213, and 1214.

Following proper mixing of the nucleic acid with the reagents required for the nucleic acid amplification reaction, the sample is pumped, via micro-fluidic channel 1222 into sample holder 1231 of cartridge 1232 of thermal cycler 1230 for subsequent amplification via thermal cycling. A detector (not shown) may be arranged such that it is capable of detecting one or more species contained in sample holder 1231 of cartridge 1232, or the detector may be arranged in a downstream auxiliary unit operation 1233, such that the one or more species flow from the sample holder 1231 to auxiliary unit operation 1233. Such one or more species may be selected by a user. Such an arrangement may be useful in conducting real-time nucleic acid amplification reactions such as RTQ-PCR or RTQ-LCR. The system described in this example may be used for many other methods, such as those involving sample preparation and thermal cycling.

### Example 13

### Ultrafast Thermal Cycles

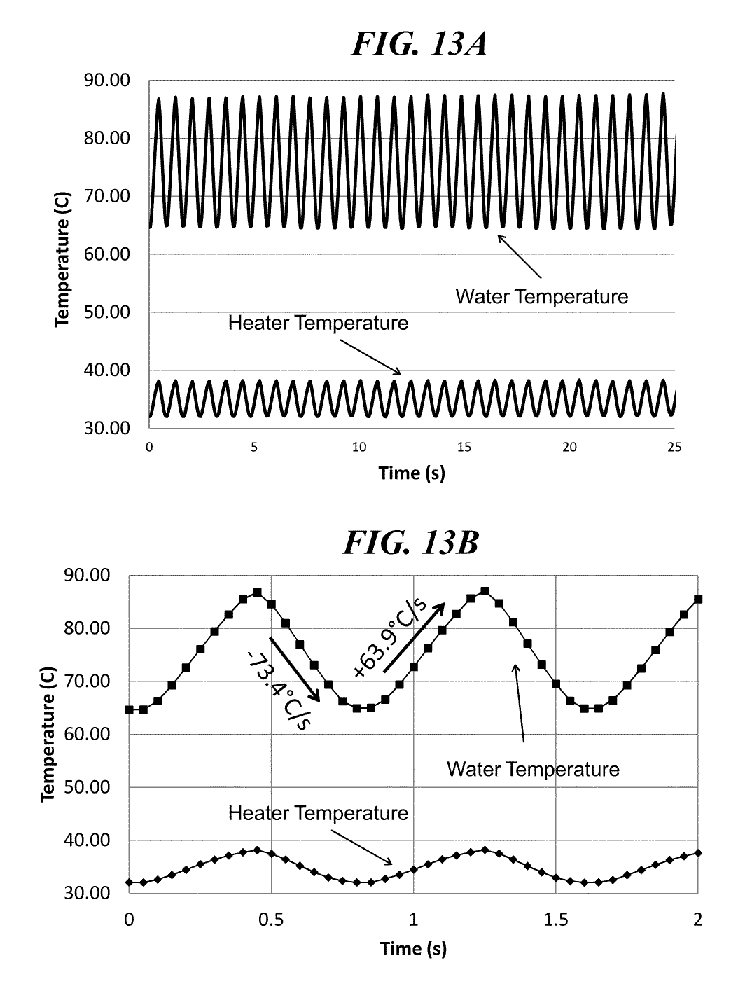

A thermal cycling experiment was performed using a device as described in Example 7. An 11.5 μL sample of water was placed into the 11.5 μL sample holder comprising a 0.002 in. thick bottom seal layer, similar in configuration to that described in Example 2. The cartridge, with the exception of its adhesive layers, was made from poly (acrylic acid). A thermocouple was embedded in the sample holder and used to record the temperature of the water. Thermocouples were also placed on the top side of the thermal cycler heater. In an alternative embodiment, a thermocouple may be formed by contacting a wire with the surface of a thermal spreader. A voltage may be generated via the Seebeck effect. For example, in an example where a copper thermal spreader is utilized, contacting the thermal spreader with a constantan wire can result in the formation of a “T” type thermocouple. In another alternative embodiment, one or more thermocouple(s) may be placed on the bottom of a thermal spreader. A compressed air canister was used to supply cooling air at a volumetric flow rate of 5 standard cubic feet per minute (“scfm”). The temperature of the water was cycled between about 64° C. and about 87° C. with minimal hold times, for a total time of 24 seconds to complete 30 thermal cycles. Plots of water temperature and heater temperature recorded from the respective thermocouples as a function of time are shown in FIG. 13A. Close-up views of the plots of FIG. 13A, during time-points of 0-2 seconds, are shown in FIG. 13B. As shown in FIG. 13A, 30 thermal cycles were achieved during the 24-second time period, or about 1.25 thermal cycles per second. The close-up views shown in FIG. 13B indicate that heating rates of +63.9° C./min were achieved during heating and cooling rates of −73.4° C./min were achieved during cooling. Moreover, FIG. 13B clearly indicates that a single thermal cycle is completed in about 0.8 seconds.

### Example 14

### Amplification of a GSDMA2 Gene Sequence

A PCR experiment was performed to amplify a target GSDMA2 gene sequence, using a thermal cycler as described in Example 7. A sample volume of 11.5 μL was placed in the sample holder comprising a 0.002 in. bottom seal layer, similar in configuration to that described in Example 2. The cartridge was made from poly (acrylic acid). The components of the sample were primer sequences matching the target GSDMA2 gene sequence (forward primer of SEQ ID NO:1 and reverse primer of SEQ ID NO:2), master mix 86 (MM86—a mixture comprising polymerase, dNTPs, MgCl₂, and appropriate buffer), and the target GSDMA2 gene sequence (SEQ ID NO:3). Thermocouple(s) were placed on the thin-film resistive heating element (e.g., 401 shown in FIG. 4) used for heating. The temperature of the sample was cycled between about 62° C. and 90° C. with minimal hold times. Nine experiments were conducted, with thirty cycles performed for each experiment. Two experiments were completed in 36 seconds (0.833 cycles/sec), two were completed in 50 seconds (0.6 cycles/sec), two experiments were completed in 90 seconds (0.333 cycles/sec), two experiments were completed in 300 seconds (0.1 cycles/sec), and a single experiment was completed in 600 seconds (0.05 cycles/sec).

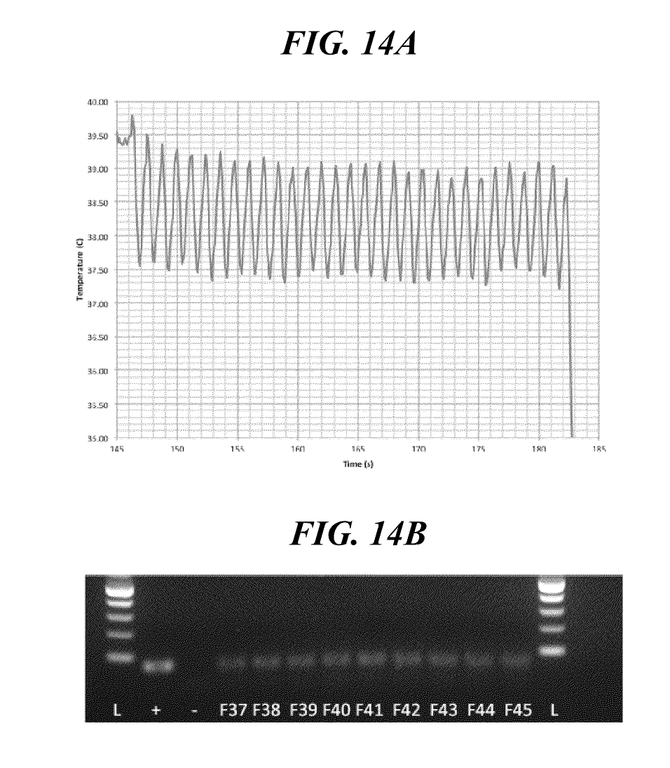

Positive and negative control amplifications were performed in a MASTERCYCLER thermal cycler. A plot of heater temperature recorded from the thermocouple as a function of time during thermal cycling for a 36-second time period is shown in FIG. 14A, indicating the completion of 30 thermal cycles during the 36-second time period. Recorded heater temperatures are in a temperature range different than that of the sample, due to the placement and calibration of the thermocouple. FIG. 14B is a photograph of a post-thermal cycling gel electrophoresis experiment that confirms successful amplification of GSDMA2. Lane F37 and lane F38 correspond to each of the two 36-second experiments, lane F39 and lane F40 correspond to each of the two 50-second experiments, lane F41 and lane F42 correspond to each of the two 90-second experiments, lane F43 and lane F44 correspond to each of the 300-second experiments, lane F45 corresponds to the 600-second experiment, lane+ corresponds to positive control, lane− corresponds to negative control, and lane L corresponds to the size ladder necessary to interpret results.

### Example 15

### Amplification of a GSDMA2 Gene Sequence

A PCR experiment was performed to amplify the GSDMA2 sequence using a thermal cycler as described in Example 8. A sample volume of 11.5 μl was placed in the sample holder of a cartridge comprising a 0.002 in. bottom seal layer and made from poly(acrylic acid). The components of the sample were master mix 86 (MM86—a mixture comprising polymerase, dNTPs, MgCl₂, primers (e.g., forward primer of SEQ ID NO:1 and reverse primer of SEQ ID NO:2), and appropriate buffer) and a nucleic acid comprising the target GSDMA2 sequence (SEQ ID NO:3). Thermocouple(s) were placed on the thin-film resistive heating element (e.g., 401 shown in FIG. 4) used for heating. The temperature of the sample was cycled between about 63° C. and about 84° C. Positive and negative control amplifications were performed in a MASTERCYCLER thermal cycler.

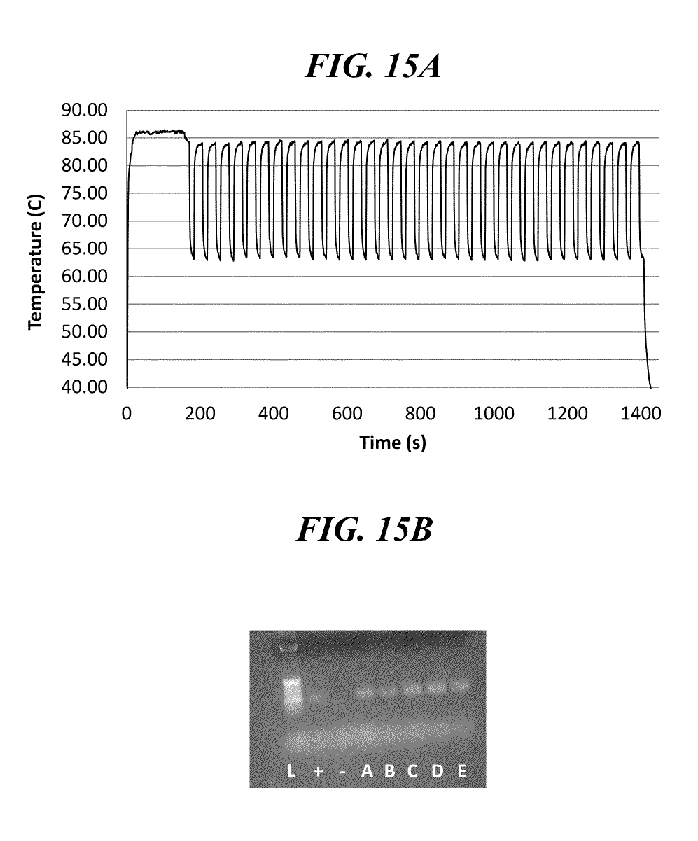

A total of 34 thermal cycles were completed during the amplification experiment. FIG. 15A shows a plot of heater temperature as a function of time during the amplification. FIG. 15B is a photograph of an agarose gel that confirms successful amplification of the nucleic acid, with bands similar in intensity to those obtained from amplification in the MASTERCYCLER. The complete amplification, comprising multiple amplification cycles, in the MASTERCYCLER required about 25 minutes. Lanes A-E correspond to different sample holders, as in Example 8, subjected to different cycling temperatures; lane+ corresponds to positive control; lane− corresponds to negative control; and lane L corresponds to the size ladder necessary to interpret results.

### Example 16

### Amplification of HIV Gene Sequence Alone or in Combination with BCR-ABL Gene Sequence

A PCR experiment was performed to amplify an HIV gene sequence using haptenylated primers and a thermal cycler as described in Example 8. A sample volume of 11.5 μl was placed in the sample holder of a cartridge comprising a 0.005 in. bottom seal layer and made from polypropylene. The sample comprised polymerase, dNTPs, MgCl₂, haptenylated primers (e.g., forward primer of SEQ ID NO:4 and reverse primer of SEQ ID NO:5), the appropriate buffer, and a nucleic acid comprising the target HIV gene sequence (e.g., SEQ ID NO:6). Thermocouple(s) were placed on the thin-film resistive heating element (e.g., 401 shown in FIG. 4) used for heating. The temperature of the sample was cycled between about 60° C. and about 88° C.

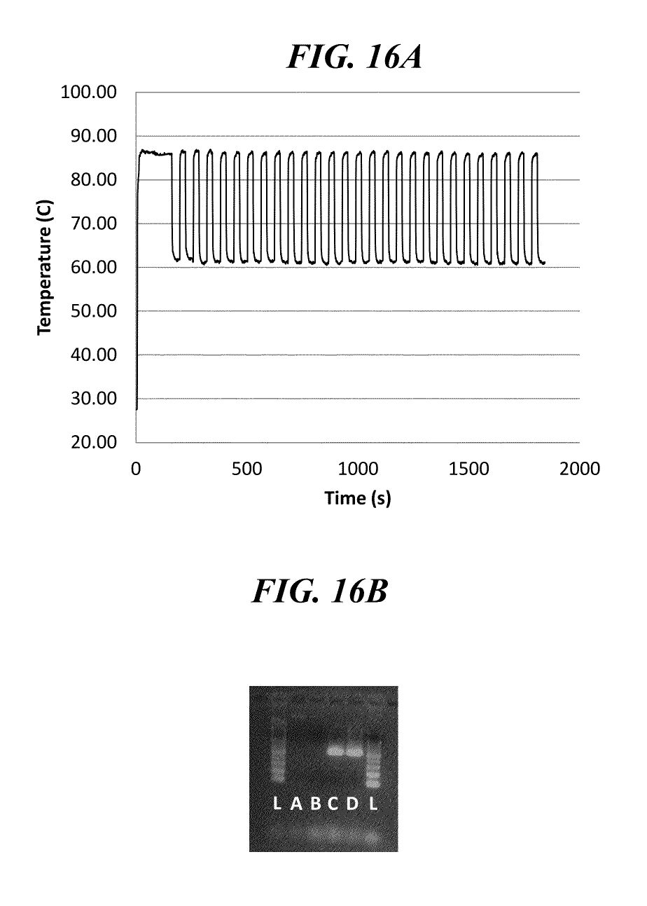

A total of 27 thermal cycles were completed during the amplification. FIG. 16A shows a plot of heater temperature as a function of time during the amplification. FIG. 16B is a photograph of an agarose gel that confirms successful amplification of the nucleic acid. Lanes A-D correspond to different sample holders, as in Example 8, subjected to different cycling temperatures; and lane L corresponds to the size ladder necessary to interpret results.

A similar PCR experiment was performed to show co-amplification of an HIV gene sequence and a BCR-ABL gene sequence using a thermal cycler as described in Example 8. A sample volume of 11.5 μL was placed in the sample holder of a cartridge comprising a 0.005 in. bottom seal layer and made from polypropylene. As above, the sample included polymerase, dNTPs, MgCl₂, haptenylated primers (e.g., forward primer of SEQ ID NO:4 and reverse primer of SEQ ID NO:5), BCR-ABL primers (e.g., forward primer of SEQ ID NO:7 and reverse primer of SEQ ID NO:8), the appropriate buffer, about 200 copies of a nucleic acid comprising the target HIV gene sequence (e.g., SEQ ID NO:6), and about 1000 copies of a template nucleic acid comprising a sequence (e.g., SEQ ID NO:9) comprising the target BCL-ABL gene sequence (e.g., SEQ ID NO:10). The temperature of the sample was cycled between about 64.6° C. (annealing) and about 88° C.

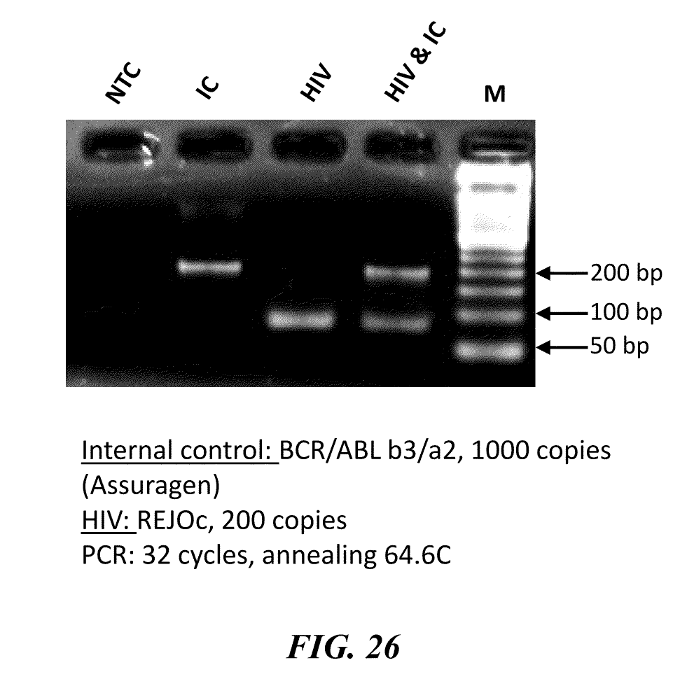

A total of 32 thermal cycles were completed during the amplification. FIG. 26 depicts an agarose gel that confirms successful amplification of both target nucleic acids. Lane NTC corresponds to negative control; lane IC (“internal control”) corresponds to BCR-ABL alone; lane HIV corresponds to HIV alone; lane HIV & IC corresponds to both of BCR-ABL and HIV; and lane M corresponds to the size ladder necessary to interpret results.

### Example 17

### Amplification of a GSDMA2 Gene Sequence

A PCR experiment was performed to amplify the GSDMA2 sequence using a thermal cycler as described in Example 7. A sample volume of about 35 μl was placed in the sample holder of a cartridge comprising a 0.002 in. bottom seal layer and made from poly(acrylic acid). The components of the sample were master mix 86 (MM86—a mixture comprising polymerase, dNTPs, MgCl₂, primers (e.g., forward primer of SEQ ID NO:4 and reverse primer of SEQ ID NO:5), and appropriate buffer) and a nucleic acid comprising the target GSDMA2 sequence (e.g., SEQ ID NO:3). Thermocouple(s) were placed on the thin-film resistive heating element (e.g., 401 shown in FIG. 4) used for heating. The temperature of the sample was cycled between about 60° C. and about 90° C. Positive and negative control amplifications were performed in a MASTERCYCLER thermal cycler.

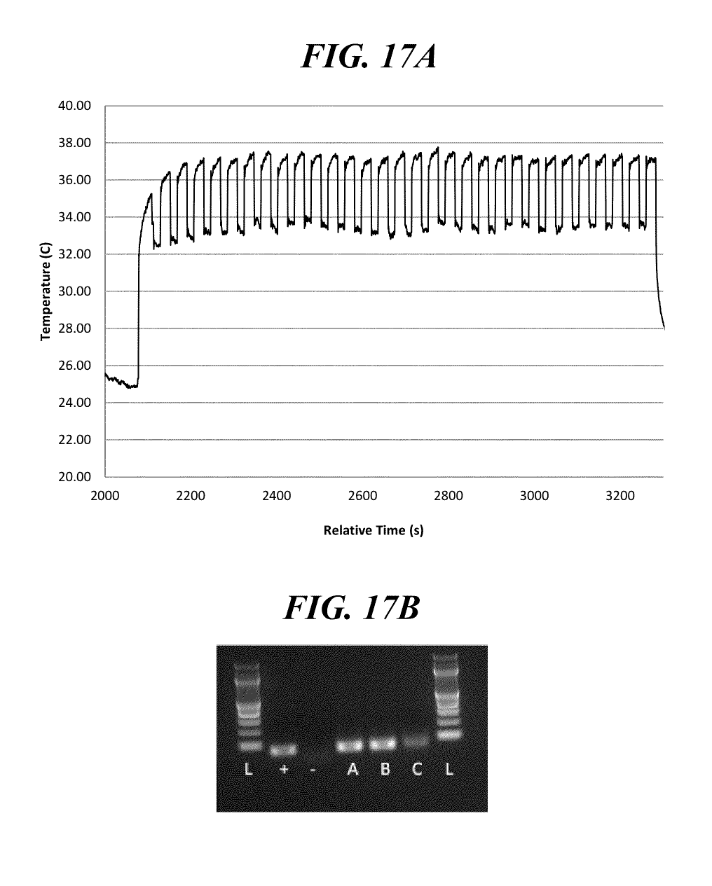

Three experiments were performed, each including a total of 30 thermal cycles. The experiments were completed in about 3200 seconds. FIG. 17A shows a plot of heater temperature as a function of time during the amplification. FIG. 17B is a photograph of an agarose gel that confirms successful amplification of the nucleic acid, with bands similar in intensity to those obtained from a commercially available thermal cycler. Lane A and lane B correspond to each of the 3200-second experiments; lane C corresponds to an experiment with different cycling temperatures; lane+ corresponds to the positive control; lane− corresponds to the negative control; and lane L corresponds to the size ladder necessary to interpret results.

### Example 18

### Energy Consumption During Thermal Cycling

A series of thermal cycling experiments was performed using a thermal cycler as described in Example 8. In this experiment, an 11.5 μL sample was held at a steady-state temperature equal to about 77.5° C. Such a temperature may represent, for example, the average temperature of thermal cycling between 60° C. and 95° C. The experiments consisted of thermal cycles conducted using 2%, 4%, 6%, or 10% heater power. Power used by the fan was also monitored. Percent heater power refers to the supplied fraction of the maximum power that may be supplied to the heater of the thermal cycler. Heater operation is continuous and constant during each experiment, and, thus, requires increased fan output for proper cooling. The experiment was designed to assess the maximum energy consumption of the system when all components are operating at the designated mid-range power levels.

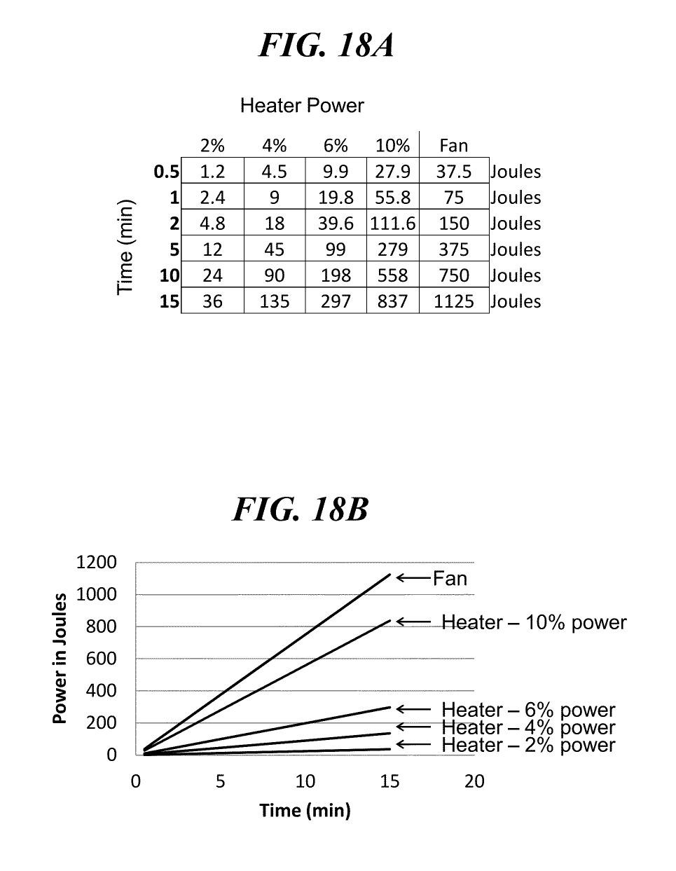

Energy usage recorded at time points of 0.5, 1, 2, 5, 10, and 15 minutes for each experiment is provided in FIG. 18A and plotted as a function of time in FIG. 18B. The data suggest that fast thermal cycling may be achieved with low power usage, generally within the capabilities of a battery, solar power, or other alternative source of power. It should be noted that in general these power usage measurements are overestimates because the fan used was overpowered to the task. Additionally, the power is calculated as if no cycling was occurring and the heater was at mid-range power during the entire thermal cycle.

An example resistance of a thin-film heating element (e.g., 401 shown in FIG. 4) is about 6.2Ω. In this example, a voltage of about 24 volts (“V”) was supplied, drawing a maximum current of about 3.87 amperes (“A”) and providing a theoretical maximum power consumption of about 92.88 W. In some cases, in order to achieve the fastest ramp rates, a control assembly in communication with the device may limit the power to about 60% of maximum at peak power consumption. This can occur during the start of a heating segment of cycling and, for materials used in this example, represents about 55.73 W at peak power consumption. In this example, however, a typical run used about 10% of maximum power, or about 9.28 W at peak power consumption. The average power consumption was a fraction of peak power consumption, as, for example, the heater only consumed power for a short time while ramping to a hotter temperature. In this example, the average power consumption was between about 1%-8% of maximum power.

### Example 19

### Energy Consumption During PCR

A PCR experiment was performed using a thermal cycler as described in Example 8. A water sample of 11.5 μl was placed in the sample holder of a cartridge comprising a 0.002 in. bottom seal layer and made from poly(acrylic acid). The water was used as a simulant for a PCR mixture. The temperature of the sample was cycled between about 55° C. and about 85° C.

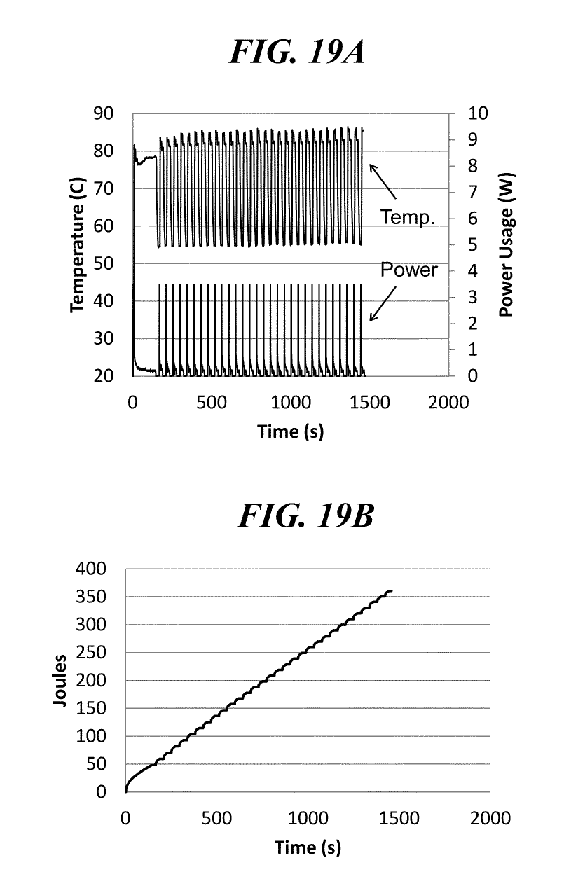

Thirty cycles were completed in about 1500 seconds. Heater temperature and heater power usage was recorded as a function of time and is shown in FIG. 19A. According to FIG. 19A, heater power usage ranges from 0 Watts where no electrical current is supplied to the heater to about 3-4 Watts at peak usage, when electrical current is supplied to the heater. Power usage peaks generally correspond to minimums in sample temperature, due to the need for heating to complete the next thermal cycle at these time points. FIG. 19B shows cumulative energy consumption with respect to time during the experiment. The thermal cycler utilized during the experiment consumed energy at a rate of about 0.2 J/s. These data suggest that thermal cycling may be achieved with low power usage.

### Example 20

### Calibration Curve of Sample Temperature v. Heater Temperature

Thermocouples were placed in contact with the sample and on the thin-film resistive heating element (e.g., 401 shown in FIG. 4) used for heating. FIG. 20 shows the temperature of the sample (“Fluid Temp”) as a function of the temperature of the heater (“Heater Temp”). The sample was 11.5 μL of water, contained within a sample holder comprising a 0.002 in. bottom seal layer and made from poly(acrylic acid). The data indicate that sample temperature may be predicted from heater temperature.

### Example 21

### Use of a Thermal Spreader

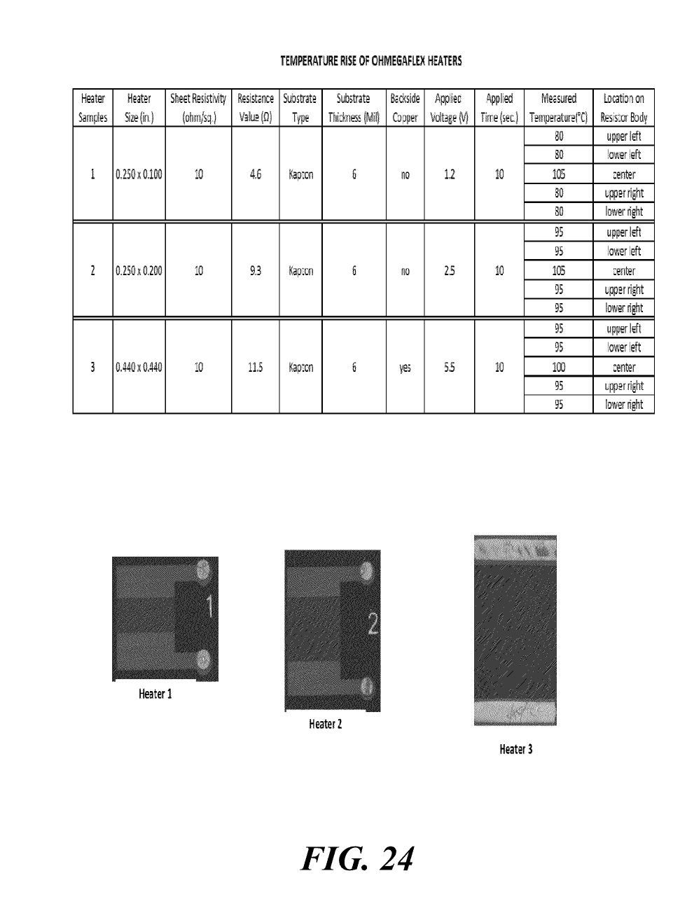

Several heaters, each comprising a thin-film resistive heating element (e.g., 401 shown in FIG. 4) protected with a protective layer, were tested for their capability to generate heat uniformly across the heating element. All of the heaters comprised a sheet resistivity of 10 Ω/square and were mounted on a 0.006 in. thick, Kapton carrier. Photographs of each of the heaters (e.g., “Heater 1”, “Heater 2”, “Heater 3”) are shown in FIG. 24. “Heater 3” comprised a thermal spreader appended beneath the thin-film resistive heating element, on the opposite side of the Kapton carrier from which the thin-film resistive heating element was mounted. “Heater 1” and “Heater 2” did not comprise a thermal spreader. Temperature sensors were placed at various surface positions (e.g., upper left corner, lower left corner, center, upper right corner, lower right corner) on each thin-film resistive heating element.

Starting at a uniform temperature of 40° C. across each heater, electrical energy was supplied to each heater for 10 seconds. At the end of 10 seconds, the temperature was recorded for each temperature sensor placed across each heater. The results of the experiments are tabulated in FIG. 24.

“Heater 1” temperatures ranged from about 80° C. to about 105° C., for a total temperature range of about 25° C. across the heater. “Heater 2” temperatures ranged from about 95° C. to about 105° C., for a total temperature range of about 10° C. across the heater. “Heater 3” temperatures ranged from about 95° C. to about 100° C., for a total temperature range of about 5° C. across the heater. As the temperature range across the three heaters tested was the lowest for the heater comprising a thermal spreader, the results suggest that a thermal spreader may be used to generate more uniform heating across a heating element.

### Example 22

### Estimating Ramp Time Per Thermal Cycle

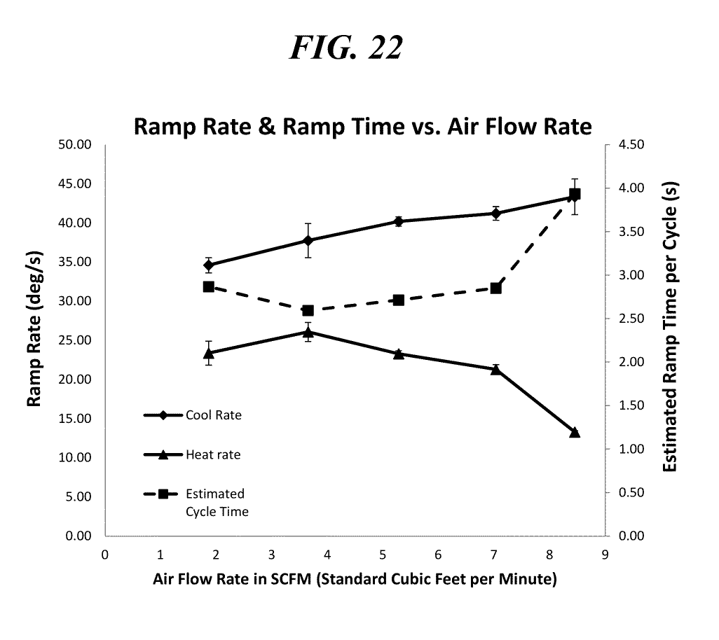

A heater comprising a thin-film resistive heating element was operated and cooled with a cooling gas supplied at various flow rates, ranging from about 2 SCFM (standard cubic feet per minute) to about 8.5 SCFM. Thermocouple(s) were placed on the thin-film resistive heating element (e.g., 401 shown in FIG. 4) used for heating. Heating and cooling rates (measured as effective temperature ramp rates (e.g., a blended number that takes differing cooling and heating ramp rates and normalizes them for comparison)) were recorded and the results are shown in FIG. 22. In general, cooling rates increased with increasing cooling gas flow rate and heating rates decreased with increasing cooling gas flow rate. Based on heating and cooling data, estimated thermal cycle times were generated, as shown in FIG. 22. In this example, estimated thermal cycle times ranged from about 2.50 seconds to about 4.00 seconds.

### Example 23

### Example Sequences Described Herein

GSDMA2
Forward Primer (SEQ ID NO: 1):
5′-GCCTGTCACAAAGCAGCACGCTGGAGGTACA-3′
Reverse Primer (SEQ ID NO: 2):
5′-GTTCTCCAGAGCCGTGGGAGCCACACTGA-3′
Target GSDMA2 (SEQ ID NO: 3):
GCCTGTCACAAAGCAGCACGCTGGAGGTACAGATGCTCAGTGTGGCTCCCACGGCTCTG
GAGAAC
HIV:
Forward Primer (SEQ ID NO: 4):
5′-TATAGCACACAAGTAGACCCT-3′
Reverse Primer (SEQ ID NO: 5):
5′-TCCTGCTTGATATTCACACC-3′
Target HIV (SEQ ID NO: 6):
TATAGCACACAAGTAGACCCTGACCTAGCAGACCAACTAATTCATCTGTACTATTTTGA
CTGTTTTTCAGACTCTGCTATAAGAAAAGCCTTATTAGGACATAGAGTTAGCCCTAGGT
GTGAATATCAAGCAGGA
BCR-ABL
Forward Primer (SEQ ID NO: 7):
5′-CCAACTCGTGTGTGAAACTCC-3′
Reverse Primer (SEQ ID NO: 8):
5′-ATTCCCCATTGTGATTATAGCC-3′
Template (SEQ ID NO: 9):
CTATGAGCGTGCAGAGTGGAGGGAGAACATCCGGGAGCAGCAGAAGAAGTGTTTCAGA
AGCTTCTCCCTGACATCCGTGGAGCTGCAGATGCTGACCAACTCGTGTGTGAAACTCCA
GACTGTCCACAGCATTCCGCTGACCATCAATAAGGAAGATGATGAGTCTCCGGGGCTCT
ATGGGTTTCTGAATGTCATCGTCCACTCAGCCACTGGATTTAAGCAGAGTTCAAAAGCC
CTTCAGCGGCCAGTAGCATCTGACTTTGAGCCTCAGGGTCTGAGTGAAGCCGCTCGTTG
GAACTCCAAGGAAAACCTTCTCGCTGGACCCAGTGAAAATGACCCCAACCTTTTCGTTG
CACTGTATGATTTTGTGGCCAGTGGAGATAACACTCTAAGCATAACTAAAGGTGAAAA
GCTCCGGGTCTTAGGCTATAATCACAATGGGGAATGGTGT
Target BCR-ABL (SEQ ID NO: 10):
CCAACTCGTGTGTGAAACTCCAGACTGTCCACAGCATTCCGCTGACCATCAATAAGGAA
GATGATGAGTCTCCGGGGCTCTATGGGTTTCTGAATGTCATCGTCCACTCAGCCACTGG
ATTTAAGCAGAGTTCAAAAGCCCTTCAGCGGCCAGTAGCATCTGACTTTGAGCCTCAGG
GTCTGAGTGAAGCCGCTCGTTGGAACTCCAAGGAAAACCTTCTCGCTGGACCCAGTGAA
AATGACCCCAACCTTTTCGTTGCACTGTATGATTTTGTGGCCAGTGGAGATAACACTCTA
AGCATAACTAAAGGTGAAAAGCTCCGGGTCTTAGGCTATAATCACAATGGGGAAT

It should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

1. A thermal cycler, comprising:
a) a sample holder;
b) a heater in thermal contact with said sample holder, wherein said heater is configured to heat said sample holder; and
c) a cooling gas in thermal contact with said sample holder, wherein said cooling gas is configured to cool said sample holder,
wherein said thermal cycler is capable of performing a single thermal cycle in less than about 3 seconds.

2. The thermal cycler of claim 1, further comprising a temperature sensor in thermal contact with said sample holder.

3. The thermal cycler of claim 1, wherein said sample holder is integrated into a cartridge.

4. The thermal cycler of claim 3, wherein said cartridge is made using converted-tape technology.

5. The thermal cycler of claim 3, wherein said cartridge is produced from a material selected from the group consisting of polypropylene, polycarbonate and poly(acrylic acid).

6. The thermal cycler of claim 3, wherein said heater is integrated into said cartridge.

7. The thermal cycler of claim 3, further comprising an aligner configured to align said cartridge and said heater.

8. The thermal cycler of claim 3, further comprising a disposable support positioned underneath said heater and configured to improve contact between said heater and said cartridge.

9. The thermal cycler of claim 8, further comprising a plurality of openings in said disposable support and a plurality of fins around the perimeter of said disposable support, said openings and fins being configured to exhaust said cooling gas.

10. The thermal cycler of claim 1, wherein said heater comprises a flexible circuit board.

11. The thermal cycler of claim 1, wherein said heater comprises a resistive heating element.

12. The thermal cycler of claim 11, wherein said resistive heating element is a thin-film heating element.

13. The thermal cycler of claim 1, further comprising a heat spreader in thermal contact with said heater, wherein said heat spreader is configured to promote thermal uniformity throughout said heater.

14. The thermal cycler of claim 13, wherein said heat spreader comprises a material with high thermal conductivity.

15. The thermal cycler of claim 14, wherein said high thermal conductivity material is copper.

16. The thermal cycler of claim 13, further comprising a temperature sensor in thermal contact with said heat spreader.

17. The thermal cycler of claim 1, wherein said cooling gas is air or carbon dioxide.

18. The thermal cycler of claim 1, wherein said cooling gas is contacted with said sample holder via a forced flow.

19. The thermal cycler of claim 18, wherein said contact occurs along a direction parallel to said sample holder.

20. The thermal cycler of claim 18, wherein said contact occurs along a direction normal to said sample holder.

21. The thermal cycler of claim 1, wherein said thermal cycler consumes energy at less than about 1.0 W.

22. A thermal cycler, comprising:
a) a sample holder;
b) a heater in thermal contact with said sample holder, wherein said heater is configured to heat said sample holder;
c) a cooling gas in thermal contact with said sample holder, wherein said cooling gas is configured to cool said sample holder; and
d) a heat spreader in thermal contact with said heater, wherein said heat spreader is configured to promote thermal uniformity throughout said heater.

23. The thermal cycler of claim 22, further comprising a temperature sensor in thermal contact with said sample holder.

24. The thermal cycler of claim 22, further comprising a temperature sensor in thermal contact with said heat spreader.

25. The thermal cycler of claim 22, wherein said sample holder is integrated into a cartridge.

26. The thermal cycler of claim 25, wherein said cartridge is made using converted-tape technology.

27. The thermal cycler of claim 25, wherein said cartridge is produced from a material selected from the group consisting of polypropylene, polycarbonate and poly(acrylic acid).

28. The thermal cycler of claim 25, wherein said heater is integrated into said cartridge.

29. The thermal cycler of claim 25, further comprising an aligner configured to align said cartridge and said heater.

30. The thermal cycler of claim 25, further comprising a disposable support positioned underneath said heater and configured to improve contact between said heater and said cartridge.

31. The thermal cycler of claim 30, further comprising a plurality of openings in said disposable support and a plurality of fins around the perimeter of said disposable support, said openings and fins being configured to exhaust said cooling gas.

32. The thermal cycler of claim 22, wherein said heater comprises a flexible circuit board.

33. The thermal cycler of claim 22, wherein said heater comprises a resistive heating element.

34. The thermal cycler of claim 33, wherein said resistive heating element is a thin-film heating element.

35. The thermal cycler of claim 22, wherein said heat spreader comprises a material with high thermal conductivity.

36. The thermal cycler of claim 35, wherein said high thermal conductivity material is copper.

37. The thermal cycler of claim 22, wherein said cooling gas is air or carbon dioxide.

38. The thermal cycler of claim 22, wherein said cooling gas is contacted with said sample holder via a forced flow.

39. The thermal cycler of claim 38, wherein said contact occurs along a direction parallel to said sample holder.

40. The thermal cycler of claim 38, wherein said contact occurs along a direction normal to said sample holder.

41. The thermal cycler of claim 22, wherein said thermal cycler consumes energy at less than about 1.0 W.

42. A method of amplifying a nucleic acid, comprising:
a) providing a thermal cycler comprising:
i) a sample holder containing a sample that comprises a nucleic acid to be amplified;
ii) a heater in thermal contact with said sample holder; and
iii) a cooling gas in thermal contact with said sample holder, wherein said cooling gas is configured to cool said sample holder; and
b) amplifying said nucleic acid in said thermal cycler,
wherein at least one amplification cycle is completed in less than about 3 seconds.

43. The method of claim 42, wherein said sample further comprises reagents necessary for amplification of said nucleic acid.

44. The method of claim 42, wherein said thermal cycler further comprises a temperature sensor in thermal contact with said sample holder.

45. The method of claim 42, wherein said sample holder is integrated into a cartridge.

46. The method of claim 45, wherein said cartridge is made using converted-tape technology.

47. The method of claim 45, wherein said cartridge is produced from a material selected from the group consisting of polypropylene, polycarbonate and poly(acrylic acid).

48. The method of claim 45, wherein said heater is integrated into said cartridge.

49. The method of claim 45, wherein said thermal cycler further comprises an aligner configured to align said cartridge and said heater.

50. The method of claim 45, wherein said thermal cycler further comprises a disposable support positioned underneath said heater and configured to improve contact between said heater and said cartridge.

51. The method of claim 50, wherein said thermal cycler further comprises a plurality of openings in said disposable support and a plurality of fins around the perimeter of said disposable support, said openings and fins being configured to exhaust said cooling gas.

52. The method of claim 42, wherein said heater comprises a flexible circuit board.

53. The method of claim 42, wherein said heater comprises a resistive heating element.

54. The method of claim 53, wherein said resistive heating element is a thin-film heating element.

55. The method of claim 42, wherein said thermal cycler further comprises a heat spreader in thermal contact with said heater, said heat spreader being configured to promote thermal uniformity throughout said heater.

56. The method of claim 55, wherein said heat spreader comprises a material with high thermal conductivity.

57. The method of claim 56, wherein said high thermal conductivity material is copper.

58. The method of claim 55, wherein said thermal cycler further comprises a temperature sensor in thermal contact with said heat spreader.

59. The method of claim 42, wherein said cooling gas is air or carbon dioxide.

60. The method of claim 42, wherein said cooling gas is contacted with said sample holder via a forced flow.

61. The method of claim 60, wherein said contact occurs along a direction parallel to said sample holder.

62. The method of claim 60, wherein said contact occurs along a direction normal to said sample holder.

63. The method of claim 42, wherein said thermal cycler consumes energy at less than about 1.0 W.

64. The thermal cycler of claim 1, wherein said thermal cycler is capable of performing a single thermal cycle in less than about 1 second.

65. The thermal cycler of claim 1, wherein said thermal cycler is capable of performing a single thermal cycle in about 0.75 seconds.

66. The method of claim 42, wherein said at least one nucleic acid amplification cycle is completed in less than about 1 second.

67. The method of claim 42, wherein said at least one nucleic acid amplification cycle is completed in about 0.75 seconds.
